(19) United States
(12) Patent Application Publication
(10) Pub. No.: US 2007/0043623 A1
(43) Pub. Date: Feb. 22, 2007

(54) Document creation system and document creation program

(76) Inventor: Atsushi Kodama, Toshima-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/583,330

(22) PCT Filed: Dec. 20, 2004
(86) PCT No.: PCT/JP04/19034

§ 371 Date: Jun. 16, 2006

(30) Foreign Application Priority Data
Dec. 19, 2003 (JP) 2003-423884

(51) Int. Cl. G06Q 20/00

(52) U.S. Cl. 705/22

(57) ABSTRACT

Prescribed disclosure documents such as financial account documents and brief announcement of financial results or in-house management documents can be created on the basis of a combined account disclosure item defined by extending a combined account title to not only the combined account title represented by increase/decrease in money, but also number of stock holdings and increase/decrease in employee with a basic combined account disclosure item indicating a substance of the increase/decrease, which combined account disclosure item is made from three items of the aforesaid basic combined account disclosure item, a decrease disclosure item indicating a substance of the decrease, and an increase disclosure item indicating a substance of the increase in the process of managing business information expressible in numeric terms while adding a subsidiary disclosure item indicating subsidiary information to the combined account disclosure item, so as to create prescribed disclosure documents or other managing document from business information on the basis of the aforesaid combined account disclosure item and subsidiary information.

### TECHNICAL FIELD

This invention relates to document creation system and document creation program for creating prescribed disclosure documents such as a balance sheet, earnings statement and financial business report and management documents, which are statutorily required to disclose transaction information in the prescribed form in conformity to the commercial law or securities and exchange law, and management documents drawn up in a company.

### BACKGROUND OF THE ART

Of transaction information, accounting information expressible in money amount are generally journalized with each transaction, transcribed to a general ledger, and posted to the balance sheet, earnings statement or financial business report, which are required to be disclosed outside of the company, upon drawing up a trial balance or working sheet That is, the accounting information is put down to the balance sheet, earnings statement or financial business report through daily journalizing and ledger managing. Patent reference 1 teaches a system for fulfilling such affairs.

However, the earnings statement and financial business report may be required to contain not merely the accounting information of the transaction information, but also information which is expressible in terms of the number of officers or monetary amounts such as the number of shares (hereinafter referred to as “non-accounting information”). Unlike the accounting information, the non-accounting information has not been managed by journalizing or on the ledger nor put down to an accounting book, but dealt with by hand, consequently to bring a problem of requiring an immerse amount of time and labor to post the non-accounting information to financial account documents.

The prescribed disclosure documents such as the balance sheet and earnings statement must be drawn up in the form required by business law. Therefore, in the case where the prescribed form is revised with the enforcement of amendments to the commercial law and so forth, the specific contents to be disclosed with respect to the accounting information and non-accounting information should be changed in accordance with the change in the prescribed form. Thus, there has been longed for a management method capable of promptly addressing the changing of the prescribed forms to meet the legal revisions.

Also, it has been looked forward to another management method capable of creating documents for managing personnel matters in a company and the number of shares issued in conjunction with preparation of the prescribed documents to be disclosed.

Patent Reference 1: Japanese Patent Application Publication No. 2002-24507(A)

### DISCLOSURE OF THE INVENTION

This invention was made in the light of the foregoing circumstances and provides a document creation system and a document creation program for managing accounting information concerning money transaction as well as non-accounting information such as number of stock holdings and increase/decrease in employee.

As mentioned in claim 1, the present invention provides a document creation system for creating prescribed disclosure documents such as financial account documents and brief announcement of financial results or in-house management documents, which comprises a database for storing disclosure section information for managing a combined account disclosure item defined by extending a combined account title to non-accounting information including not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items; a display device for displaying entry fields; an input device for entry into the aforesaid entry field; and a processing unit for performing the following processes (A)-(E):

(A) displaying, on the aforesaid display device, a basic slip including a combined account title entry field for entering combined account title data and an expression unitage entry field for entering expressing unitage indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) displaying, on the aforesaid display device, a disclosure item entry field for the aforesaid disclosure item and a disclosure item transfer slip for asking for entering the aforesaid disclosure item information,

(D) registering the aforesaid disclosure item transfer slip to be stored in the aforesaid database in correlation with the disclosure item information entered into each of the aforesaid entry fields, and

(E) creating the prescribed disclosure documents from the aforesaid business information on the basis of the aforesaid disclosure item information and disclosure section information.

According to the system described above, the non-accounting information as well ad the accounting information can be managed by using the basic combined account disclosure item indicating the basic combined account disclosure item indicating the substance of the increase/decrease and the increase and decrease disclosure items indicating the increase and decrease, which constitute the combined account disclosure item defined by extending the combined account item commonly used in an accounting procedure to the non-accounting information. The same procedure serves to create the documents.

Further, the data can be flexibly determined in conformity with the disclosure content of the document by unrestrainedly assigning the combined account disclosure item.

As mentioned in claim 2, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items; a display device for displaying entry fields; an input device for entry into the aforesaid entry field; and a processing unit for performing the following processes (A)-(E):

(A) displaying, on the aforesaid display device, a basic slip including a combined account title entry field for entering combined account title data, a subsidiary disclosure item entry field for entering subsidiary disclosure item data indicating subsidiary information added to the aforesaid combined account title, and an expression unitage entry field for entering expressing unitage indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) displaying, on the aforesaid display device, a disclosure item entry field for the aforesaid disclosure item and a disclosure item transfer slip for asking for entering the aforesaid disclosure item information,

(D) registering the aforesaid disclosure item transfer slip to be stored in the aforesaid database in correlation with the disclosure item information entered into each of the aforesaid entry fields, and

(E) creating the prescribed disclosure documents from the aforesaid business information on the basis of the aforesaid disclosure item information and disclosure section information.

According to the system described above, more detailed information can be managed and disclosed in the document by adding to the aforesaid combined account title the subsidiary disclosure item data indicating the subsidiary information for supplement to the contents with respect to the basic combined account disclosure item and increase and decrease disclosure items.

As mentioned in claim 3, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items, and formula item information for correlating a formula item, which is a combined account disclosure item indicating operation symbols such as addition and subtraction signs with the aforesaid operation symbols; a display device for displaying entry fields; an input device for entry into the aforesaid entry field; and a processing unit for performing the following processes (A)-(G):

(A) displaying, on the aforesaid display device, a basic slip including a combined account title entry field for entering combined account title data and an expression unitage entry field for entering expressing unitages indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) displaying, on the aforesaid display device, a calculating slip including a formula item entry field for entering the formula represented by enumerating the combined account disclosure items and a calculation result item entry field for entering a calculation result item indicating the combined account disclosure item calculated by the aforesaid calculation formula,

(D) registering the calculation slip for storing, in a calculating item table, the calculation result item calculated by the aforesaid calculation formula in correlation with the aforesaid calculation formula.

(E) displaying, on the aforesaid display device, a disclosure item entry field for the aforesaid disclosure item and a disclosure item transfer slip for asking for entering the aforesaid disclosure item information,

(F) registering the aforesaid disclosure item transfer slip to be stored in the aforesaid database in correlation with the disclosure item information entered into each of the aforesaid entry fields, and

(G) creating the prescribed disclosure documents from the aforesaid business information on the basis of the aforesaid disclosure item information and disclosure section information

As mentioned in claim 4, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items, and formula item information for correlating a formula item, which is a combined account disclosure item indicating operation symbols such as addition and subtraction signs with the aforesaid operation symbols; a display device for displaying entry fields; an input device for entry into the aforesaid entry field; and a processing unit for performing the following processes (A)-(G):

(A) displaying, on the aforesaid display device, a basic slip including a combined account title entry field for entering combined account title data, a subsidiary disclosure item entry field for entering subsidiary disclosure item data indicating auxiliary information added to the aforesaid combined account title, and an expression unitage entry field for entering expressing unitages indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) displaying, on the aforesaid display device, a calculating slip including a formula item entry field for entering the formula represented by enumerating the combined account disclosure items and a calculation result item entry field for entering a calculation result item indicating the combined account disclosure item calculated by the aforesaid calculation formula,

(D) registering the calculation slip for storing, in a calculating item table, the calculation result item calculated by the aforesaid calculation formula in correlation with the aforesaid calculation formula

(E) displaying, on the aforesaid display device, a disclosure item entry field for the aforesaid disclosure item and a disclosure item transfer slip for asking for entering the aforesaid disclosure item information,

(F) registering the aforesaid disclosure item transfer slip to be stored in the aforesaid database in correlation with the disclosure item information entered into each of the aforesaid entry fields, and

(G) creating the prescribed disclosure documents from the aforesaid business information on the basis of the aforesaid disclosure item information and disclosure section information.

According to the systems described above, the information entered into the basic slip can be processed on the calculation formula and described in the document by creating the calculation result item indicating the calculation formula item indicating the formula composed of the operation symbols and other signs and the combined account disclosure item.

As mentioned in claim 5, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items; a display device for displaying entry fields; an input device for entry into the aforesaid entry field; and a processing unit for performing the following processes (A)-(F):

(A) displaying, on the aforesaid display device, a basic slip including a combined account title entry field for entering combined account title data, a subsidiary disclosure item entry field for entering subsidiary disclosure item data indicating auxiliary information added to the aforesaid combined account title, and an expression unitage entry field for entering expressing unitages indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) preparing a disclosure ledger for calculating credit/debit balance in a given period on the basis of the date information and expression unitage information of the aforesaid basic slip information and, upon itemization of the aforesaid basic slip information with each combined account disclosure item,

(D) displaying, on the aforesaid display device, a disclosure item entry field for the aforesaid disclosure item and a disclosure item transfer slip for asking for entering the aforesaid disclosure item information,

(E) registering the aforesaid disclosure item transfer slip to be stored in the aforesaid database in correlation with the disclosure item information entered into each of the aforesaid entry fields, and

(F) creating the prescribed disclosure documents from the aforesaid business information on the basis of the aforesaid disclosure item information and disclosure section information.

As mentioned in claim 6, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items; a display device for displaying entry fields; an input device for entry into the aforesaid entry field; and a processing unit for performing the following processes (A)-(E):

(A) displaying, on the aforesaid display device, a basic slip including a combined account title entry field for entering combined account title data, a subsidiary disclosure item entry field for entering subsidiary disclosure item data indicating auxiliary information added to the aforesaid combined account title, and an expression unitage entry field for entering expressing unitages indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) preparing a disclosure ledger for calculating credit/debit balance in a given period on the basis of the date information and expression unitage information of the aforesaid basic slip information and, upon itemization of the aforesaid basic slip information with each combined account disclosure item,

(D) displaying, on the aforesaid display device, a disclosure item entry field for the aforesaid disclosure item and a disclosure item transfer slip for asking for entering the aforesaid disclosure item information,

(E) registering the aforesaid disclosure item transfer slip to be stored in the aforesaid database in correlation with the disclosure item information entered into each of the aforesaid entry fields, and

(F) creating the prescribed disclosure documents from the aforesaid business information on the basis of the aforesaid disclosure item information and disclosure section information.

As mentioned in claim 7, the present invention provides a document creation system for creating prescribed disclosure documents such as financial account documents and brief announcement of financial results or in-house management documents, which comprises a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of the aforesaid business information and disclosure items disclosed in the documents with disclosure positions in the documents of the disclosure items, formula item information for correlating a formula item, which is a combined account disclosure item indicating operation symbols such as addition and subtraction signs with the aforesaid operation symbols, and other information; a display device for displaying entry fields; an input device for entry into the aforesaid entry field; and a processing unit for performing the following processes (A)-(H):

(A) displaying, on the aforesaid display device, a basic slip including a combined account title entry field for entering combined account title data, a subsidiary disclosure item entry field for entering subsidiary disclosure item data indicating auxiliary information added to the aforesaid combined account title, and an expression unitage entry field for entering expressing unitages indicating numeric values of the aforesaid increase/decrease respectively on both debit and credit columns while displaying a date entry field for entering a date on which the increase or decrease occurs,

(B) registering the basic slip information entered into the aforesaid entry fields to be stored as correlated business information in the aforesaid database,

(C) preparing a disclosure ledger for calculating credit/debit balance in a given period on the basis of the date information and expression unitage information of the aforesaid basic slip information and, upon itemization of the aforesaid basic slip information with each combined account disclosure item,

(D) displaying, on the aforesaid display device, a calculating slip including a formula item entry field for entering the formula represented by enumerating the combined account disclosure items and a calculation result item entry field for entering a calculation result item indicating the combined account disclosure item calculated by the aforesaid calculation formula,

(E) registering the calculation slip for storing, in a calculating item table, the calculation result item calculated by the aforesaid calculation formula in correlation with the aforesaid calculation formula.

(F) displaying, on the aforesaid display device, a disclosure item entry field for the aforesaid disclosure item and a disclosure item transfer slip for asking for entering the aforesaid disclosure item information,

(G) registering the aforesaid disclosure item transfer slip to be stored in the aforesaid database in correlation with the disclosure item information entered into each of the aforesaid entry fields, and

(H) creating the prescribed disclosure documents from the aforesaid business information on the basis of the aforesaid disclosure item information and disclosure section information.

According to the system described above, there can be drawn up the disclosure ledger in which the information entered into the basic slip is organized by the combined account title and subsidiary disclosure item.

As mentioned in claim 8, the document creation system set forth in any of claims 1, 3 and 5 is featured in that the database has a combined account disclosure item table for storing the combined account disclosure item, and the processing unit serves to display, on the display device, the combined account disclosure item entry field for entry of the aforesaid combined account disclosure item, and store in the database the aforesaid combined account disclosure item entered into the aforesaid entry field, wherein the date in the aforesaid combined account disclosure item table are indicated as an option on the display device when displaying the combined account disclosure entry field in the basic slip displaying process.

As mentioned in claim 9, the document creation system set forth in any of claims 2, 4, 6 and 7 is featured in that the database has a combined account disclosure item table for storing the combined account disclosure item and a subsidiary disclosure item table for storing the subsidiary disclosure item; and the processing unit serves to display, on the display device, the combined account disclosure item entry field for entry of the aforesaid combined account disclosure item and subsidiary disclosure item entry field for entry of the aforesaid subsidiary disclosure item, and store in the database the aforesaid combined account disclosure item and subsidiary disclosure item entered into the aforesaid entry field, wherein the date in the aforesaid combined account disclosure item table are indicated as an option and the date in the aforesaid subsidiary disclosure item table are indicated as an option on the display device when displaying the combined account disclosure entry field in the basic slip displaying process.

According to the systems described above, the combined account disclosure item and subsidiary disclosure item, which are previously registered in the database, can be displayed as the options in entering the basic slip, consequently to significantly lighten the data entry task of a data entry operator in entering the data Also in a case of changing the disclosure item in the document, the combined account disclosure item and subsidiary disclosure item can easily be registered again.

As mentioned in claims 10 to 18, the document creation systems set forth in claims 1 to 9 can be fulfilled by a document creation program according to the invention.

### BRIEF DESCRIPTION OF THE DRAWINGS

FIG. 1 is a block diagram showing a system in the first embodiment of the present invention.

FIG. 2 is a block diagram showing a document creation program in the first embodiment of the present invention.

FIG. 3 is a block diagram showing a database in the first embodiment of the present invention.

FIG. 4 shows a production company attribute table in the first embodiment of the present invention.

FIG. 5 shows an account settlement term table in the first embodiment of the present invention.

FIG. 6 shows a disclosure term type table in the first embodiment of the present invention.

FIG. 7 shows an accounting term table by an account settlement disclosure type period table in the first embodiment of the present invention.

FIG. 8 is a block diagram showing a segment table in the first embodiment of the present invention.

FIG. 9 shows a company attribute table of a company to be disclosed in the first embodiment of the present invention.

FIG. 10 shows an individual attribute table of an individual to be disclosed in the first embodiment of the present invention.

FIG. 11 shows a slip type table in the first embodiment of the present invention.

FIG. 12 shows an expression unit table in the first embodiment of the present invention.

FIG. 13 shows a data entry operator's table in the first embodiment of the present invention.

FIG. 14 shows a slip section table in the first embodiment of the present invention.

FIG. 15 shows a combined account disclosure item table in the first embodiment of the present invention.

FIG. 16 shows a subsidiary disclosure item table in the first embodiment of the present invention.

FIG. 17 shows a formula item table in the first embodiment of the present invention.

FIG. 18 shows a disclosure section table in the first embodiment of the present invention.

FIG. 19 shows a document type table in the first embodiment of the present invention.

FIG. 20 shows a slip information table in the first embodiment of the present invention.

FIG. 21 shows a production screen of a production company attribute in the first embodiment of the present invention.

FIG. 22 shows a production screen of the combined account disclosure item in the first embodiment of the present invention.

FIG. 23 shows a processing list image in the first embodiment of the present invention.

FIG. 24 is a flowchart of creating a slip in the first embodiment of the present invention.

FIG. 25 is a diagram showing a default slip of an officer slip in the first embodiment of the present invention.

FIG. 26 is a diagram showing a current term increase slip of the officer slip in the first embodiment of the present invention.

FIG. 27 is a diagram showing a current term decrease slip of the officer slip in the first embodiment of the present invention.

FIG. 28 is a diagram showing a current term change slip of the officer slip in the first embodiment of the present invention.

FIG. 29 is a diagram showing a next term increase slip of the officer slip in the first embodiment of the present invention.

FIG. 30 is a diagram showing a next term decrease slip of the officer slip in the first embodiment of the present invention.

FIG. 31 is a diagram showing a next term change slip of the officer slip in the first embodiment of the present invention.

FIG. 32 is a diagram showing a default slip of an employee slip in the first embodiment of the present invention.

FIG. 33 is a diagram showing a current term increase slip of the employee slip in the first embodiment of the present invention.

FIG. 34 is a diagram showing a current term decrease slip of the employee slip in the first embodiment of the present invention.

FIG. 35 is a diagram showing a default slip of an issued stock slip in the first embodiment of the present invention.

FIG. 36 is a diagram showing a current term increase slip of the issued stock slip in the first embodiment of the present invention.

FIG. 37 is a diagram showing a current term decrease slip of the issued stock slip in the first embodiment of the present invention.

FIG. 38 is a diagram showing a default slip of an own shares slip in the first embodiment of the present invention.

FIG. 39 is a diagram showing a current term increase slip of the own shares slip in the first embodiment of the present invention.

FIG. 40 is a diagram showing a current term decrease slip of the own shares slip in the first embodiment of the present invention.

FIG. 41 is a diagram showing a default slip of an affiliated company stock slip in the first embodiment of the present invention.

FIG. 42 is a diagram showing a current term increase slip of the affiliated company stock slip in the first embodiment of the present invention.

FIG. 43 is a diagram showing a current term decrease slip of the affiliated company stock slip in the first embodiment of the present invention.

FIG. 44 is a flowchart of creating a disclosure ledger in the first embodiment of the present invention.

FIG. 45 is a diagram showing a director ledger based on the officer slip in the first embodiment of the present invention.

FIG. 46 is a diagram showing an auditor ledger based on the officer slip in the first embodiment of the present invention.

FIG. 47 is a diagram showing a director schedule ledger based on the officer slip in the first embodiment of the present invention.

FIG. 48 is a diagram showing another auditor ledger based on the officer slip in the first embodiment of the present invention.

FIG. 49 is a diagram showing an employee ledger based on the employee slip in the first embodiment of the present invention.

FIG. 50 is a diagram showing an issued stock ledger based on the issued stock slip in the first embodiment of the present invention.

FIG. 51 is a diagram showing an own shares ledger based on the own shares slip in the first embodiment of the present invention.

FIG. 52 is a diagram showing an affiliated company stock ledger based on the affiliated company stock slip in the first embodiment of the present invention FIG. 53 is a flowchart of creating the calculating slip in the first embodiment of the present invention.

FIG. 54 is a diagram showing a screen for specifying a calculation method in the first embodiment of the present invention.

FIG. 55 is a flowchart of creating a disclosure item transfer slip in the first embodiment of the present invention.

FIG. 56 shows the disclosure item transfer slip in the first embodiment of the present invention.

FIG. 57 shows the disclosure item transfer slip (Example 1) based on the director ledger and auditor ledger in the first embodiment of the present invention.

FIG. 58 shows the disclosure item transfer slip (Example 2) based on the director ledger and auditor ledger in the first embodiment of the present invention.

FIG. 59 shows the disclosure item transfer slip based on the director schedule ledger and auditor schedule ledger in the first embodiment of the present invention.

FIG. 60 shows the disclosure item transfer slip based on the employee ledger in the first embodiment of the present invention.

FIG. 61 shows the disclosure item transfer slip based on an issued stock ledger in the first embodiment of the present invention.

FIG. 62 shows the disclosure item transfer slip based on an own shares ledger in the first embodiment of the present invention.

FIG. 63 shows the disclosure item transfer slip (Example 1) based on an affiliated company stock ledger in the first embodiment of the present invention.

FIG. 64 shows the disclosure item transfer slip (Example 2) based on an affiliated company stock ledger in the first embodiment of the present invention.

FIG. 65 is a flowchart of creating the document in the first embodiment of the present invention.

FIG. 66 is a view showing in part the disclosure item transfer slip of FIG. 61 on a financial account document in the first embodiment of the present invention.

FIG. 67 is a view showing in part the disclosure item transfer slip of FIG. 61 on the financial account document in the first embodiment of the present invention.

FIG. 68 is a view showing in part the disclosure item transfer slip of FIG. 62 on the financial account document in the first embodiment of the present invention.

FIG. 69 is a view showing in part the disclosure item transfer slip of FIG. 56 on the financial account document in the first embodiment of the present invention.

FIG. 70 is a view showing in part the disclosure item transfer slip of FIG. 56 on the financial account document in the first embodiment of the present invention.

FIG. 71 is a view showing in part the disclosure item transfer slip of FIG. 61 on the financial account document in the first embodiment of the present invention.

FIG. 72 is a view showing in part the disclosure item transfer slips of FIG. 62 and FIG. 63 on the financial account document in the first embodiment of the present invention.

FIG. 73 is a view showing in part the disclosure item transfer slips of FIG. 62 and FIG. 63 on the financial account document in the first embodiment of the present invention.

FIG. 74 is a view showing in part the disclosure item transfer slips of FIG. 57 and FIG. 58 on the financial account document in the first embodiment of the present invention.

FIG. 75 is a view showing in part the disclosure item transfer slip of FIG. 60 on the financial account document in the first embodiment of the present invention.

FIG. 76 is a view showing in part the disclosure item transfer slips of FIGS. 56, 61 and 62 on a brief announcement of financial results in the first embodiment of the present invention.

FIG. 77 is a view showing in part the disclosure item transfer slip of FIG. 59 on a valuable instrument report in the first embodiment of the present invention.

FIG. 78 is a view showing in part the disclosure item transfer slip of FIG. 61 and FIG. 62 on the valuable instrument report in the first embodiment of the present invention.

FIG. 79 is a view showing in part the disclosure item transfer slip of FIG. 56 on the valuable instrument report in the first embodiment of the present invention.

FIG. 80 is a view showing in part the disclosure item transfer slip of FIG. 60 on the valuable instrument report in the first embodiment of the present invention.

FIG. 81 is a view showing in part the disclosure item transfer slip of FIG. 61 on the valuable instrument report in the first embodiment of the present invention.

FIG. 82 is a view showing in part the disclosure item transfer slip of FIG. 62 on the valuable instrument report in the first embodiment of the present invention.

### BEST MODE FOR CARRYING OUT THE INVENTION

The first embodiment of the present invention will be described hereinafter in detail with reference to the accompanying drawings. The present invention provides contributes to creation of various management documents and the like for managing the prescribed disclosure documents, share of stocks and employees in a company, but the aspect of the invention capable of creating prescribed disclosure documents such as a financial account document, brief announcement of financial results and valuable instrument report will be described here just as one example.

In the field of accountancy, there have been generally used the terms “combined account title” and “subsidiary item”, but the term “combined account title” and “subsidiary item” in the invention are defined as the items extending to not merely accounting information but also non-accounting information such as number of employees, increase in stock and so on.

Also, the combined account disclosure item is broadly divided into three items, i.e. basic combined account disclosure item, increase disclosure item and decrease disclosure item, in the invention. The basic combined account disclosure item is a combined account disclosure item indicating a substance to be accounted such as “officers” and “employees.” The increase disclosure item is defined as combined account disclosure items indicating the increase in the substance to be accounted such as “current term increase of officers” and “current term increase of employees.” The decrease disclosure item is defined as combined account disclosure items indicating the decrease in the substance to be accounted such as “current term decrease of officers” and “current term decrease of employees.” Thus, these increase and decrease factors can be distinctively managed in relation to all the numerically expressible company information dealt with in the similar processes.

To the basic combined account disclosure item, some of subsidiary information such as “representative director” and “marketing department manager” may be added. Similarly, some of subsidiary disclosure items indicating subsidiary information such as “resignation on term expiration” and “intermediate employment”, which gives grounds for clarifying the contents to be mentioned in the relevant items on the final document, may be added to the increase disclosure item and decrease disclosure item. Thus, the various information data added to the combined account disclosure item can be advantageously used in creating the required document.

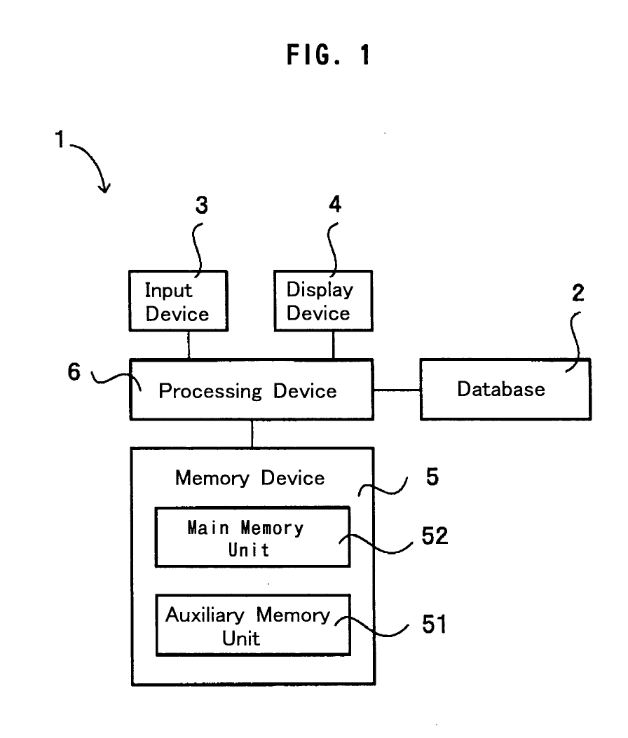

The system architecture of the document creation system 1 in the first embodiment of the invention will be described with reference to FIG. 1. The document creation system 1 of the first embodiment of the invention comprises a database 2 for storing company information such as data of increase and decrease in money transaction, share of stock and employee in a company, an input device 3 such as a keyboard and mouse for entering the data by a data entry operator, a display device for displaying the subject in processing for guidance with the operator, a memory device 5 having an auxiliary memory unit 51 such as a hard disk drive for storing a document creating program as described later and a main memory unit 52 such as of a memory for temporarily storing data and the program, and a processing device 6 such as a CPU for executing the document creating program to perform various computation.

Here, storing of data into the database 2 is said to register.

The document creation program is to display the information stored in the memory device 5 or database 2 on a display device 4 and store, in the memory device 5 or database 2, the information inputted by using the input device 3, thus to create the document based on the information.

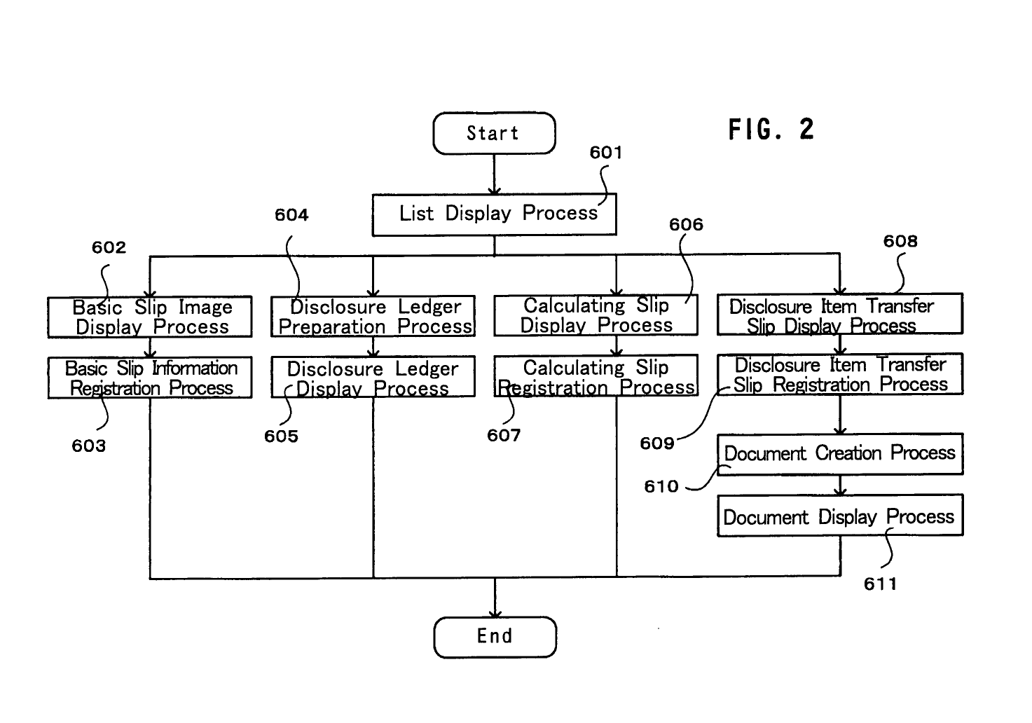

FIG. 2 shows the program structure of the document creation program of the invention. The program creation program mainly performs a list display process 601, a basic slip image display process 602, a basic slip information registration process 603, a disclosure ledger preparation process 604, an disclosure ledger display process 605, a calculating slip display process 606, a calculating slip registration process 607, a disclosure item transfer slip display process 608, a disclosure item transfer slip registration process 609, a document creation process 610, and a document display process 611.

In the list display process 601, a list of tasks available to the data entry operator is displayed on the display device 4 to ask for entering data.

In the basic slip image display process 602, the entry fields for the respective items required for creating the basic slip for increase and decrease data of money transaction, number of employees and share of stocks are displayed on the display device 4 for encouraging the data entry operator to enter the data.

In the basic slip information registration process 603, the information data entered by the data entry operator are stored in the database 2 in conformity with one another.

In the disclosure ledger preparation process 604, a disclosure ledger is made from the information entered into the basic slip by the data entry operator.

In the disclosure ledger display process 605, the disclosure ledger thus made is displayed on the display device 4.

In the calculating slip display process 606, a calculating slip for specifying a calculating method for obtaining specific information from the information data entered into the basic slip by the data entry operator is displayed on the display device 4 for encouraging the operator to enter into the slip.

In the calculating slip registration process 607, the information data entered into the calculating slip by the data entry operator are stored in the database 2.

In the disclosure item transfer slip display process 608, a disclosure item transfer slip for specifying the items to be written on the document is displayed on the display device 4 for encouraging the data entry operator to enter into the slip. In the disclosure item transfer slip registration process 609, the information data entered into the disclosure item transfer slip by the data entry operator are stored in the database 2 in conformity with one another.

In the document creation process 610, a desired document is created from company information entered by the data entry operator on the basis of the information entered into the disclosure item transfer slip.

In the document display process 611, the document thus created is displayed on the display device 4.

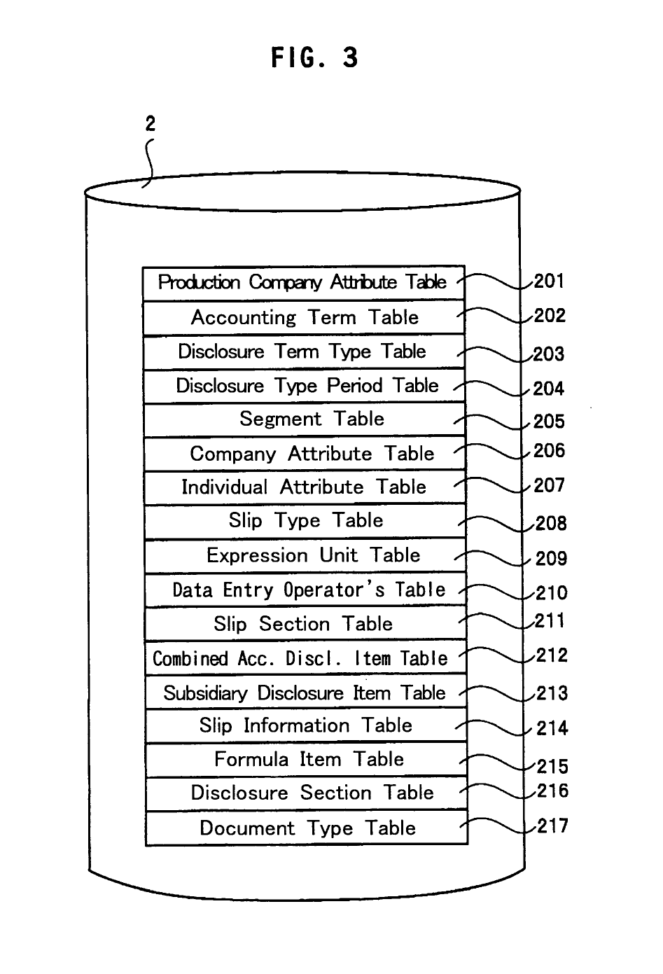

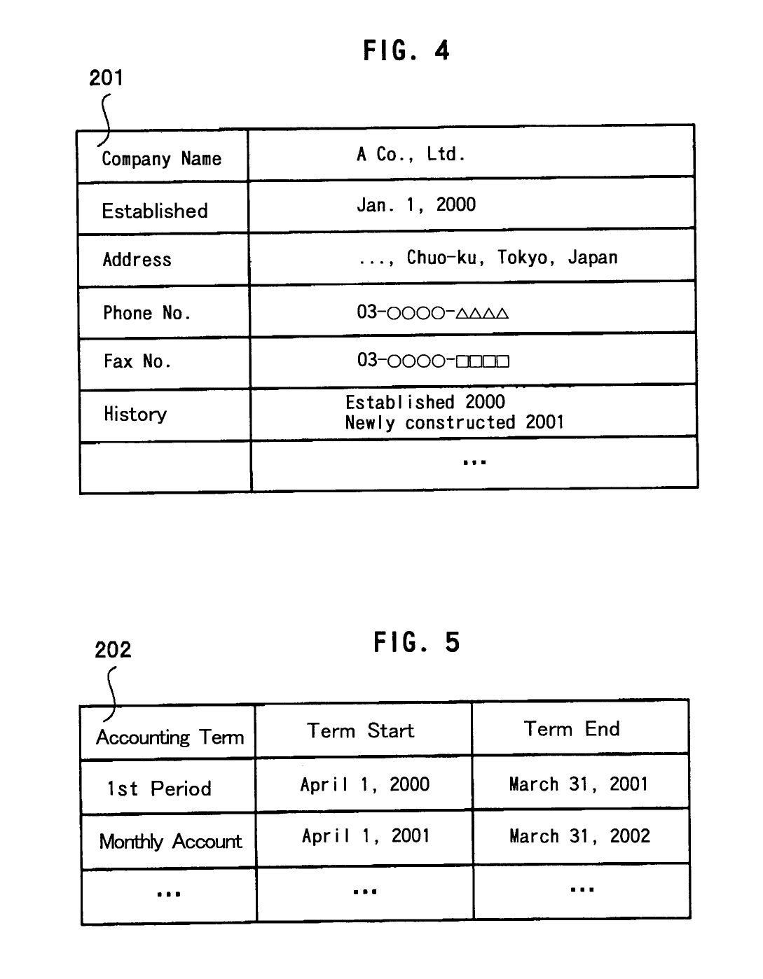

Next, the structure of the database 2 will be described. FIG. 3 shows tables prescribed in the database 2. That is, the database 2 has the tables shown in FIG. 4 through FIG. 20. To be more specific, the database 2 has an production company attribute table 201, an accounting term table 202, a disclosure term type table 203, an account settlement disclosure type period table 204, a segment table 205, a company attribute table 206 of a company to be disclosed, an individual attribute table 207 of an individual to be disclosed, a slip type table 208, an expression unit table 209, a data entry operator's table 210, a slip section table 211, a combined account disclosure item table 212, a subsidiary disclosure item table 213, a formula item table 215, a disclosure section table 216, a document type table 217, and a slip information table 214.

The production company attribute table 201 consists of information concerning a company name, establishment date, address, telephone number, fax number, and corporate attribute information such as a history of a company to be disclosed, as shown in FIG. 4.

The accounting term table 202 consists of accounting term information correlated with accounting term date, accounting term start date and accounting term end date, as shown in FIG. 5.

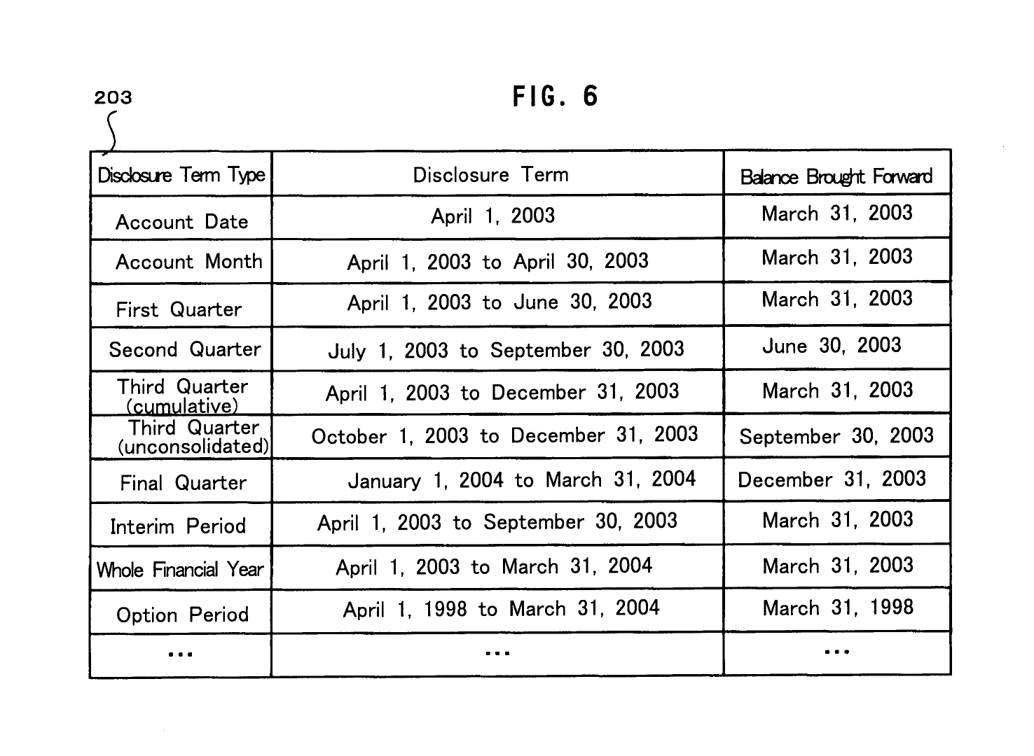

The disclosure term type table 203 consists of information of disclosure term type in correlation with current term and next carrying-over date, as shown in FIG. 6.

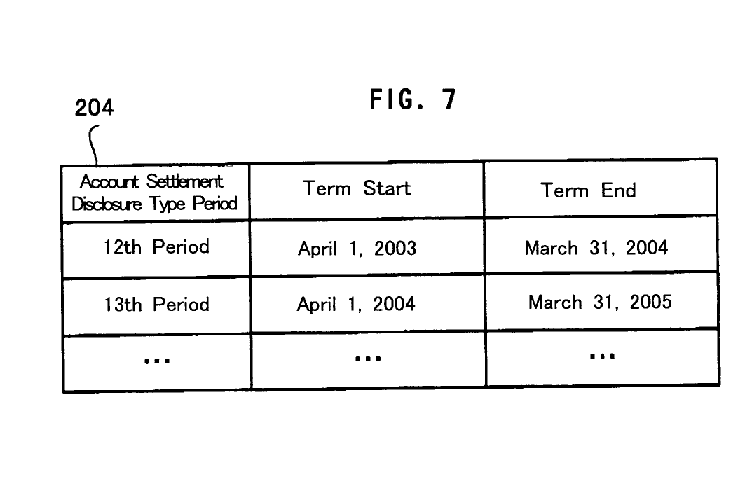

The account settlement disclosure type period table 204 consists of information of account settlement disclosure type period and account settlement disclosure document period in correlation with accounting term start date and accounting term end date, as shown in FIG. 7.

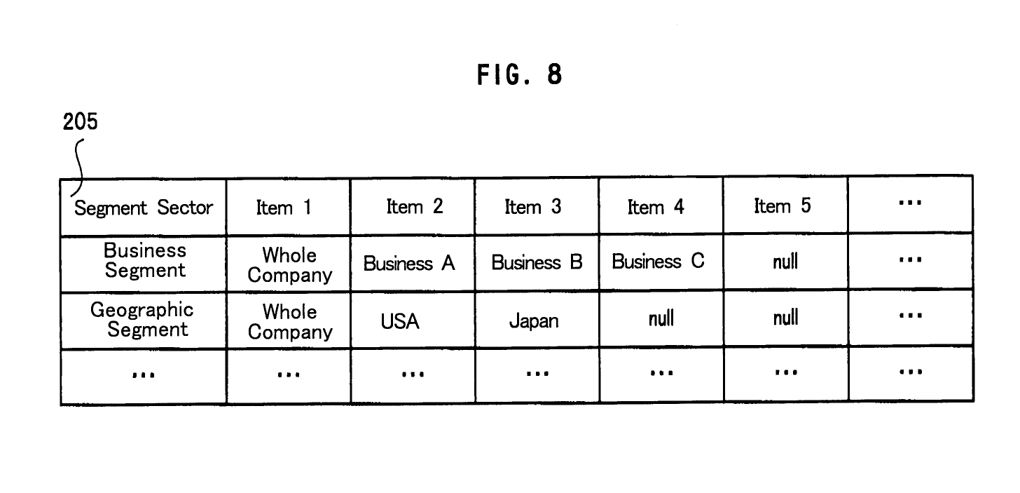

The segment table 205 consists of information for correlating segment sectors with item segments belonging to the segment sector, as shown in FIG. 8.

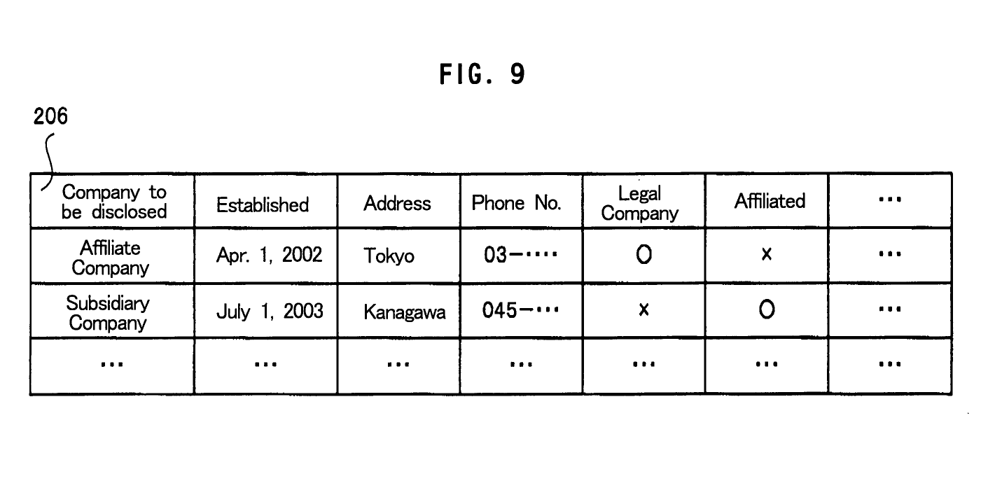

The company attribute table 206 of the company to be disclosed consists of information as to whether data to be entered are associated with a company name, establishment date, address, telephone number, and fax number of a counterparty company and whether the data to be entered are associated with an affiliate company or associated company, as shown in FIG. 9.

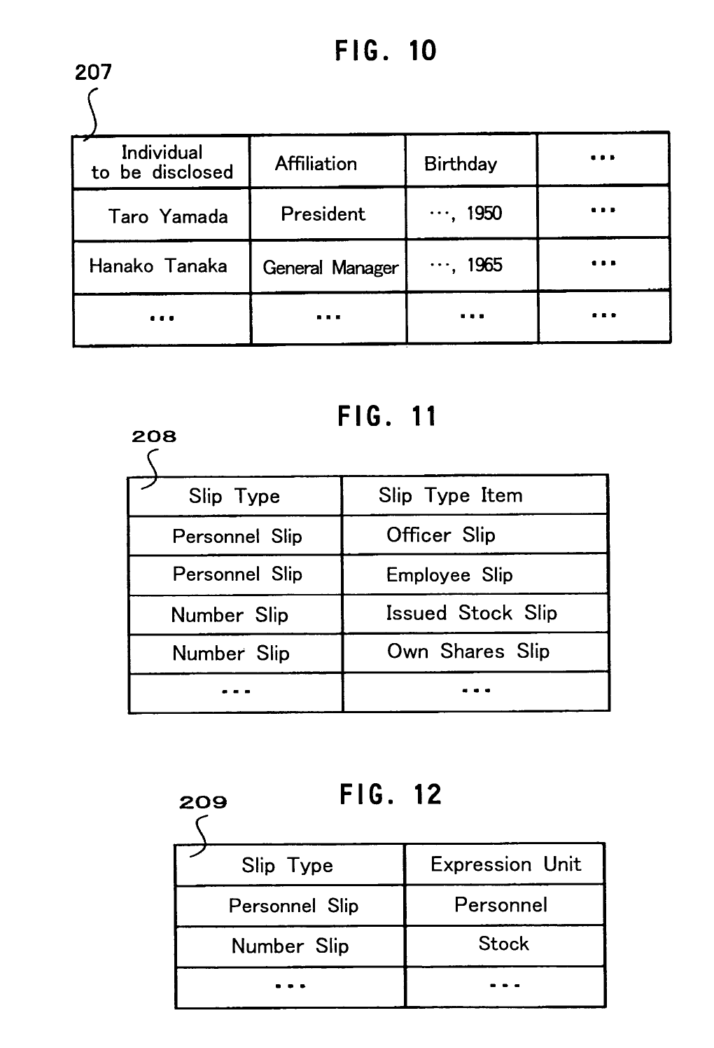

The individual attribute table 207 of an individual to be disclosed consists of individual information of name, division, and birth date of an individual to be entered, as shown in FIG. 10.

The slip type table 208 consists of information of slip types, in which the slip types are associated with details of the slips, as shown in FIG. 11.

The expression unit table 209 consists of information of expression unit, in which the expression unit is associated with the slip type, as shown in FIG. 12.

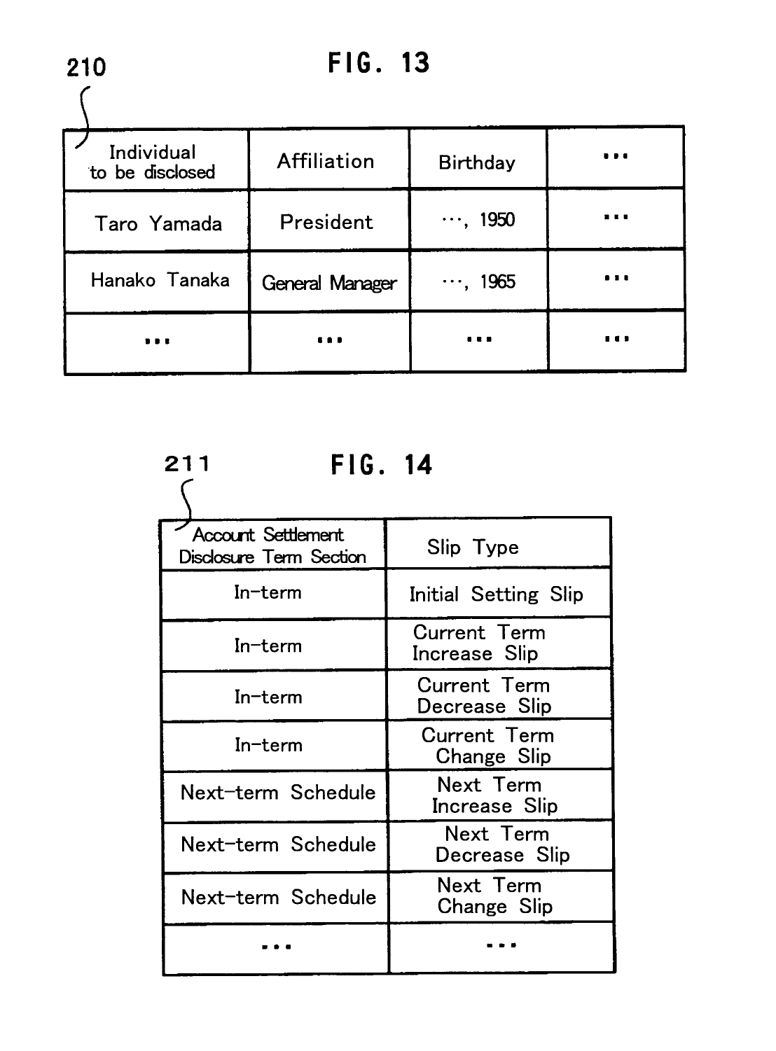

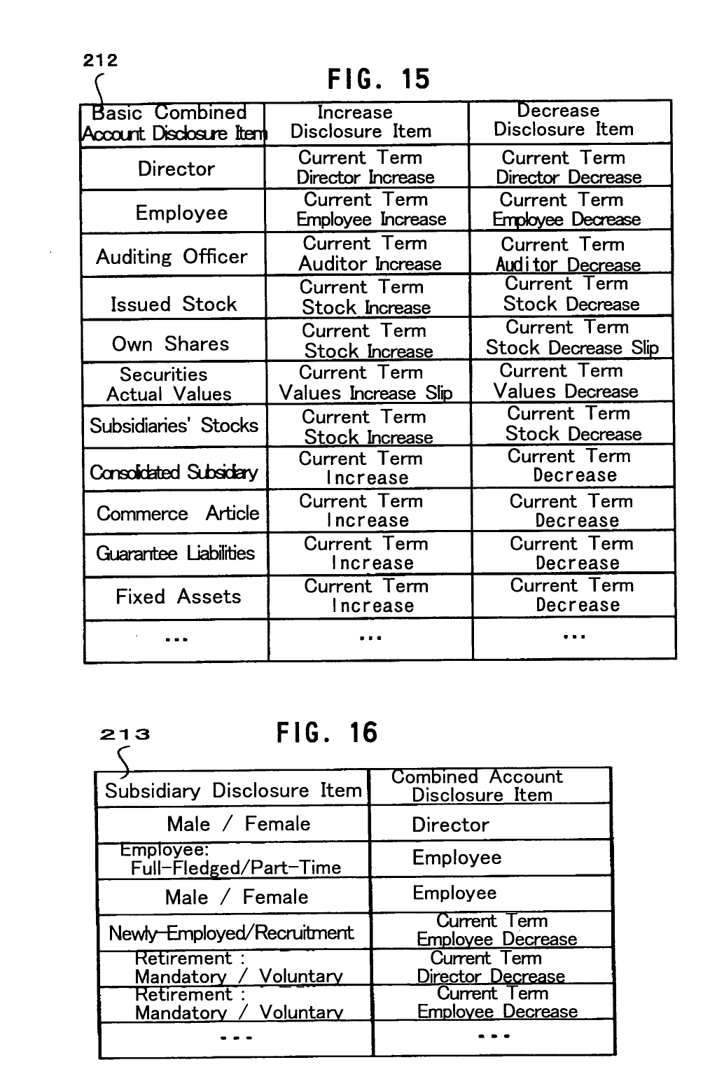

The data entry operator's table 210 consists of information of a data entry operator who inputs the data into the slip, such as the data of division and birth date of the operator, as shown in FIG. 13.

The slip section table 211 consists of information for correlating an account settlement disclosure term section indicating the account settlement disclosure term for each slip with the slip type, as shown in FIG. 14.

The combined account disclosure item table 212 consists of the basic combined account disclosure item, the increase disclosure item and the decrease disclosure item, as shown in FIG. 15.

The subsidiary disclosure item table 213 consists of the subsidiary disclosure item and the combined account disclosure item containing the subsidiary disclosure item, as shown in FIG. 16.

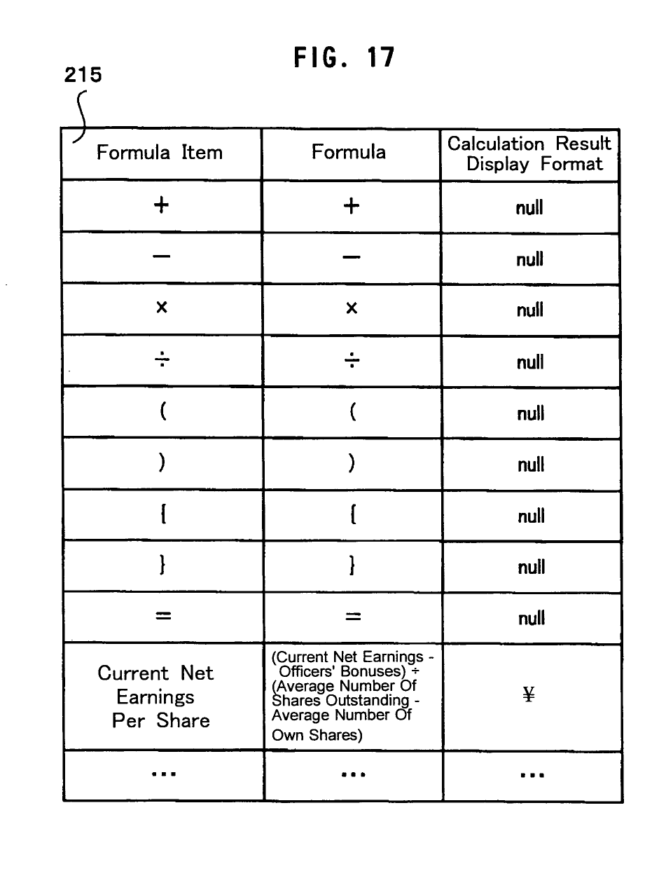

The formula item table 215 consists of a formula item, a calculating formula, and a calculation result display format, as shown in FIG. 17.

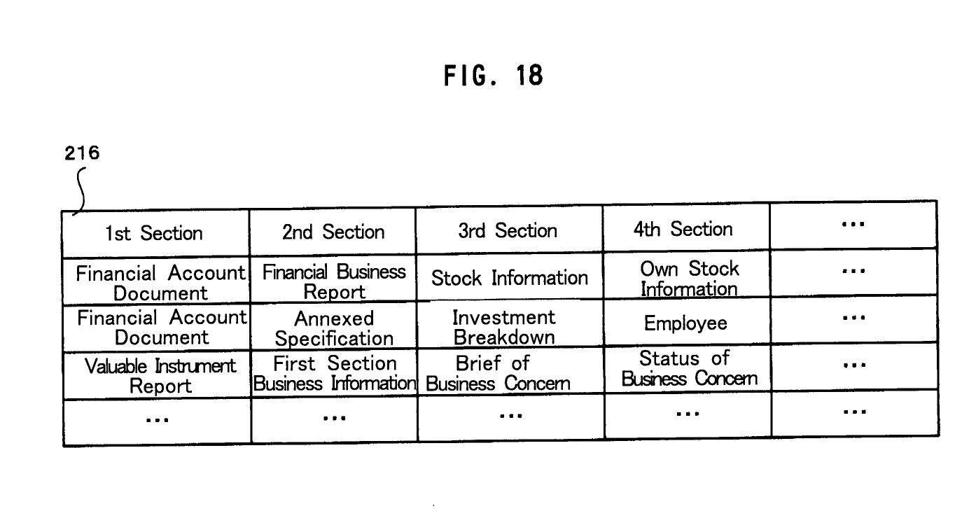

The disclosure section table 216 indicates the disclosure section consisting of first, second, third and fourth sections, as shown in FIG. 18.

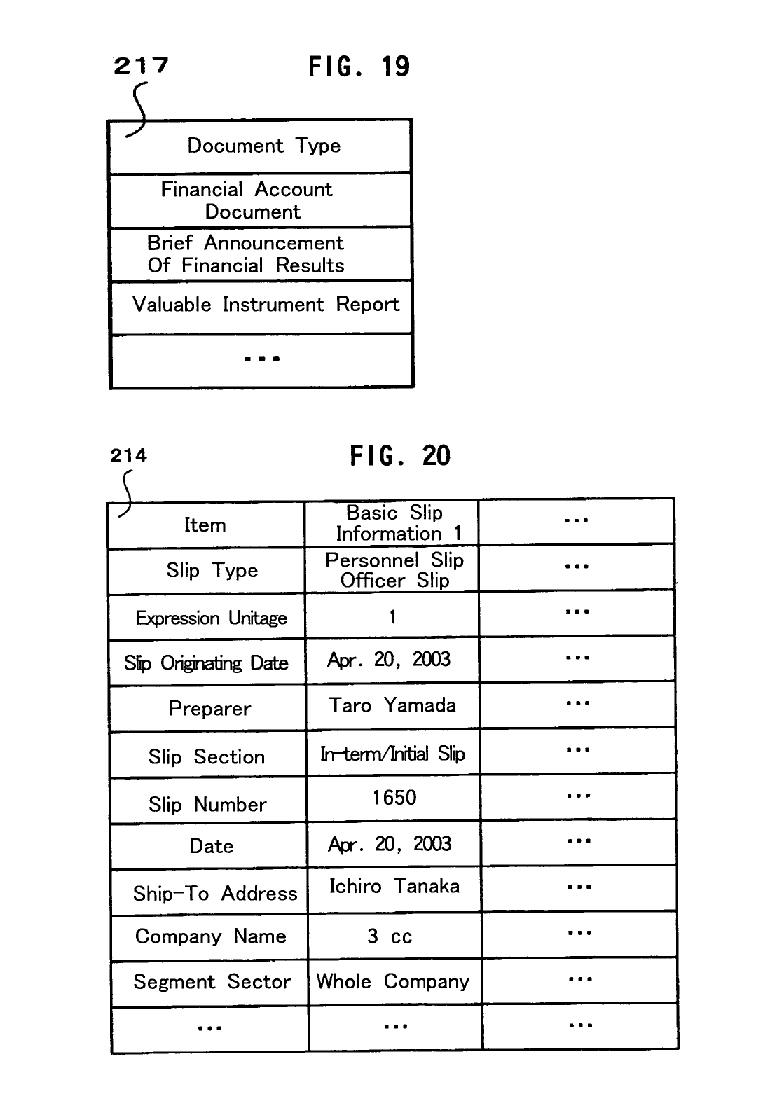

The document type table 217 indicates a document type, as shown in FIG. 19.

The slip information table 214 is a table for storing the inputted basic slip information indicating the item name and slip information, as shown in FIG. 20.

The information stored in these tables can be arbitrarily determined by the mercy of the data entry operator, but not limited only to the above.

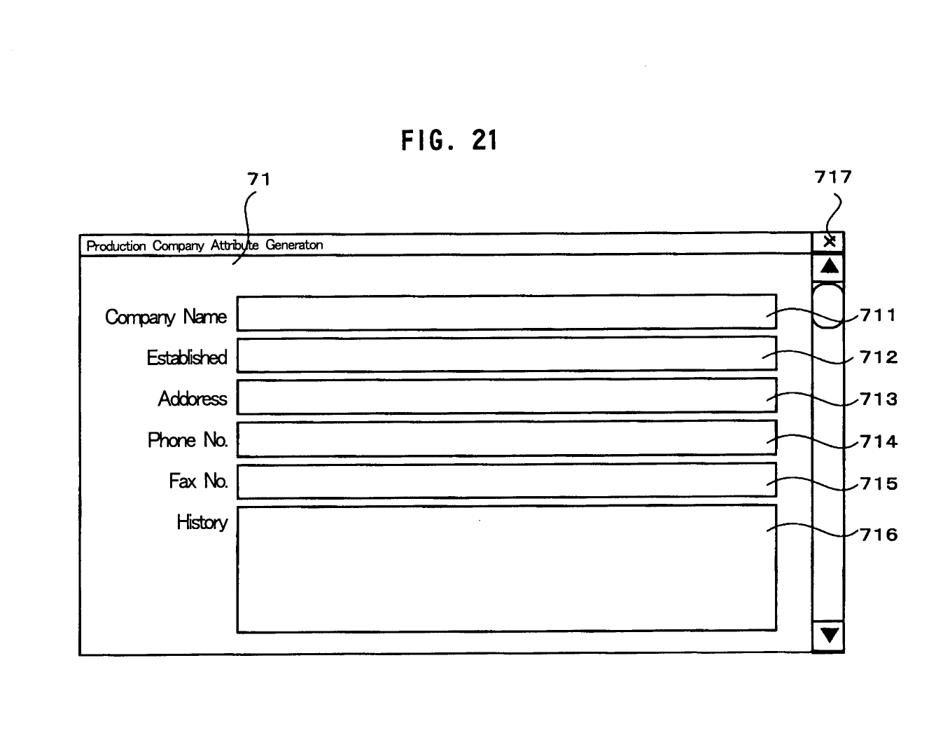

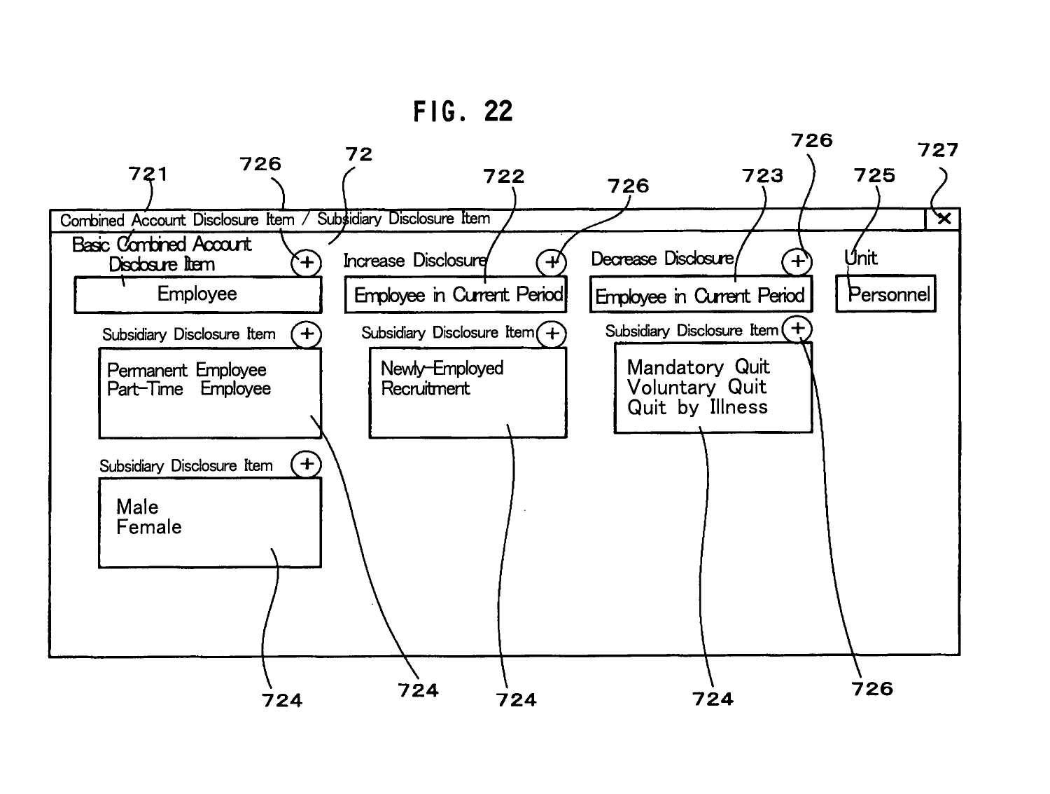

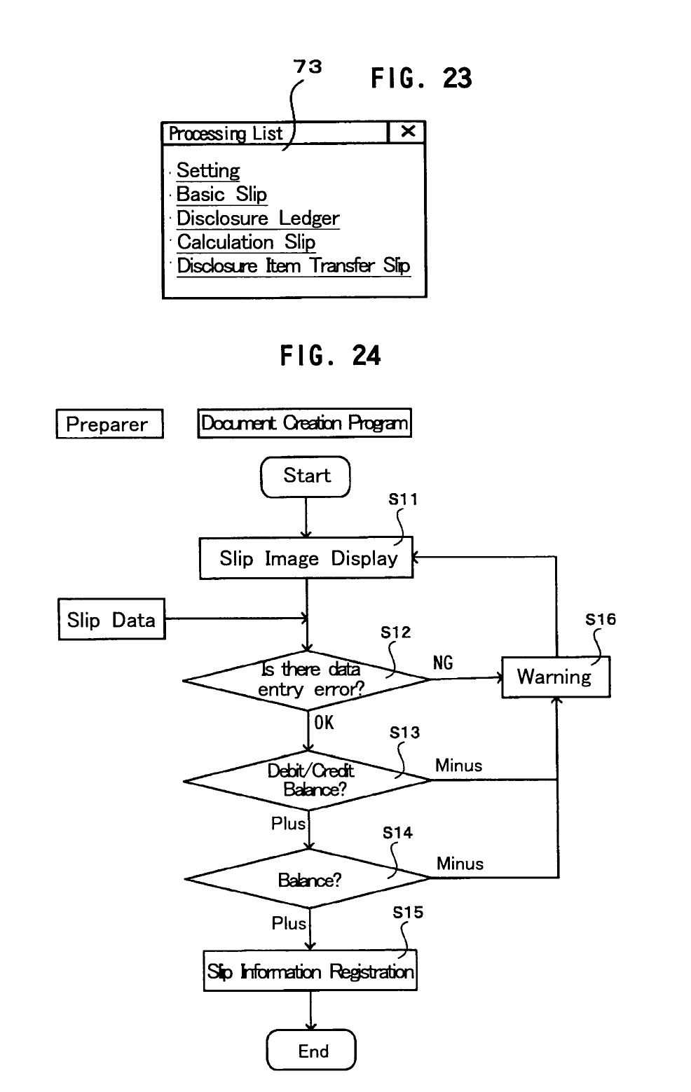

When the document creation program is executed, the processing device 6 performs the list display process 601. That is, the processing device 6 carries out displaying of the item list of processing objects such as the setting button, basic slip, disclosure ledger, calculation slip, and disclosure item transfer slip on the screen of the display device 4, as shown in FIG. 23. When the data entry operator selects the setting button, the processing device 6 operates to display the list of the aforementioned tables on the display device 4. Then, when the operator selects one corresponding to the production company attribute table 201 from the list, the processing device 6 operates to display a production company attribute generating screen 71 on the display device 4 as shown in FIG. 21.

The production company attribute generating screen 71 contains a company name entry field 711 for the name of the company to be entered, an establishment date entry field 712 for the establishment date of the company, an address entry field 713 for the company address, a telephone number entry field 714 for the company telephone number, a fax number entry field 715 for the company fax number, a history entry field 716 for the history of the company, and an end button 717. Each of the entry fields indicates the information stored in the production company attribute table 201, if already stored. When the data entry operator enters any data to any of the entry fields and then presses the end button 717, the data thus entered in the entry fields are stored in the corresponding columns in the production company attribute table 201. Then, the production company attribute generating screen 71 is closed.

Similarly, when the data entry operator selects the combined account disclosure item table 212 from the list of the table preselected from the list of the aforementioned processing objects by using the input device 3, the processing device 6 operates to display a combined account disclosure item generating screen 72 on the display device 4 as shown in FIG. 22.

The combined account disclosure item generating screen contains a basic combined account disclosure item enter field 721 for the basic combined account disclosure item, an increase disclosure item enter field 722 for the increase disclosure item, a decrease disclosure item enter field 723 for the decrease disclosure item, a subsidiary disclosure item enter field 724 subsidiary disclosure item corresponding to the combined account disclosure item, an expression unit enter field 725 for the expression unit, a subsidiary disclosure item addition button 726 for subordinating new subsidiary disclosure item to the combined account disclosure item and subsidiary disclosure item, and an end button 727. In each of the entry fields, information stored in the production company attribute table 201 is displayed. When selecting the subsidiary disclosure item addition button 726, the subsidiary disclosure item enter field 724 subordinated to the corresponding combined account disclosure item or subsidiary disclosure item is newly displayed.

When the operator selects the end button 727 with the input device 3 upon entry of the data into the entry field, the processing device 6 stores the data thus entered to the combined account disclosure item table 212, subsidiary disclosure item table 213 and expression unit table 209 and then closes the combined account disclosure item generating screen 72.

The data in the tables are set up in the manner as stated above. New registration and correction can be made in other tables than the production company attribute table 201 and combined account disclosure item table 212 in the same manner.

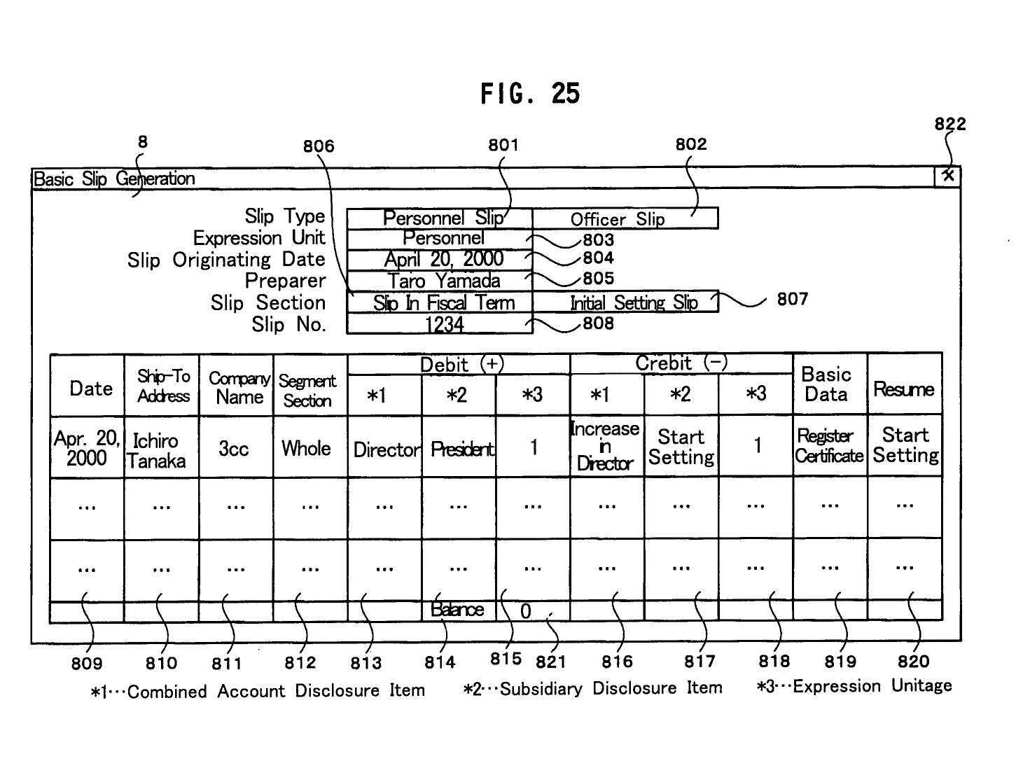

Next, the process of creating the document with the document creation system 1 in the first embodiment of the invention will be described with reference to the flowchart of FIG. 24.

In this embodiment, the processing for non-accounting information such as data of increase/decrease in employee and share of stocks will be mainly performed.

FIG. 25 shows a basic slip image 8 indicating an initial setting slip of an officer slip. The initial setting of the officer is configured using the initial setting slip.

First, when the document creation program starts, the processing device 6 performs the list display process 601 to display on the display device 4 the processing list image 73 containing the processing object items of the setting item, basic slip, disclosure ledger, accounting ledger and disclosure item transfer slip. When the operator selects the basic slip with the input device 3, the processing device 6 perform the basic slip image display process 602 to display the basic slip image 8 on the display device 4 (S11).

On the top of the basic slip image 8, there are displayed a slip type entry field 801 for the slip type, a slip type item entry field 802 for the slip type item, an expression unit type enter field 803 for the expression unit, a slip originating date entry field 804 for a date to originate the slip, an operator name entry field 805 for the name of the operator, a slip section entry field 806 for the slip section, a slip section item entry field 807 for the slip section item, and a slip number display column 808 for the slip number.

Similarly, in the central part of the basic slip image 8, there are displayed a date entry field 809 for the date, a ship-to address entry field 810 for a ship-to address, a company name entry field 811, a segment sector entry field 812, a combined debit account title entry field 813, a subsidiary item entry field 814, an expression unitage entry field 815, a combined credit account title entry field 816, a subsidiary item entry field 817, an expression unitage entry field 818, a basic data entry field 819, a resume entry field 820, and a balance amount display column 821.

The basic slip image 8 further contains an end button 822 for finalizing the process upon completion of the data entry into the slips and data storage.

When the operator selects the slip type entry field 801 with the input device 3, the list of the slip type is displayed on the display device 4. As the slip types enumerated on the display device, there are an “employee slip” and a “shares slip.” When the operator selects one of the items in the list with the input device 3, the selected slip type is determined to display the selected one in the slip type entry field 801.

When the operator selects the slip type item entry field 802 with the input device 3, the list of the slip type items stored in the slip type table 208. As the slip type item enumerated in the list, there are an “officer slip” and “employee slip” where the employee slip is selected as the slip type. When the operator selects one of the items in the list with the input device 3, the selected item is determined as the slip type item and displayed in the slip type item entry field 802.

When the operator selects the expression unit type enter field 803 with the input device 3, the list of the expression units is displayed on the display device 4. The expression units enumerated in the list are “yen” and “personnel” stored in the expression unit table 209. For instance, when a personnel slip is selected in the slip type entry field, “personnel” hanging from the personnel slip is displayed. When the operator selects one item from the list by using the input device 3, the selected item is set as the expression unit type and displayed in the expression unit type enter field 803.

When the operator selects the lip originating date entry field 804 with the input device 3, a calendar is displayed on the display unit 4, while a current day is determined as an originating date and displayed in the slip originating date entry field 804. At this time, a date value may be entered manually with the input device 3 such as a keyboard.

When the operator selects the operator name entry field 805 with the input device 3, a list of operator's names stored in the data entry operator's table 210 is displayed on the display device 4. When selecting one item from the list with the input device 3, the selected item is set as the operator name and displayed in the operator name entry field 805.

When the operator selects the slip section entry field 806 by using the input device 3, the list of slip sections stored in the slip section table 211 is displayed on the display device 4. When the operator selects one item from the list with the input device 3, the selected item is set as the slip section and displayed in the slip section entry field 806.

When the operator selects the slip section item entry field 807 by using the input device 3, the list of slip section items stored in the slip section table 211 is displayed on the display device 4. When the operator selects one item from the list with the input device 3, the selected item is set as the slip section item and displayed in the slip section item entry field 807.

In the slip number display column 808, there is displayed a slip number for previously specifying the respective slips to be treated.

When the operator selects the date entry field 809 by using the input device 3, a calendar is displayed on the display device 4. When the operator selects a date with the input device 3, the selected date is set and displayed in the date entry field 808. At this time, a date value may be entered manually by using the input device 3 such as the keyboard. The current date value is set previously in the date entry field as a default.

When the operator selects the ship-to address entry field 810 by using the input device 3, the name list stored in the individual attribute table 207 is displayed on the display device 4. When the operator selects one item from the list with the input device 3, the selected item is set as the ship-to address item and displayed in the ship-to address entry field 810.

When the operator selects the company name entry field 811 by using the input device 3, the company list stored in the company attribute table 206 is displayed on the display device 4. When the operator selects one item from the list with the input device 3, the selected item is set as the company name and displayed in the company name entry field 811.

When the operator selects the segment sector entry field 812 by using the input device 3, the list of items stored in the segment table 205 is displayed on the display device 4. When the operator selects one item from the list with the input device 3, the selected item is set as the segment sector and displayed in the segment sector entry field 812.

When the operator selects the combined debit account title entry field 813 by using the input device 3, the list of items stored in the combined account disclosure item table 212 is displayed on the display device 4. When the operator selects one item from the list with the input device 3, the selected item is set as the combined account disclosure item and displayed in the combined debit account title entry field 813.

When the operator selects the subsidiary item entry field 814 by using the input device 3, the list of items, which are stored in the subsidiary disclosure item table 213 and subordinated only to the combined account disclosure item selected above, is displayed on the display device 4. When the operator selects one item from the list with the input device 3, the selected item is set as the subsidiary item and displayed in the subsidiary item entry field 814. At this time, a plurality of the subsidiary items may be selected.

In the expression unitage entry field 815 on the debit side, “one” personnel is set as a default and cannot be changed in this slip, but may be changed according to the slips.

In the same manner as that on the debit side, the operator enters data into the combined credit account title entry field 816, subsidiary item entry field 817, and expression unitage entry field 818.

When the operator selects the basic data entry field 819 by using the input device 3, the basic data entry field 819 becomes active, so that the operator can enter the basic data with the input device 3 to set the entered data as the basic data item.

When the operator selects the resume entry field 820 by using the input device 3, the resume entry field 820 becomes active, so that the operator can enter the resume data with the input device 3 to set the entered data as the resume data item.

Each time the operator enters the data into the respective entry fields, a balance amount at the time of data entry is displayed in the balance amount display column 821.

The data entry operation is performed by the data entry operator in the manner as above.

Meanwhile, even after setting the aforementioned items, when any of the entered items is again selected with the input device 3, the processing device 6 operates to display the similar list to the above on the display device 4, so that the operator can again select and edit the setting of the selected item.

When the operator selects the end button 822 upon completion of entering the data into the initial setting slip of the personnel slip (officer slip), the processing device 6 operates to determine whether or not there is an entry field having no input data (S12). At that time, if there is such a non-input entry filed, the processing device displays that state on the display device 4 to ask for the operator to enter the required data (S16→S11).

This process has further a function of determining whether the balance amount calculated from the information inputted by the operator is positive or not (S13). At that time, if the balance amount is negative, the processing device 6 displays that state on the display device 4 to ask for the operator to reenter the required data (S16→S11).

This process has further a function of determining whether a current term outstanding balance calculated from the information inputted by the operator and the information stored in slip information table 214 is positive or not (S14). At that time, if the current term outstanding balance is negative, the processing device 6 displays that state on the display device 4 to ask for the operator to reenter the required data (S16→S11).

And then, the processing device 6 performs the basic slip information registration process 603 to store the information inputted by the operator in the slip information table 214 of the database 2 (S15). That is, in the corresponding columns of the slip information table 214, there are stored information data of the slip type, expression unit type, slip originating date, operator name, slip section, slip number, date, ship-to address, company name, segment sector, combined account title, subsidiary item, and expression unitage on the debit, combined account title, subsidiary item, and expression unitage on the credit, basic data entry and resume.

Further, inputting of the data to other slips is carried out in the same manner as above.

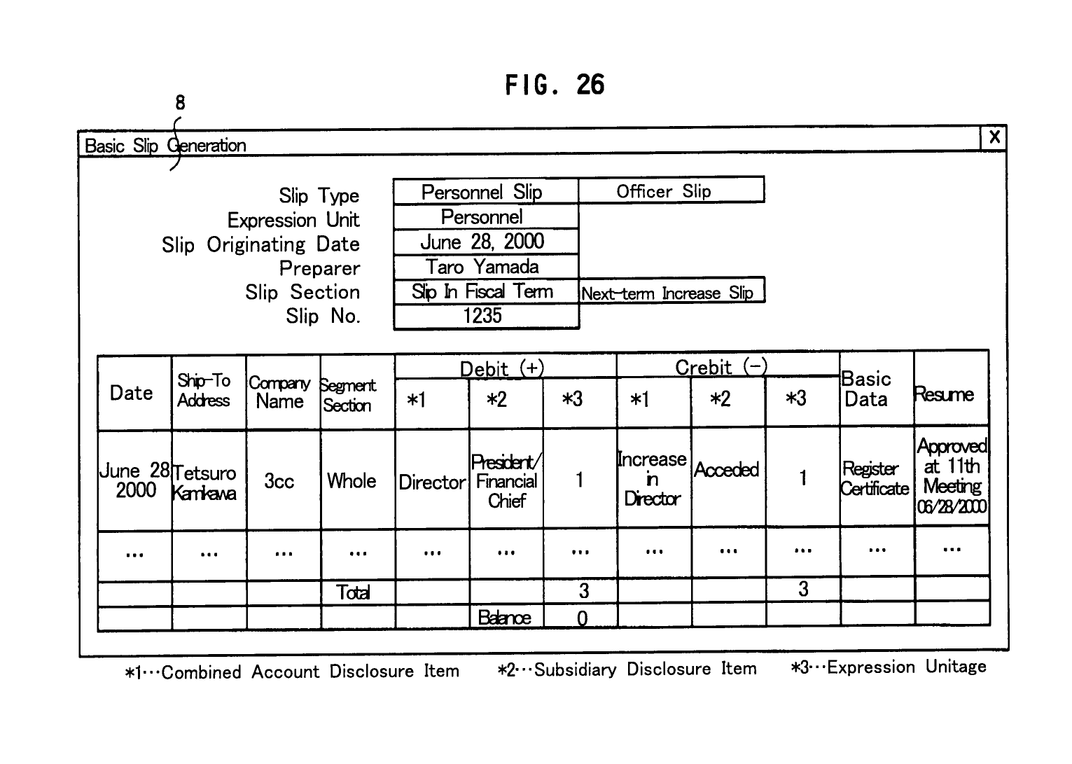

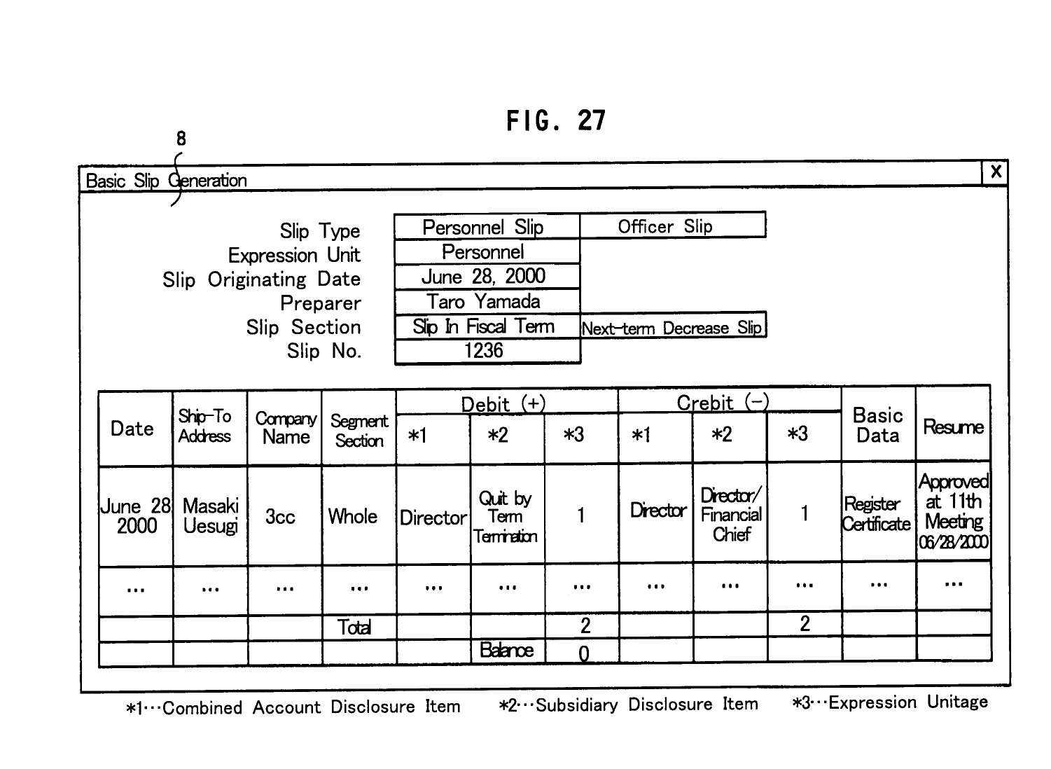

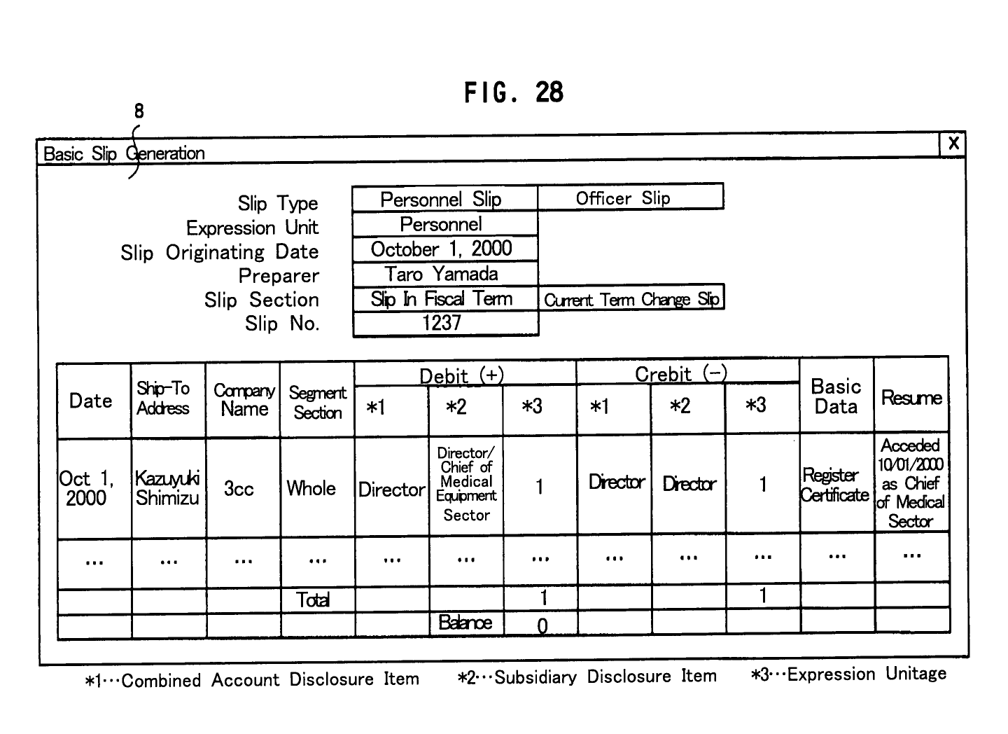

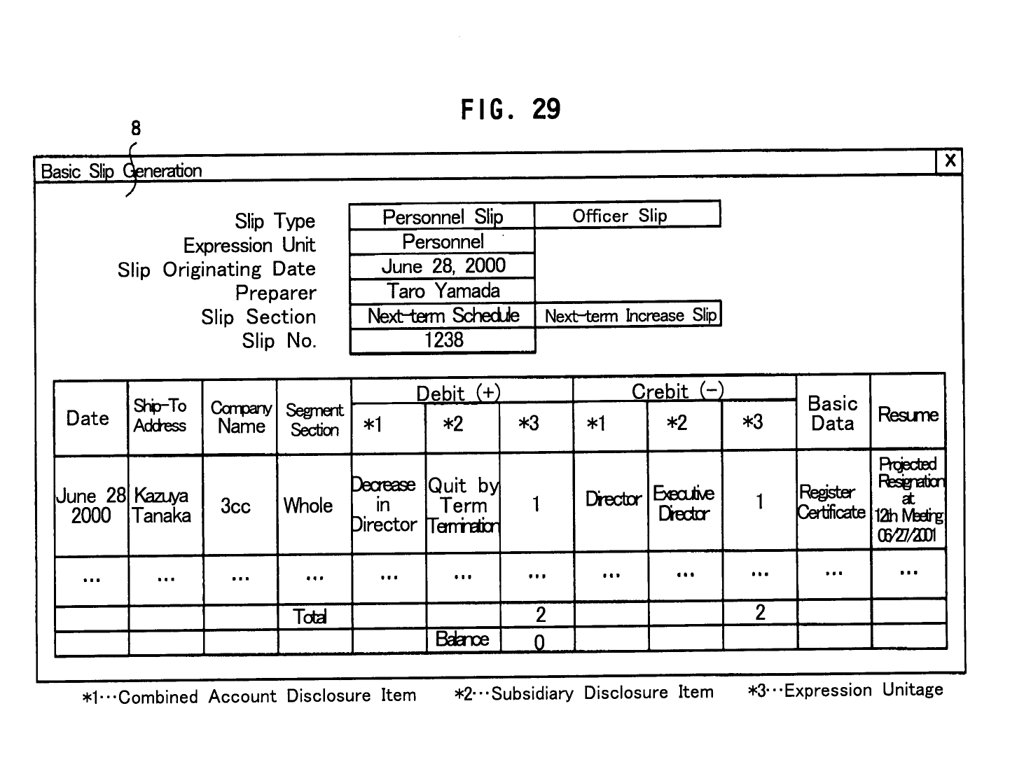

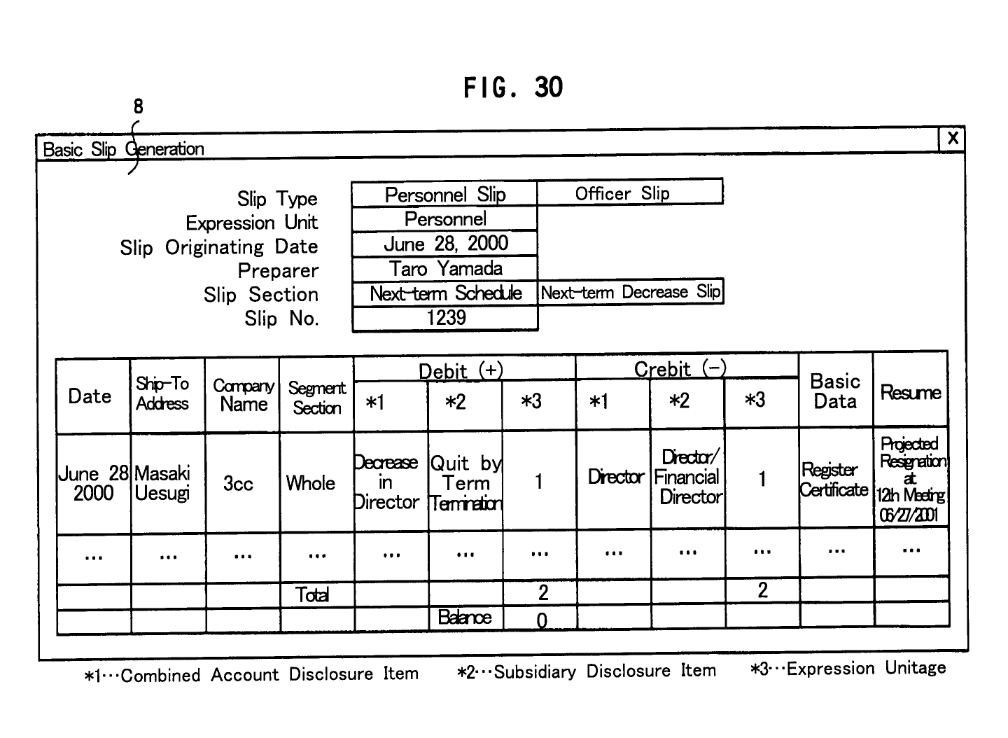

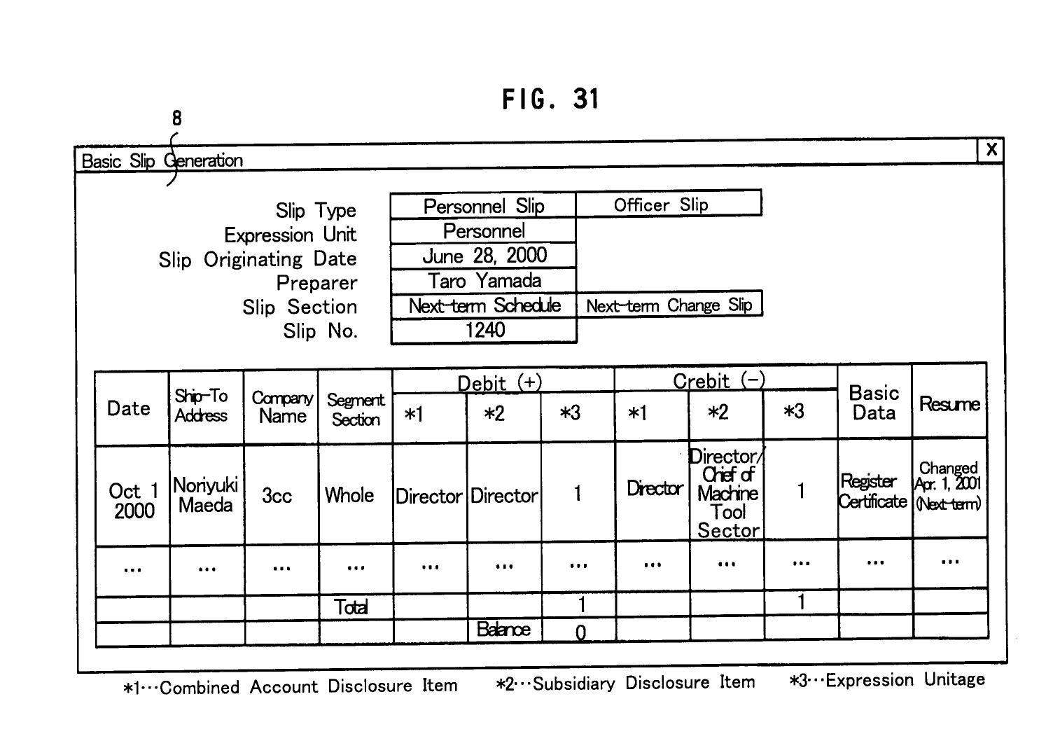

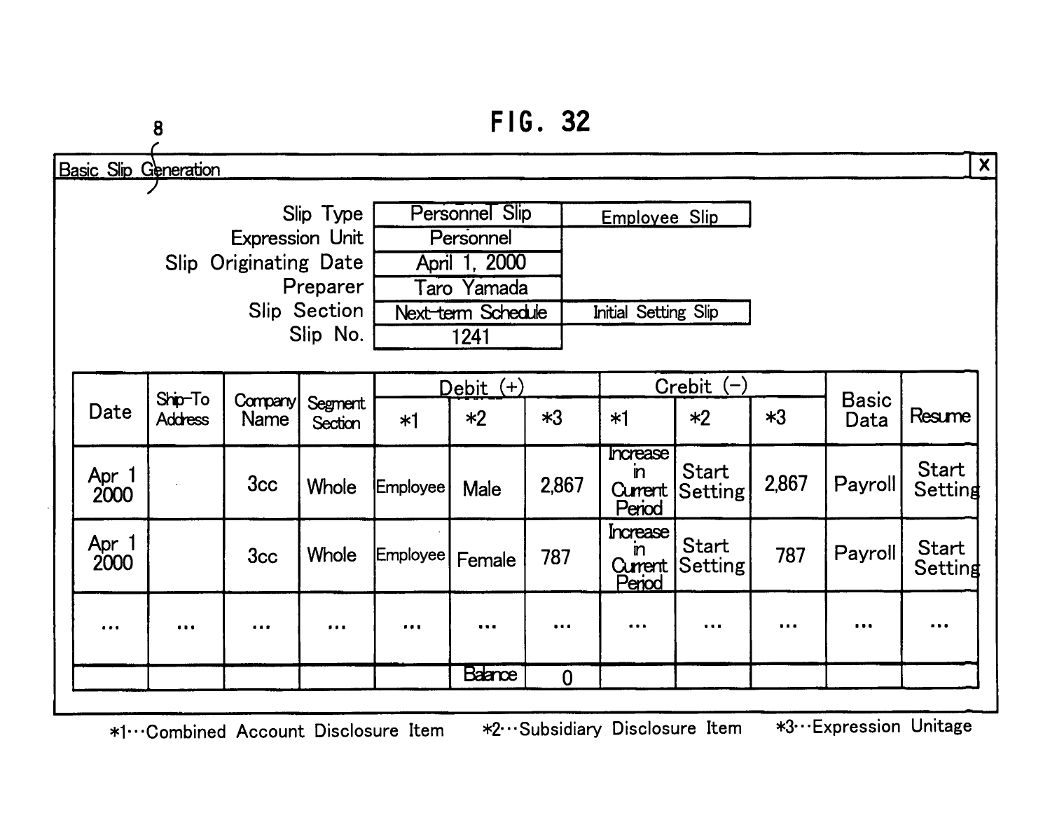

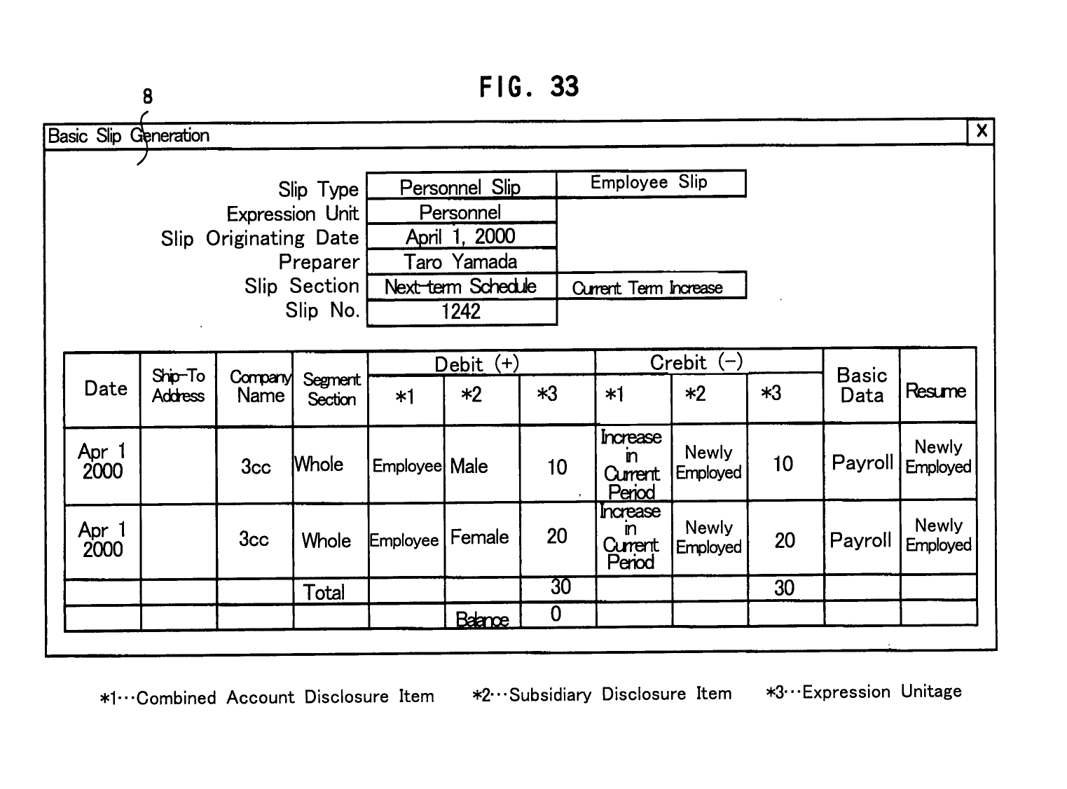

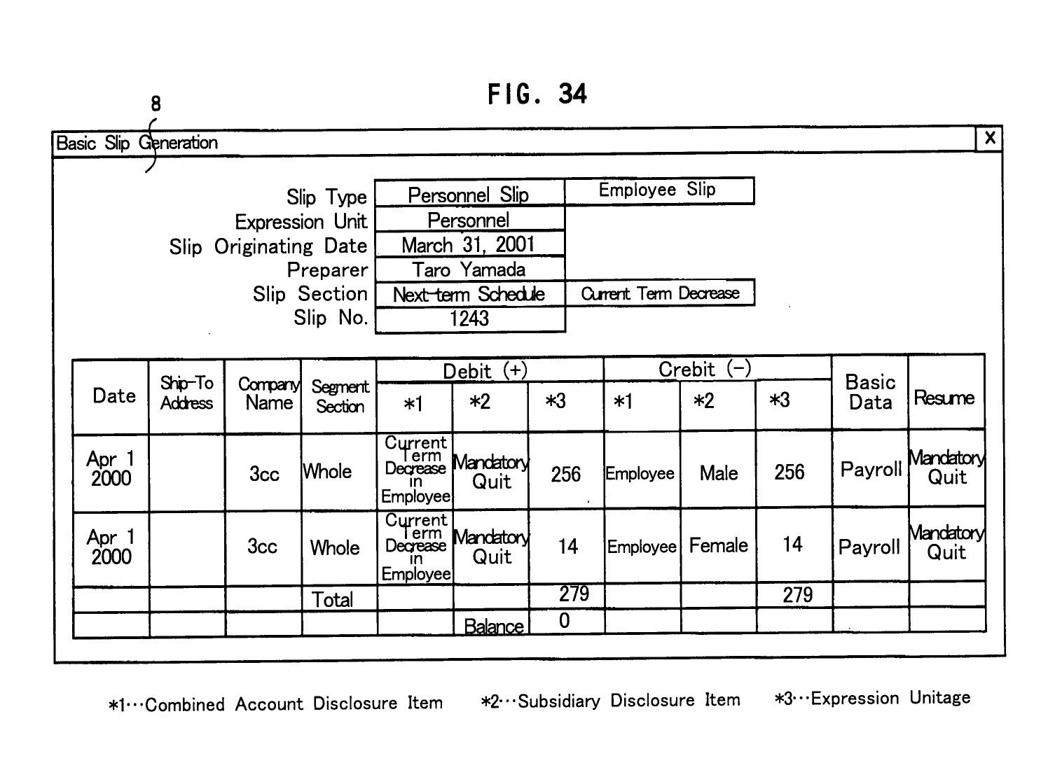

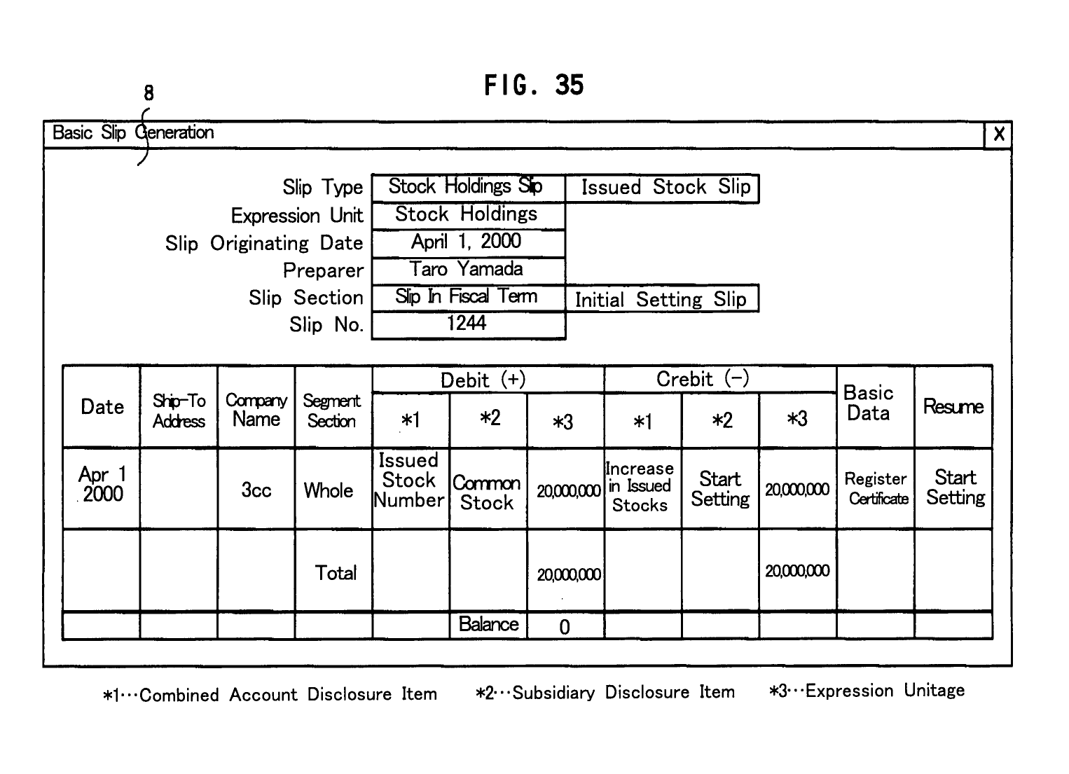

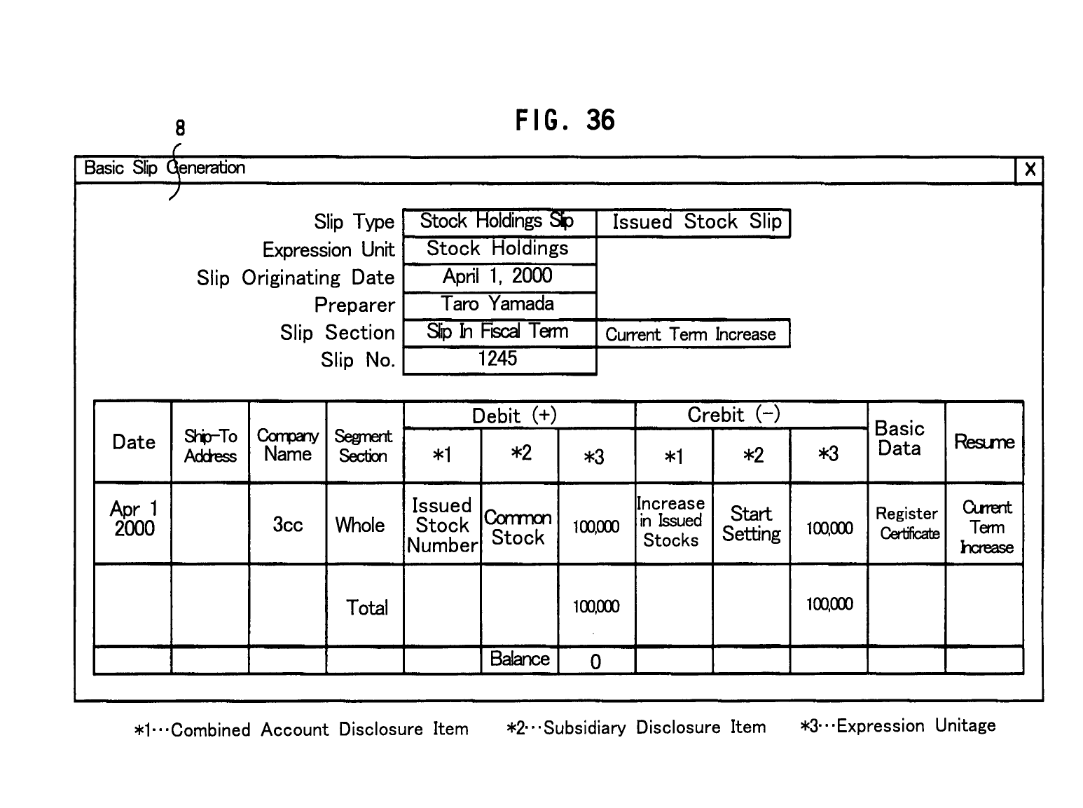

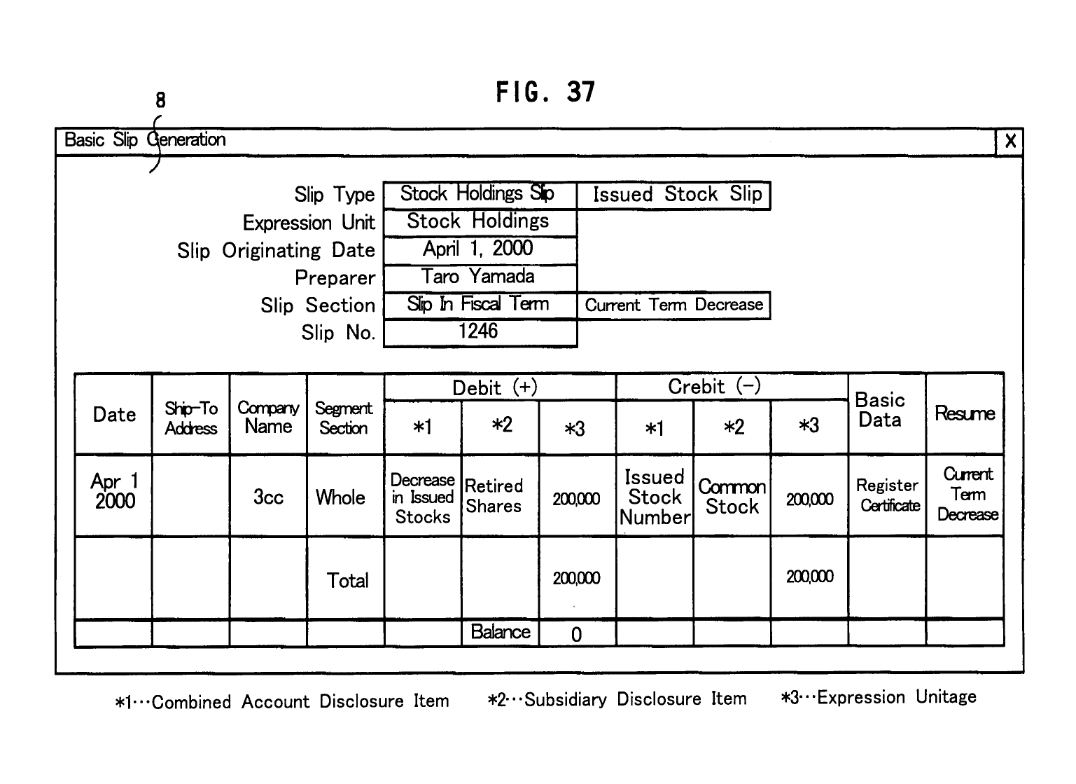

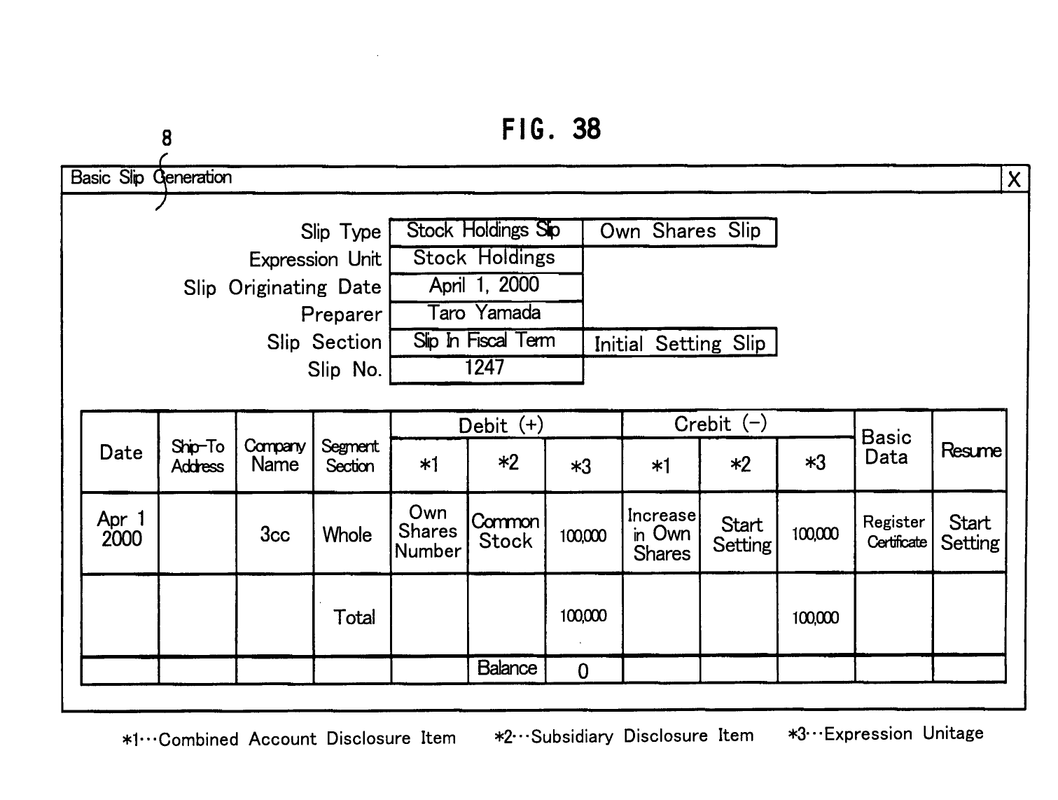

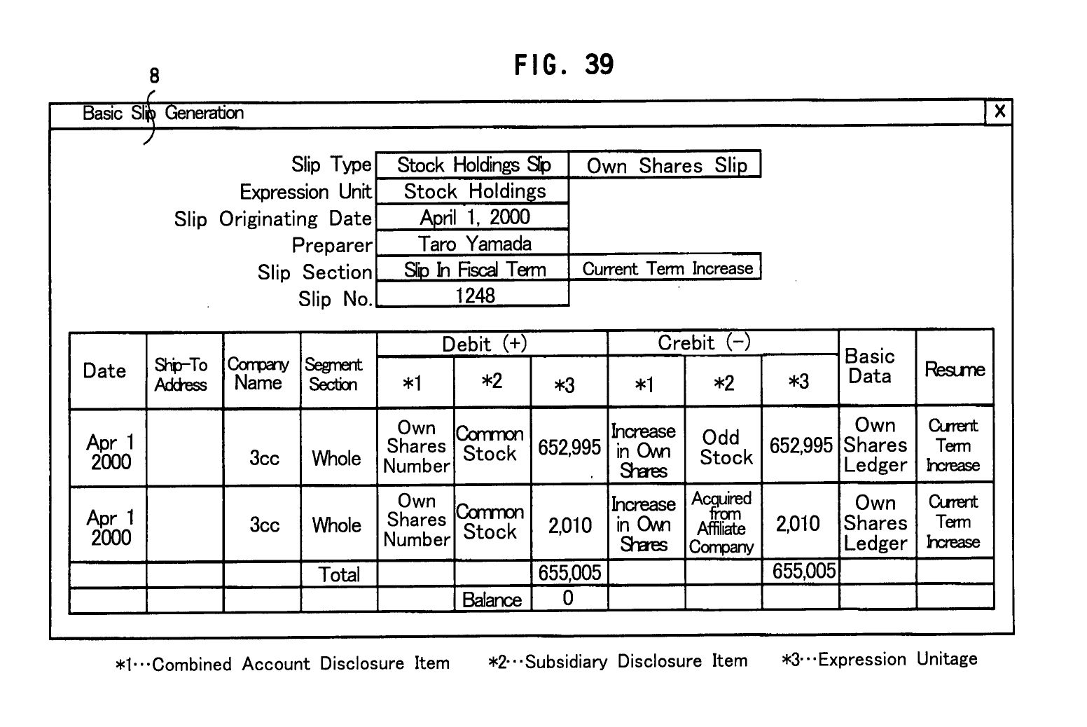

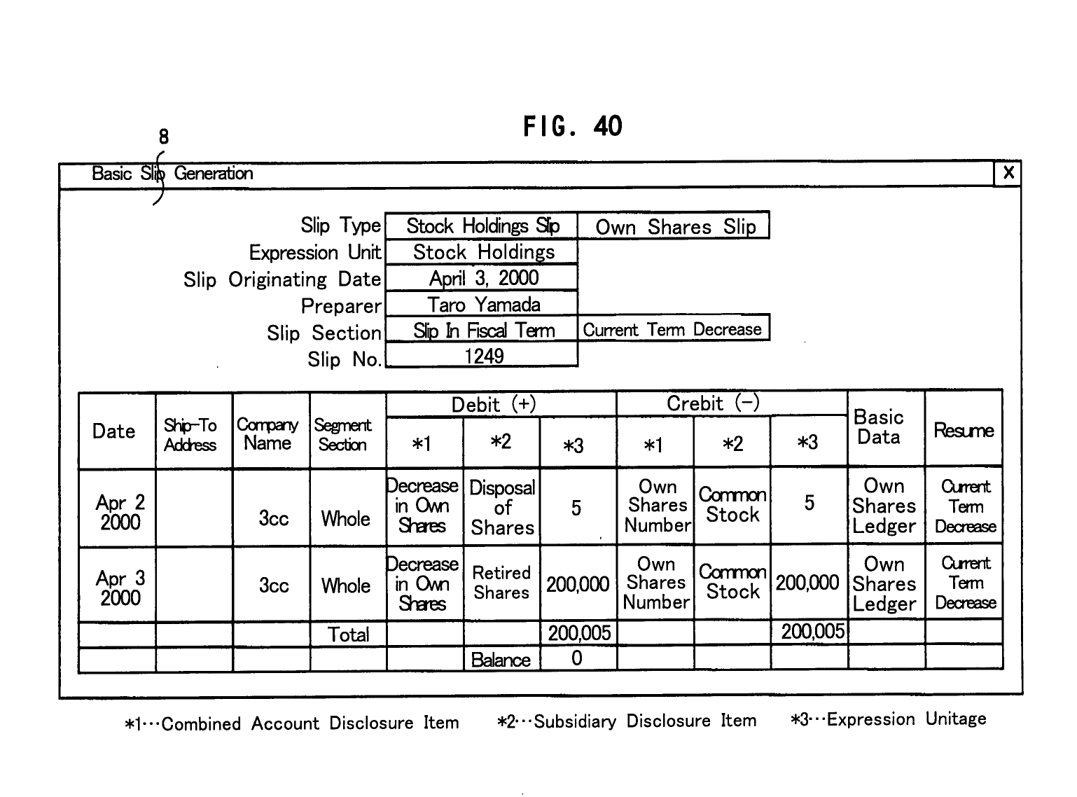

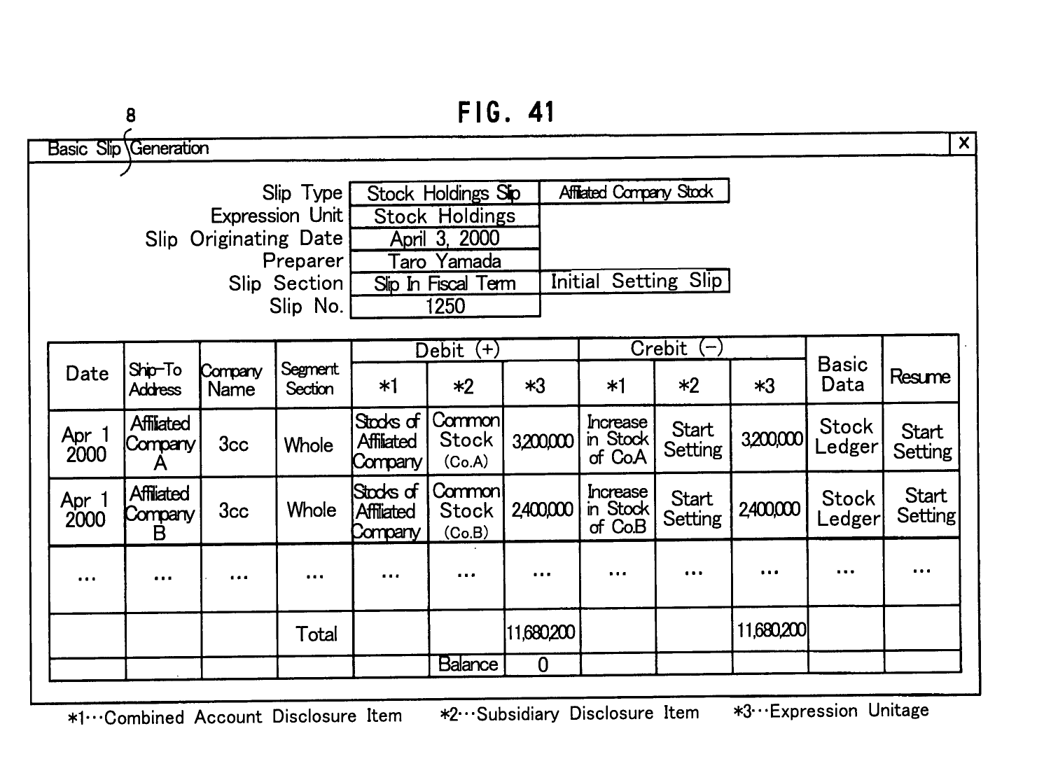

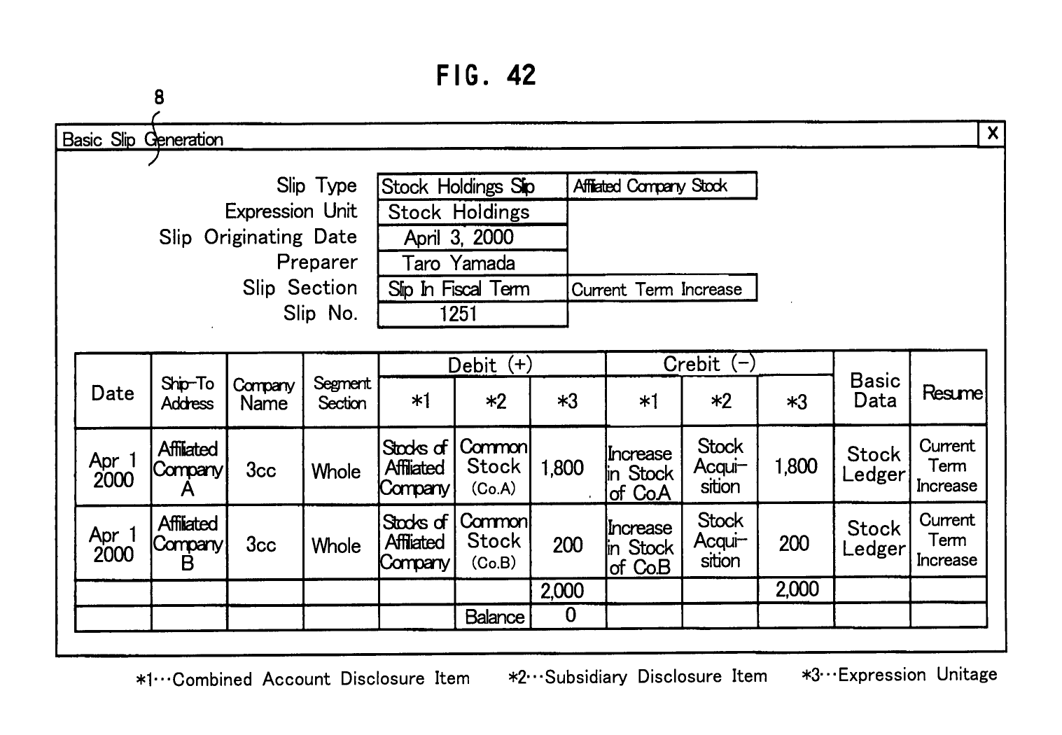

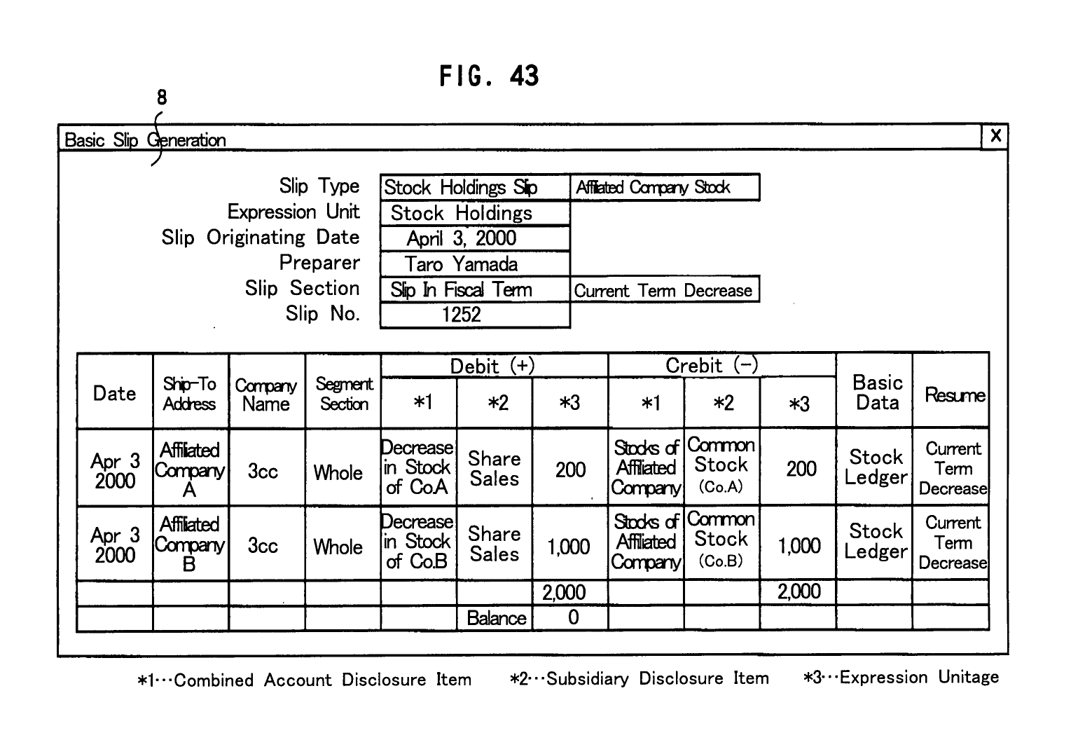

FIG. 26 through FIG. 43 show various slip images of a current term increase slip and current term decrease slip of the officer slips. Data inputting to these slips is performed in the same manner as above.

Next, the disclosure ledger preparation process 604 for making the disclosure ledger on the basis of the basic slip inputted by the operator will be described.

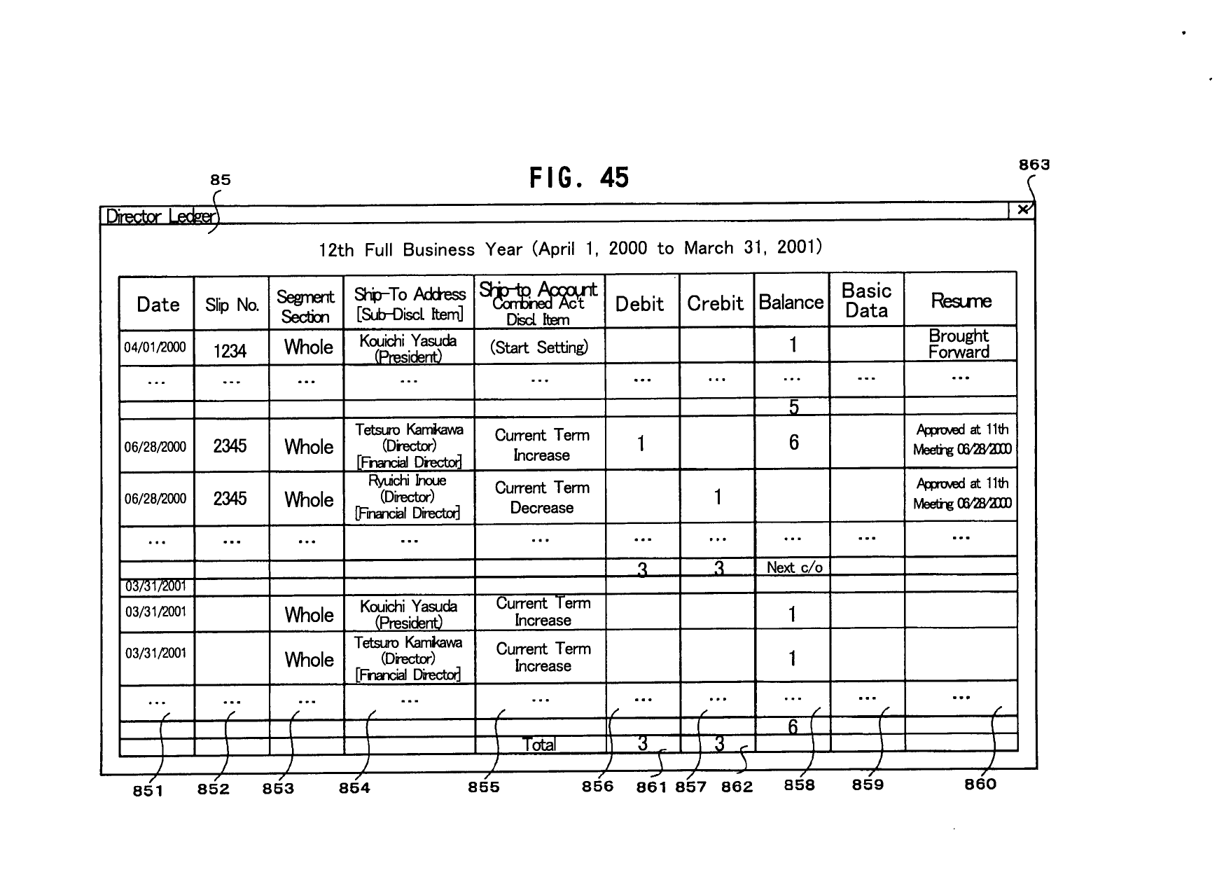

When the document creation program starts, the processing device 6 performs the list display process 601 to display the processing list image 73 indicating the list of the aforesaid items to be treated on the display device 4. When the operator selects the disclosure ledger with the inputting device 3, the processing device 6 performs the disclosure ledger preparation process 604 for making the disclosure ledger from the information of the basic slip in the manner as described below while performing the disclosure ledger display process 605 for displaying a disclosure ledger image 85 on the display device 4 as shown in FIG. 45.

The disclosure ledger image indicates a combined account disclosure item enter field (not shown) for entering the combined account disclosure item, a subsidiary disclosure item enter field (not shown) for entering the subsidiary disclosure item, date entry field 851 for an accounting term start date or accounting term end date, slip number entry column 852 for the slip number, segment sector entry field 853 for the segment sector, ship-to address entry field 854 for the ship-to address, ship-to account combined debit account title entry field 855 for the ship-to account combined debit account title, debit entry field 856 for the debit numeric value, credit entry field 857 for the credit numeric value, balance display column 858 for indicating the outstanding balance, basic data entry field 859 for the basic data, resume entry field 860 for the resume, debit total display column 861 for indicating the debit total, and credit total display column 862 for indicating the credit total.

The disclosure ledger image has an end button 863 for terminating the inputting into the disclosure ledger.

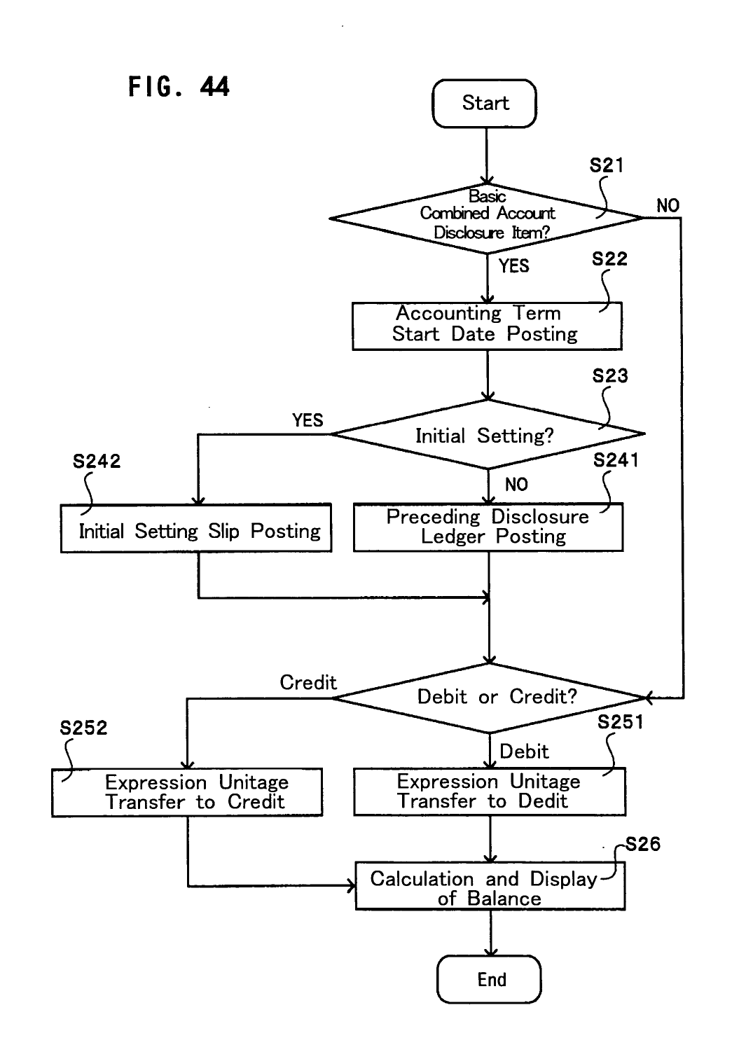

Next, the disclosure ledger preparation process 604 for making the disclosure ledger on the basis of the basic slip inputted by the operator will be disclosed with reference to the flowchart of FIG. 44.

When the operator selects the basic combined account disclosure item or subsidiary disclosure item with the input device 3, the processing device 5 determines whether or not the selected basic combined account disclosure item or subsidiary disclosure item is the basic combined account disclosure item (S21).

When it is the basic combined account disclosure item, the accounting term start date is displayed in the date entry field 851 of balance brought forward data (S22). Further, determination as to whether or not it is the initial setting slip in the initial setting is made (S23). At that time, if it is not the initial setting slip, the data entered in the preceding disclosure ledger are displayed as the balance brought forward data of the current disclosure ledger (S241). That is, the slip number, segment sector, slip-to address, ship-to account combined debit account title, basic data and resume of the aforementioned disclosure ledger are displayed in the respective entry fields while displaying the aforesaid basic combined account disclosure item in the ship-to account combined debit account title entry field along with the combined debit account disclosure item in case of debit or the combined credit account disclosure item in case of credit. Similarly, in a case of the initial setting slip, the information inputted in the initial setting slip is displayed as the balance brought forward data (S242).

Regardless as to whether or not the selected combined account disclosure item is the basic combined account disclosure item, when the basic combined account disclosure item is a debit account, the expression unitage on the credit of the slip is displayed in the debit entry field 856 (S251) while displaying in the balance display column 858 a value calculated from “balance=previous day's balance+debit value−credit value”. When the basic combined account disclosure item is a credit account, the expression unitage on the credit of the slip is displayed in the credit entry field 857 (S252) while displaying in the balance display column 858 a value calculated from “balance=previous day's balance+credit value−debit value” (S26).

Then, the processing device 6 calculates sum totals of the expressing unitages during the settlement period with respect to the debit and credit and displays the calculated sum totals in the debit total display column 861 and credit total display column 862, respectively.

The ledger is made on the basis of the basic slip information stored in the database 2 by the processing device 6 as stated above, but the operator may enter the data to the respective entry fields with the input device 3.

By registering and applying for journalization the basic combined account disclosure item which is subject to management, increase disclosure item concerning the increase in the subject and decrease disclosure item concerning the decrease in the subject, journalizing and ledger can be managed even if a plurality of subjects are managed to handle accounting information and non-accounting information, so that the desired document can be effectively made by using the information in charge of the database. By using an item concerning the description of the document, the journalization can be made with the subsidiary disclosure item to provide more accurate information for the document.

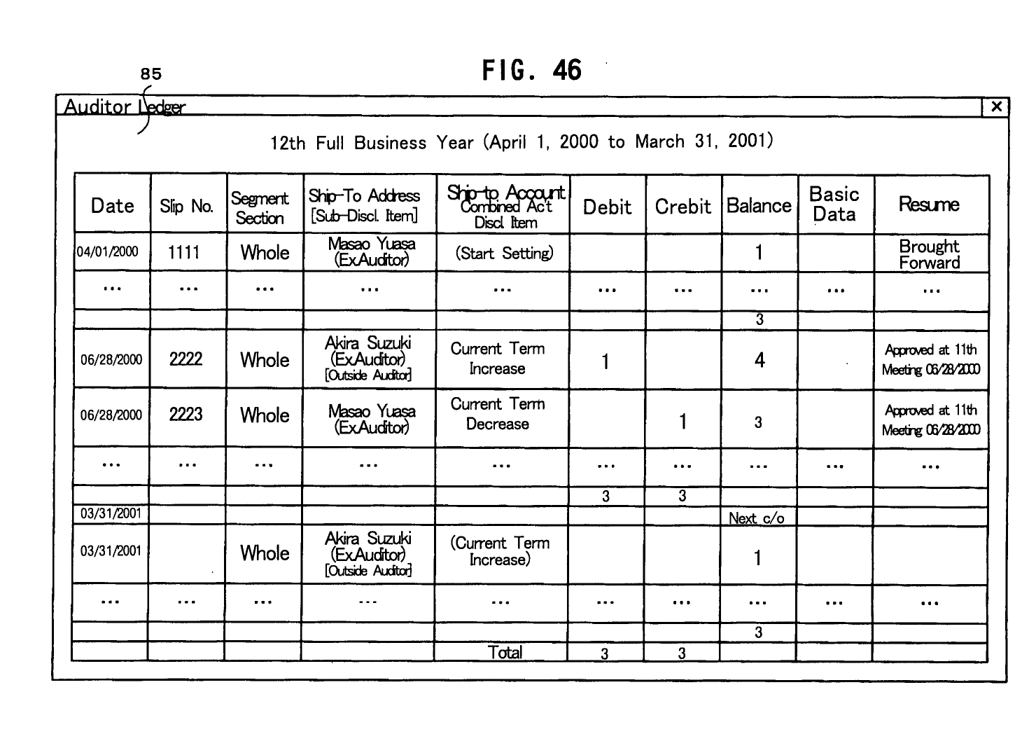

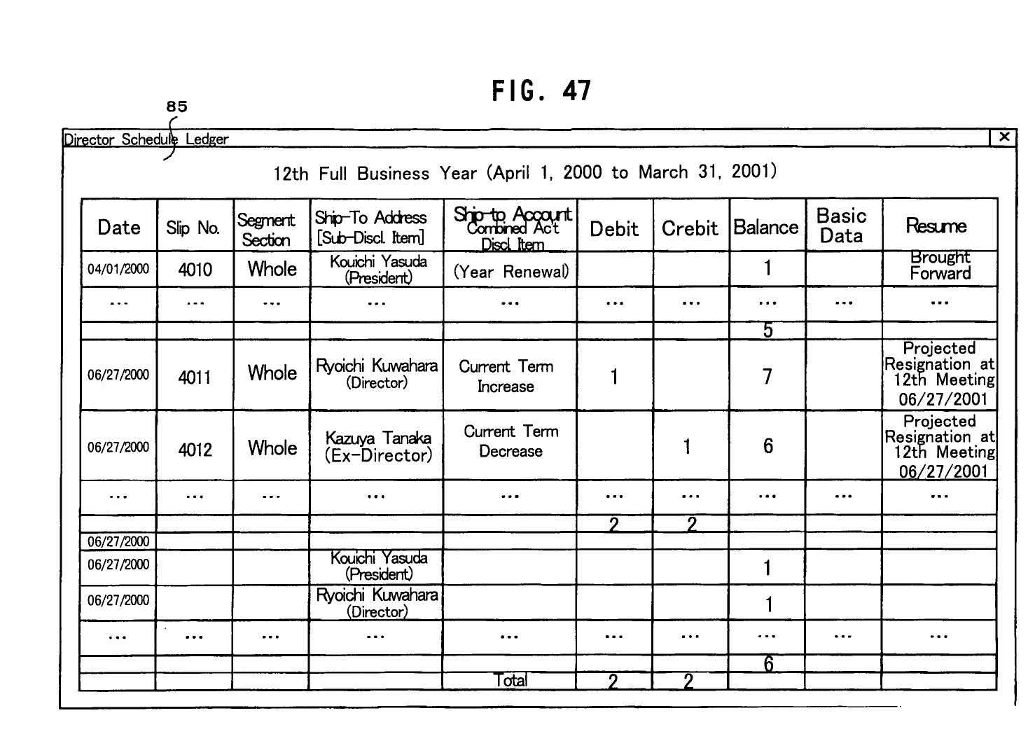

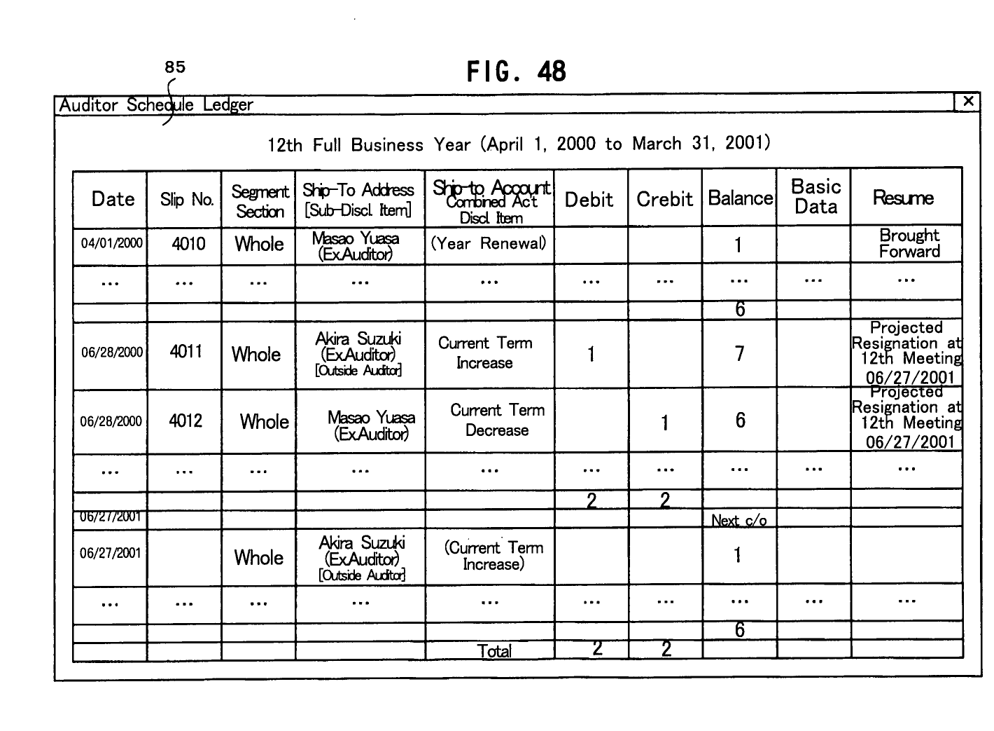

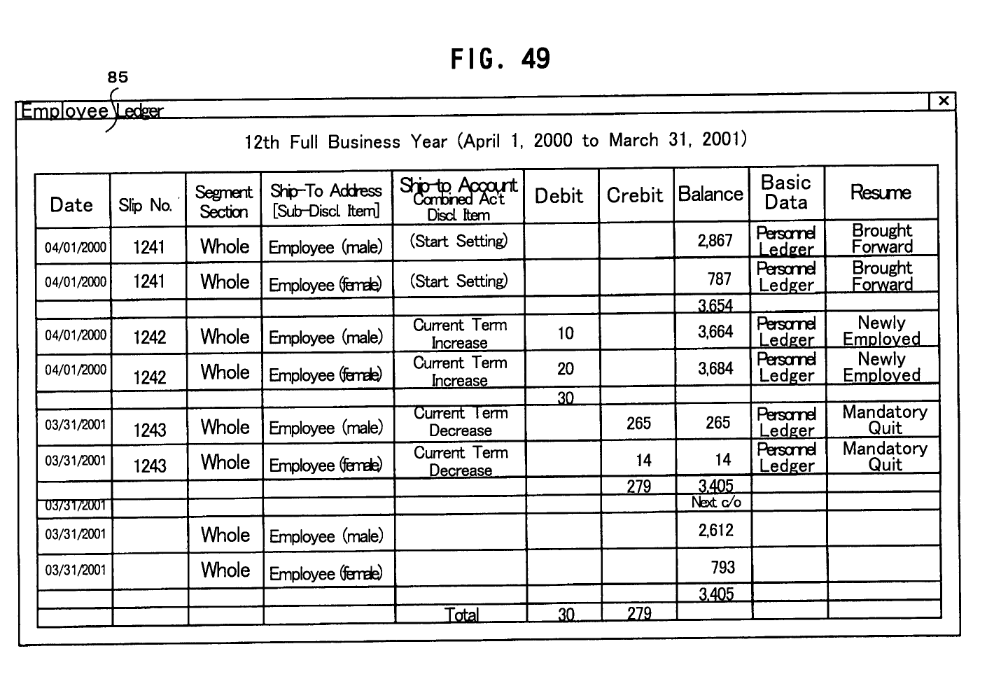

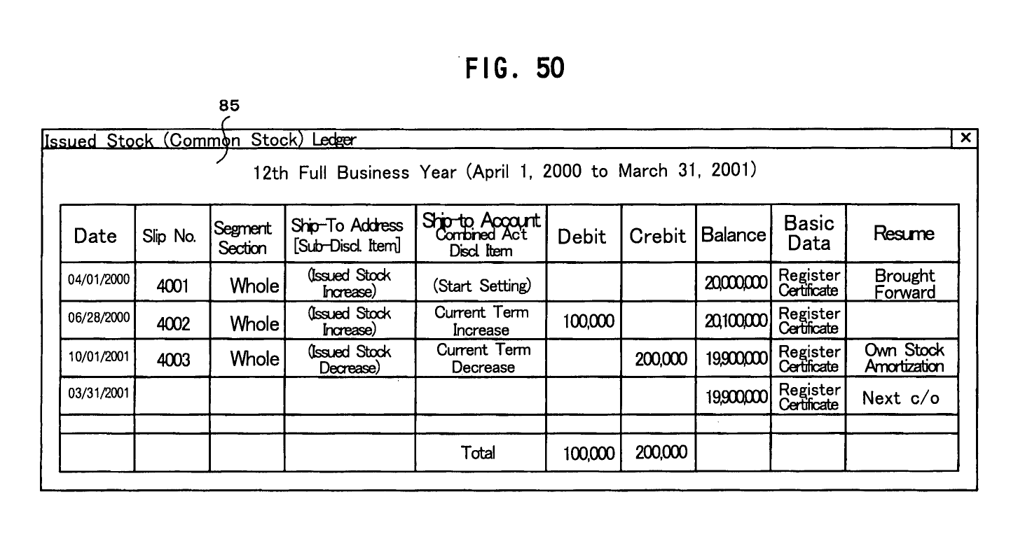

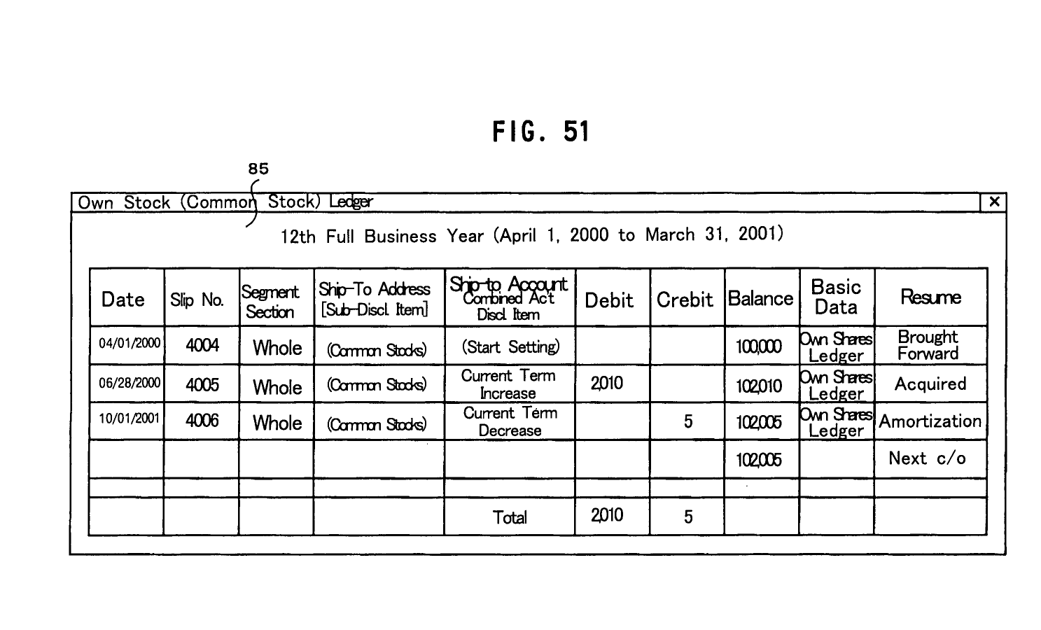

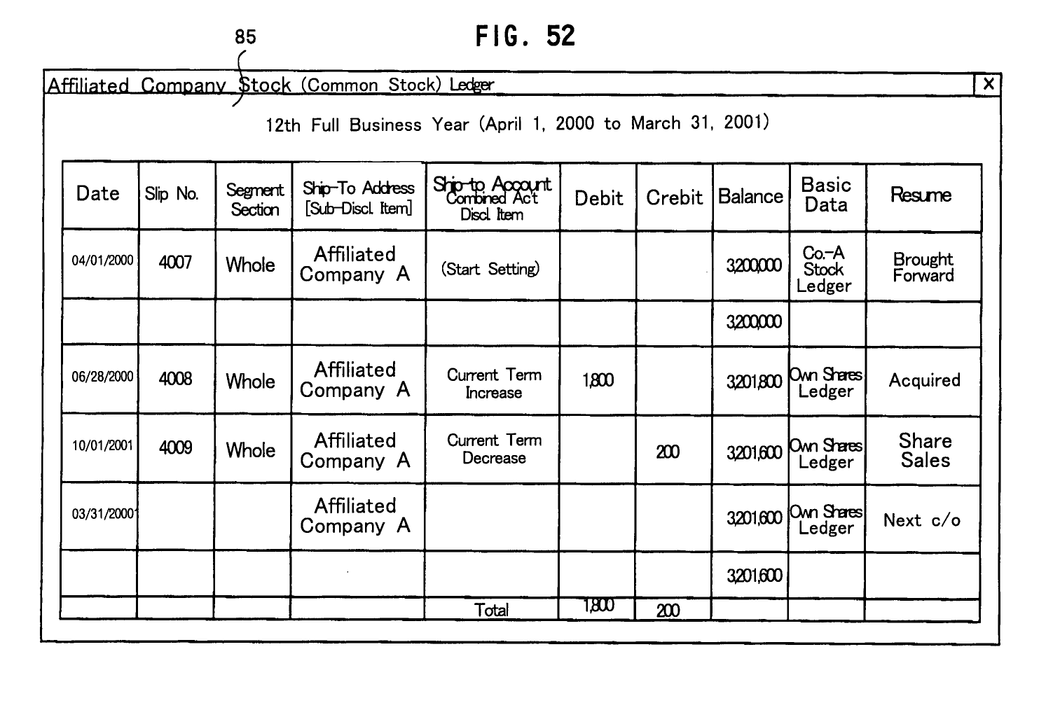

FIG. 46 through FIG. 52 show image screens of various ledgers such as of an auditing officer ledger and director schedule ledger. These ledgers are made in the same manner as above.

Next, a calculating slip display process 606 and a calculating slip registration process 607, which are carried out according to the document creation program of the invention, will be described. In the first embodiment of the invention, a calculating slip is made with a formula item indicating a calculating method and a calculation result item obtained from the formula item.

As shown in the aforementioned formula item table 215, the formula item consists of common calculating symbols “+”, “−”, “×”, “÷”, “(“,”)”, “{”, “}”, and “=”. Further, the formula item includes the calculation result item indicating the calculating formula made by combining the combined account disclosure item and the aforesaid calculating item.

For instance, the combined account disclosure item “current net earnings per share (common stock)” is a formula item indicating the formula “current net earnings per share (common stock)=(current net earnings−officers' bonuses)÷(average number of shares outstanding−average number of own shares)”.

Next, the process of making the calculation result item will be described with reference to the flowchart of FIG. 53.

First, when the document creation program is executed, the processing device 6 performs the list display process 601 to display on the display device 4 the processing list image 73 having a list of the aforesaid items to be processed. When the operator selects the calculating slip with the input device 3, the processing device 6 performs to display the calculating slip image 9 on the display device 4 (S31).

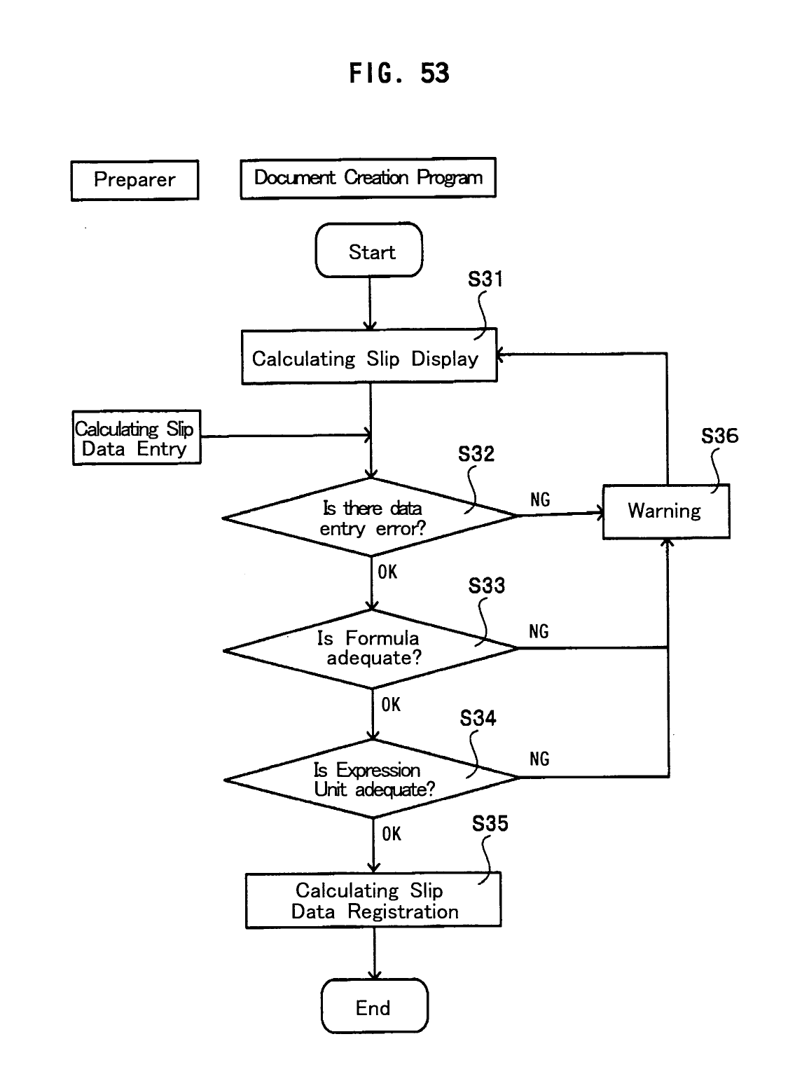

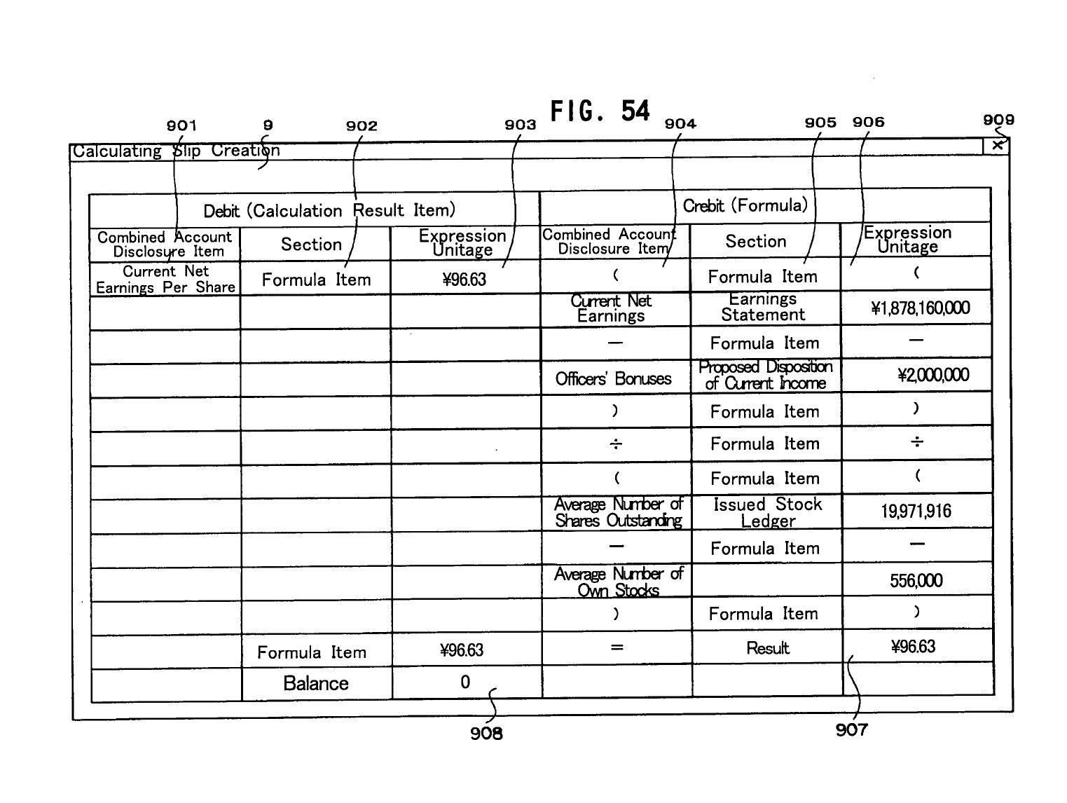

FIG. 54 shows the calculating slip image 9 for making the calculation result item and the formula therefor. The calculating slip image 9 contains a calculation result item entry field 901 for a calculation result item obtained by the formula, a calculation result section display column 902 displaying the section of the calculation result section, a result expression unitage enter field 903 for result expression unitage of the calculation result item, a formula entry field 904 for the combined account disclosure item used for the formula, a combined account title section entry field 905 for the section of the combined account disclosure item, a combined account title expression unitage display column 906 indicating the expression unitage of the combined account disclosure item, a calculation result display column 907 indicating the calculation result by the formula, and a lease balance display column 908 indicating the lease balance. Further, an end button 909 for terminating the processing when the processing is completed is also contained in the screen.

The operator enters data to the respective entry field on the aforesaid calculating slip image 9 with the input device 3. In entering the data, the formula for the calculation result item given resultantly is defined by inputting in order the respective combined account disclosure items constituting the formula to the formula entry field 904. When the operator selects the end button 909 with the input device 3, checking whether or not all the required items are entered is made (S32). If there is such a non-input entry filed, such a non-input state is displayed on the display device 4 to ask for the operator to enter the required data (S33). At that time, if addition symbols or combined account disclosure items continue in juxtaposition in the formula, the formula is determined to be error and the error information is displayed on the display device 4 to ask for the operator to enter the proper data (S36→S31). If the formula is determined to be computable, determination whether or not the expression unit in the combined account disclosure item constituting the formula is appropriate is made (S34). At that time, if the combined account disclosure item having the expression unit “stock” is added to the combined account item having the expression unit “yen” by way of example, the expression unit is determined to be error to ask for the operator to enter the proper data (S36→S31). When the expression unit is determined to be appropriate, the processing device 6 performs the calculating slip registration process 607 for storing the data entered in the respective entry fields in the positions corresponding to the columns of the formula item, calculating formula and calculation result in the formula item table 215 (S35). Thus, the calculation result item can be specified as the disclosure item of the document as described later.

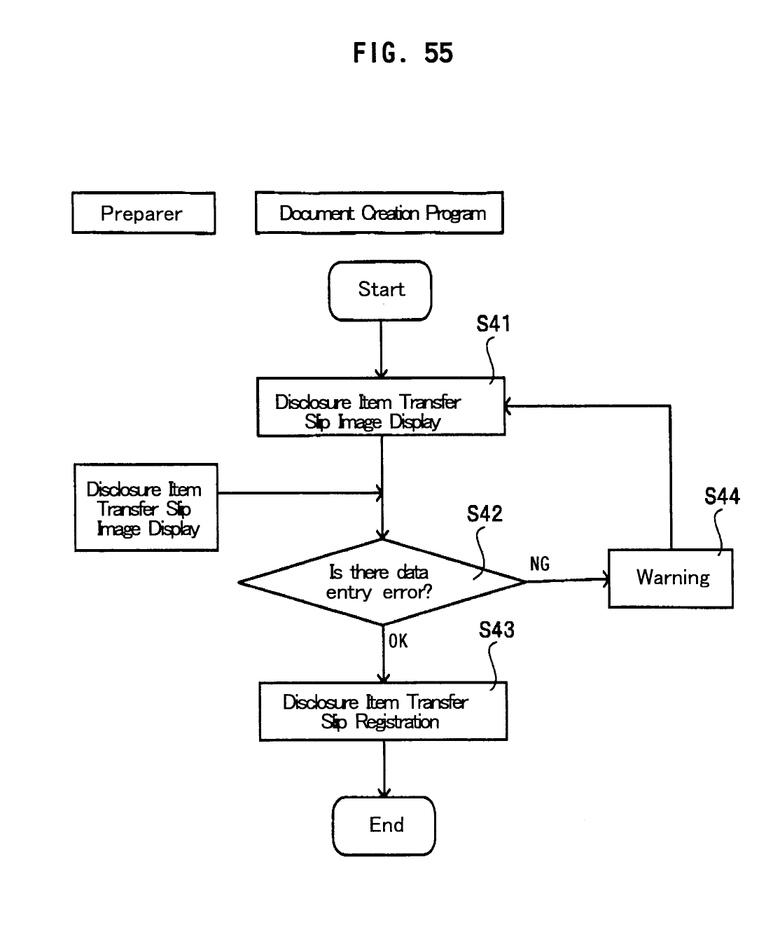

Next, the process of specifying the disclosure item in each item of the ledger prepared above according to the document creation program of the invention will be described with reference to the flowchart of FIG. 55.

The description of the combined account disclosure item or subsidiary disclosure item in the document is determined on the basis of the disclosure section indicating describing positions in the document. As shown in the disclosure section table 216, the disclosure sections are sorted into a first section, second section, third section, forth section and so forth. The first section is indicative of the largest segment for account documents such as a brief announcement of financial results and a valuable instrument report, which are required by commercial law. The second section is indicative of a section for documents such as a financial business report, an annexed specification and first section business information. The third section and fourth section are indicative of documents describing the state of shares, capital subscription of affiliated company, status of the first section company, status of own shares and status of affiliated companies and further indicate more detailed positions in the document

By specifying the layout of the document with the disclosure section table 216, it is possible to uniquely make the document based on the data derived from the information inputted in the basic slip and stored in the slip information table 214.

When the document creation program is executed, the processing device 6 performs the list display process 601 to display the processing list image 73 having the item list for the aforesaid processing object on the display device 4 (S41). When the operator selects the disclosure item transfer slip with the input device 3, the processing device 6 performs the disclosure item transfer slip display process 608 to ask for the operator to enter the disclosure item transfer slip information while displaying a disclosure item transfer slip 95 on the display device 4.

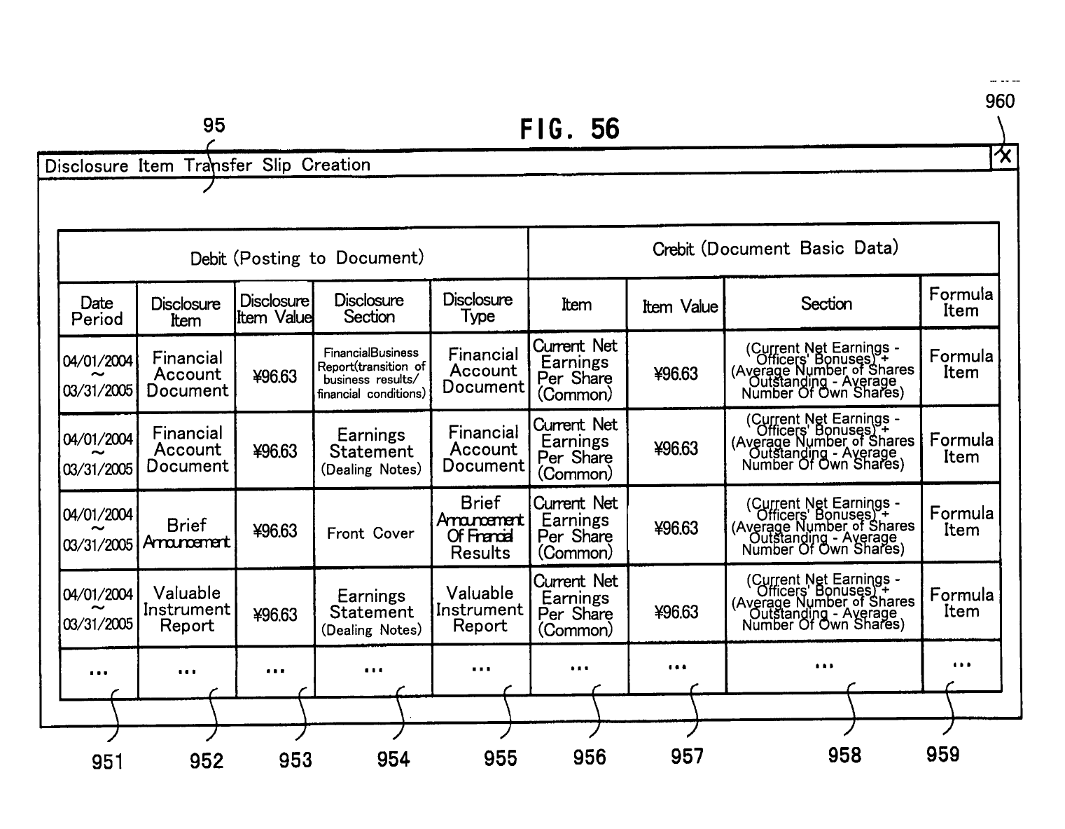

FIG. 56 shows a disclosure item transfer slip image 95 for setting the disclosure item for the document

The disclosure item transfer slip image 95 contains, as information to be transcribed to the document, a date period entry field 951 for a date period to be disclosed in the document, a disclosure item entry field 952 for selecting the subject item to be disclosed in the document from the ledger, combined account disclosure item, subsidiary disclosure item, calculation result item or the like, a disclosure item value display column 953 indicating the value corresponding to the disclosure item, a disclosure section entry field 954 for selecting the disclosure section of the disclosure item from the disclosure section table 216, and a disclosure type entry field 955 for selecting the disclosure type of the disclosure item from the disclosure type table. For the basic data to obtain the data to be disclosed, there are further provided an item entry field 956 for the subject item to be acquired, an item value entry field 957 for the item value for the subject item, a section entry field 958 for the section of the subject item, and a type entry field 959 for the type of the subject item. An end button 960 is provided for terminating the data entry into the disclosure item transfer slip.

When specifying a formula result item as the type inputted in the type entry field 959, the formula is displayed in the section entry field 958. When specifying the item having the item values, the specified item values are displayed in the disclosure item value display column 953 and item value entry field 957.

When the operator enters the data into the respective entry fields as mentioned above with the input device 3 and selects the end button, the processing device 6 checks whether or not all the required items are entered (S42). If there is such a non-input entry filed, such a non-input state is displayed on the display device 4 to ask for the operator to enter the required data (S44→S41). At this time, if the item entered in the disclosure item entry field 952 is not numeric value, the entered item is not determined to be inadequate. When the data are entered in the respective entry fields, the processing device 6 performs the disclosure item transfer slip registration process 609 to store the information entered in the respective entry fields to the database 2 (S43).

Therefore, the processing device 6 performs the document creation process 610 for creating the document based on the disclosure item transfer slip information as mentioned below, and then, it performs the document display process 611 for displaying the document thus created on the display device 4. At this time, the created document may be printed out by an output device such as a printer.

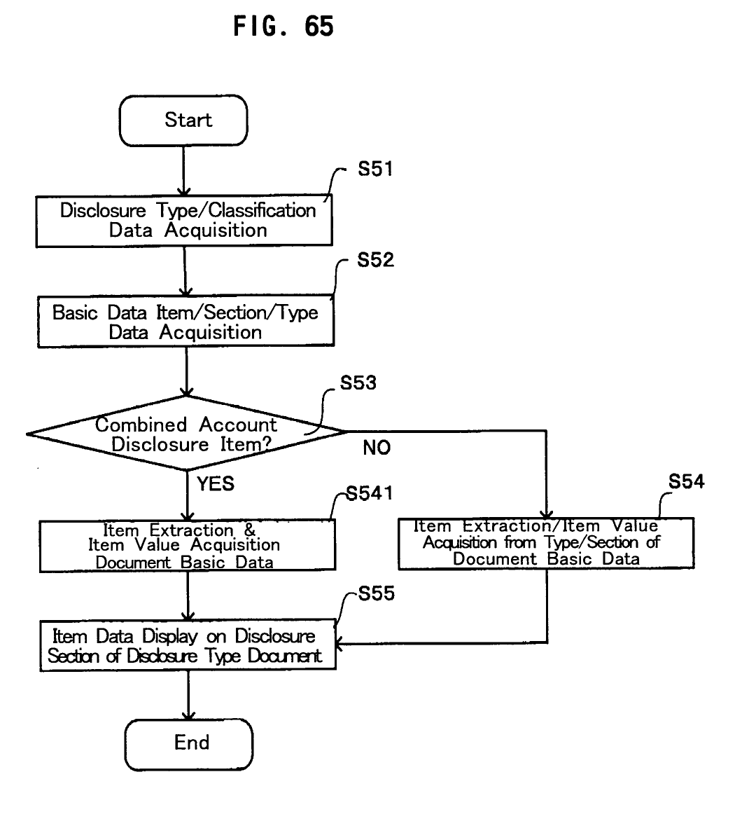

The process of creating the document using the aforementioned disclosure item transfer slip information will be described hereinafter with reference to the flowchart of FIG. 65.

First, the processing device 6 acquires data of the disclosure item, disclosure section and disclosure type of disclosure slip transfer information (S61). Data of the item, section and type of the basic data are also acquired (S52). Then, determination whether or not the type acquired is the combined account disclosure item is made (S53). When the type is the combined account disclosure item, the item value of the acquired item is obtained (S541). When the type is the ledger, information of the acquired item is obtained from the type and section of the item (S542). The information of the acquired item at S541 and S542 is described as the disclosure item of the document of the disclosure type obtained at S51 at the position of the disclosure section (S55).

For instance, on the upper column in the embodiment of FIG. 56, there are specified and represented the formula item as the type, “current net earnings per share (common stock)” as the formula item stored as the item to be acquired, the current net earnings per share as the disclosure item, the financial business report (second section), which is the financial account document (first section), as the disclosure section, and the transition of business results and financial condition (third section). Therefore, as illustrated in FIG. 69 showing one example of the created financial business report, the item value “¥96.63” is displayed in the column of the current net earnings per share with respect to the transition of business results and financial conditions in the financial business report.

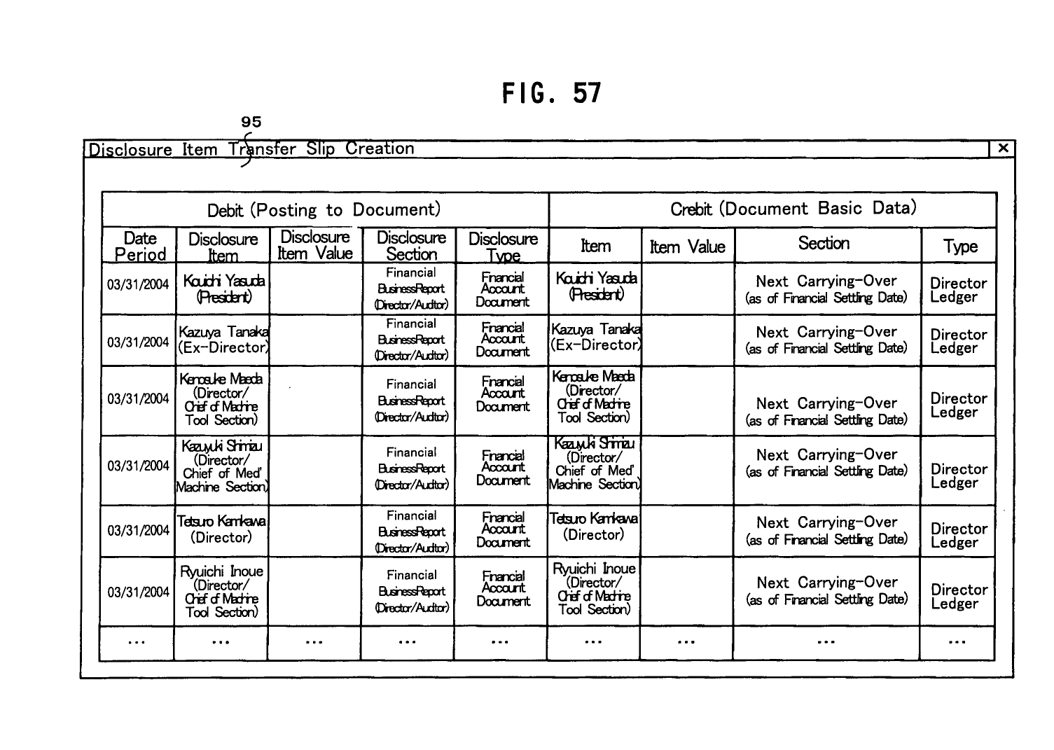

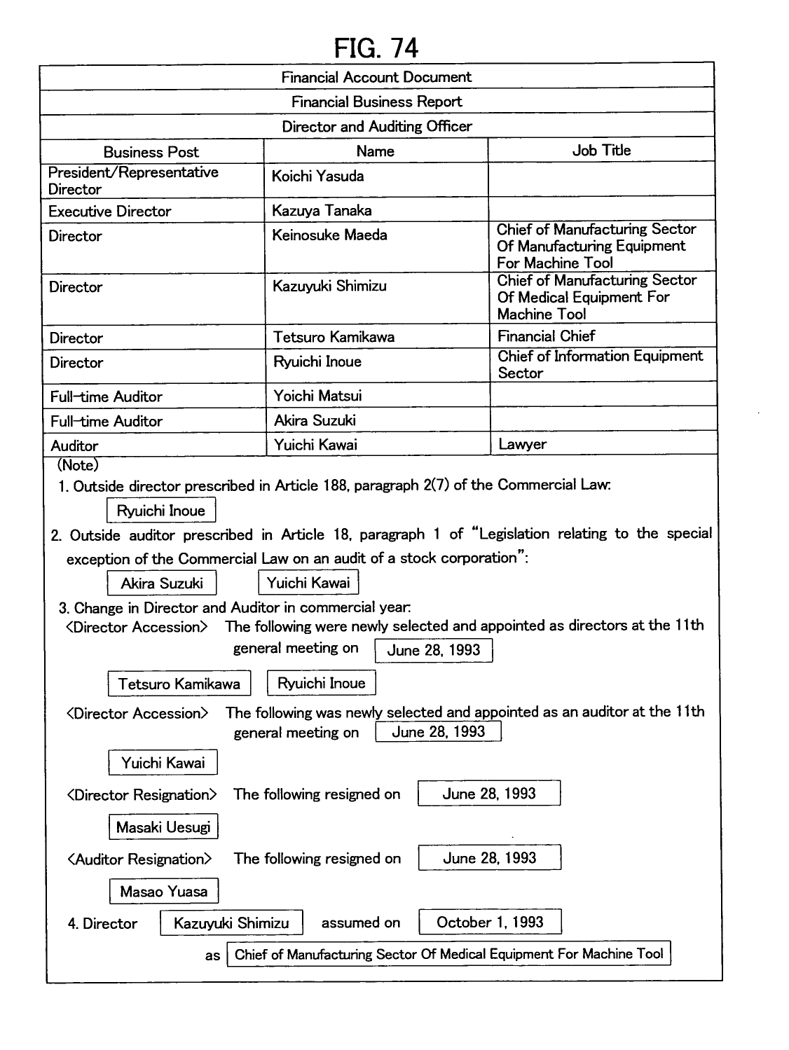

FIG. 57 is the disclosure item transfer slip image 95 concerning the director ledger and auditing officer ledger to be specified as the item described in the document In the upper column of the disclosure item transfer slip, there are specified the director ledger as the basic data type of the document, “next carrying-over” as the section, “President and Representative Director: Koichi Yasuda” as the item, the financial account document (first section), the financial business report (second section) and the director and auditing officer (third section) as the disclosure section. Thus, in the column of the director and auditing officer in the financial business report, the information concerning “President and Representative Director: Koichi Yasuda” is disclosed as illustrated in FIG. 74 showing one part of the created financial business report.

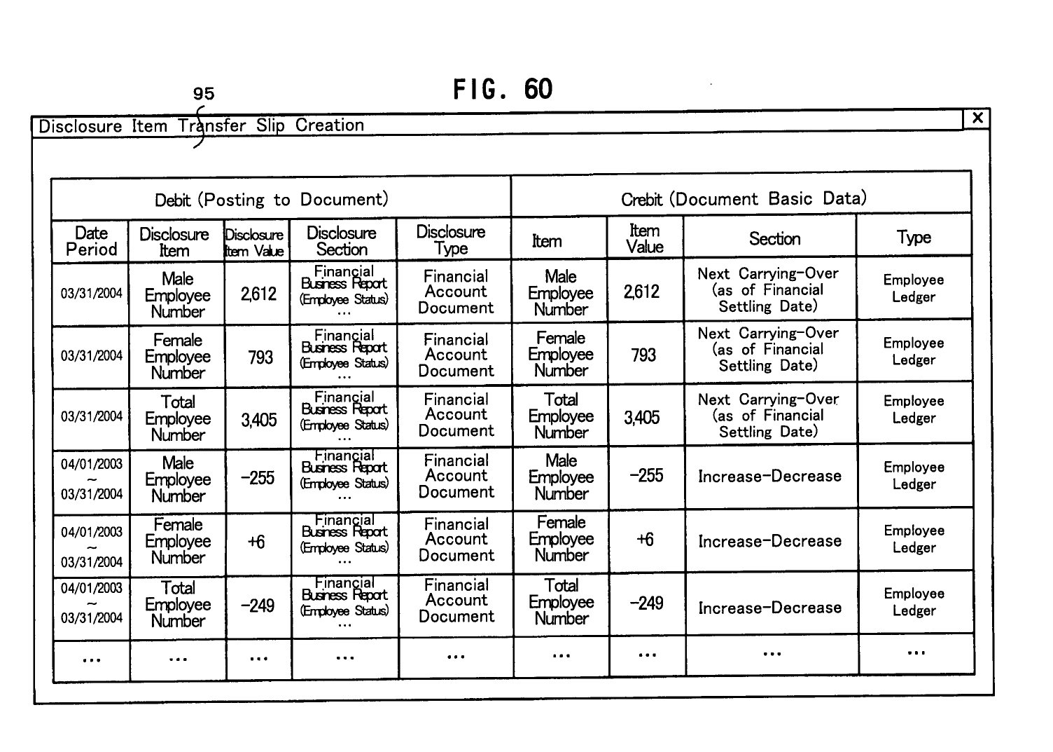

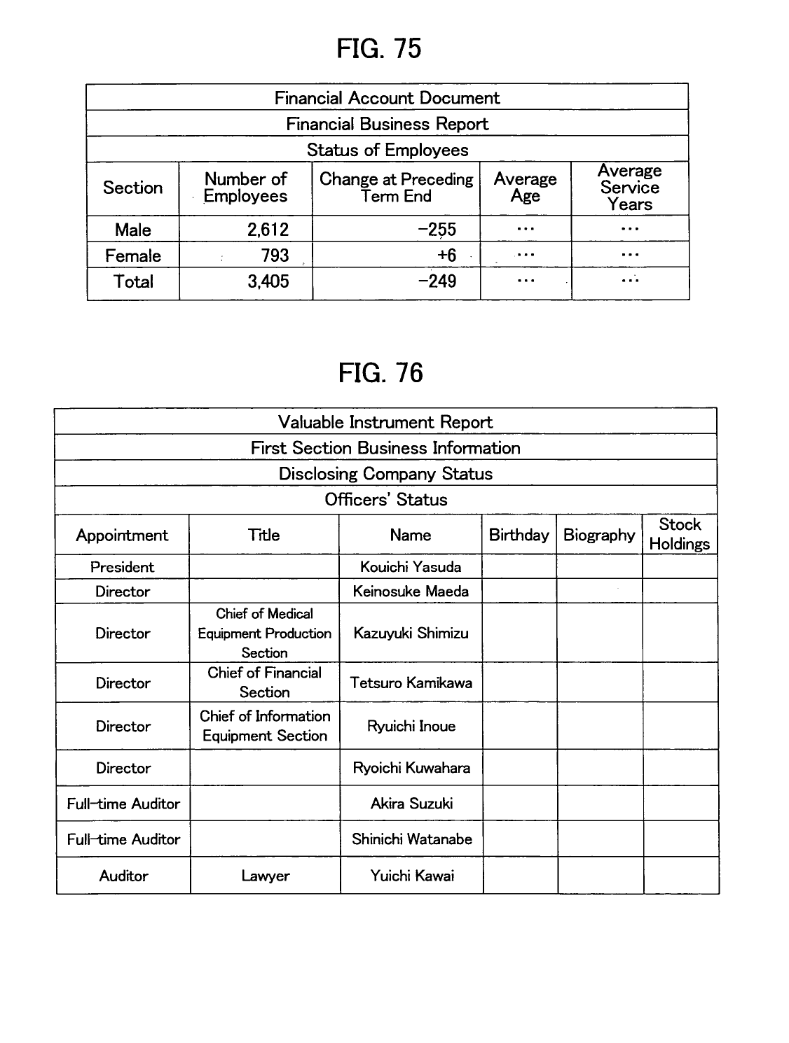

FIG. 60 shows the disclosure item transfer slip image 95 with respect to an employee ledger. In the upper column of the slip, there are specified the “employee ledger” as the basic data type, “next carrying-over” as the section, “male employee number” as the item, “male employee number” as the disclosure item to be transferred to the document, and the financial account document (first section), the financial business report (second section) and the status of employees (third section) as the disclosure section. Thus, in the column of the employee status of the financial account document, the information such as the disclosure item value “2,612 (employees)”, which is the expression unitage indicating the male employee number, as illustrated in FIG. 75 showing one part of the created financial business report.

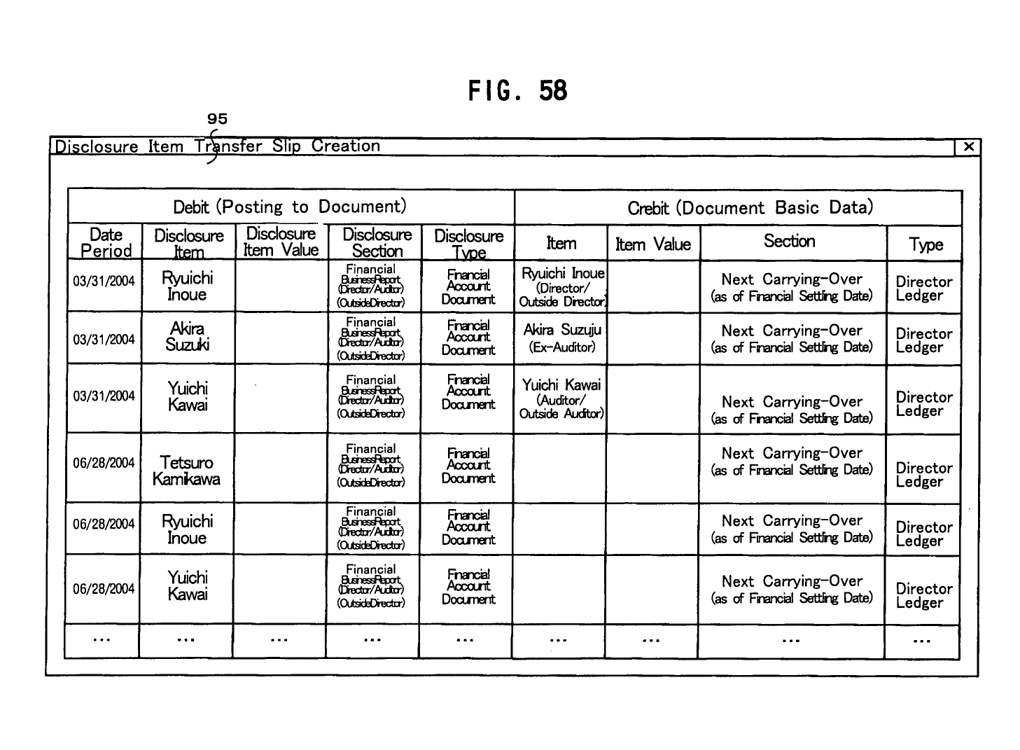

FIG. 58 through FIG. 64 show various disclosure item transfer slips. From these disclosure item transfer slips, a variety of documents such as the financial account document, brief announcement of financial results and valuable instrument report can be created from these disclosure item transfer slips.

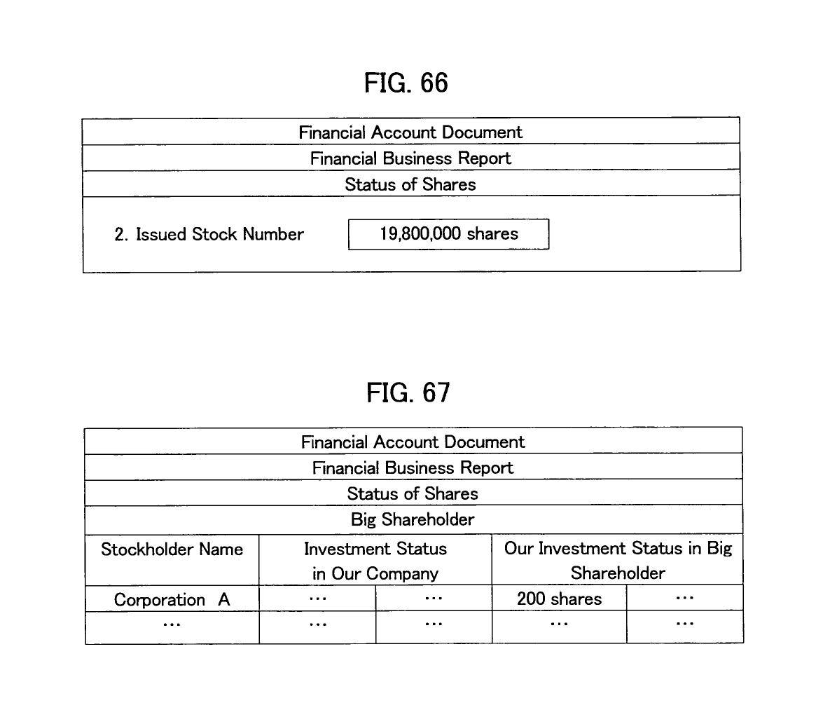

FIG. 66 through FIG. 82 show in part the document created according to the document creation system 1 according to the first embodiment of the present invention.

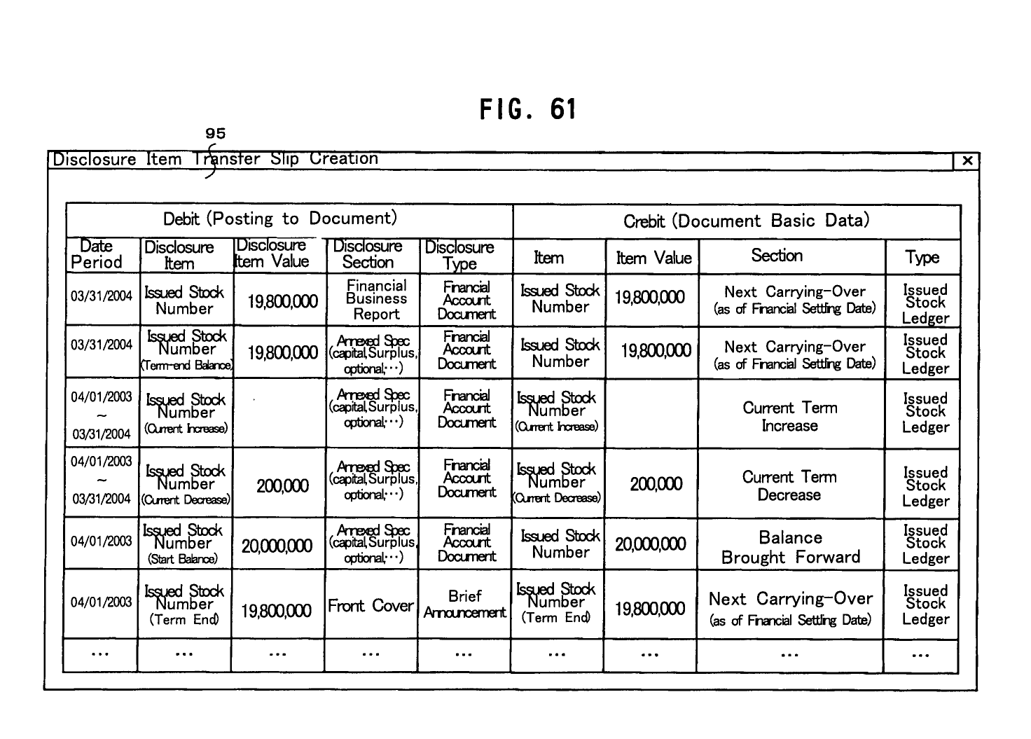

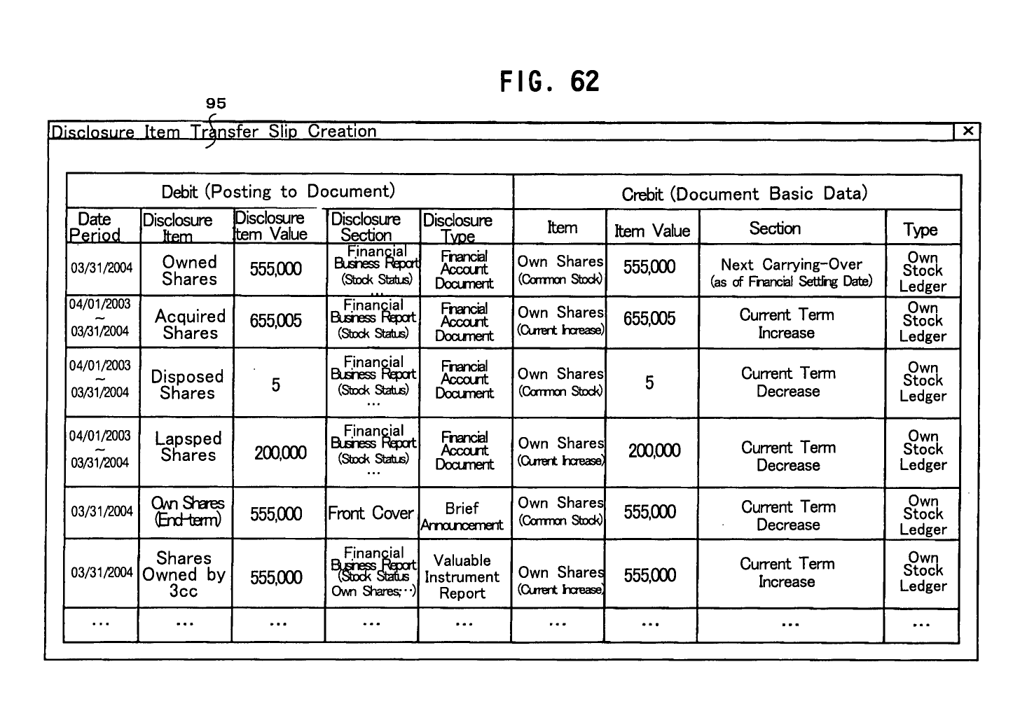

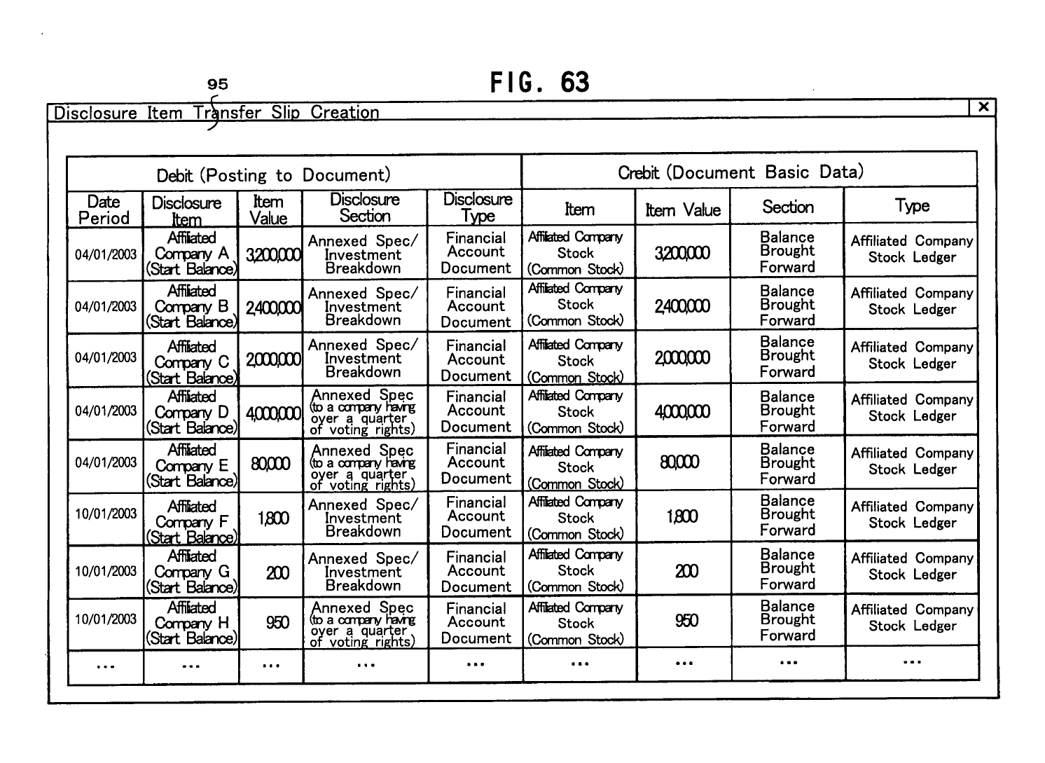

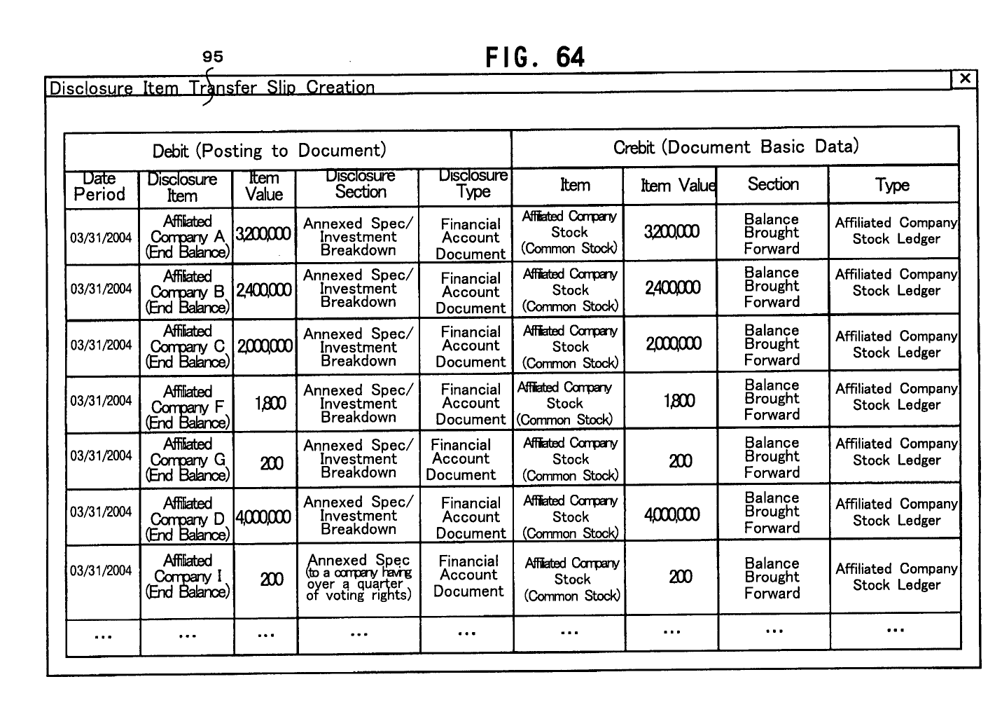

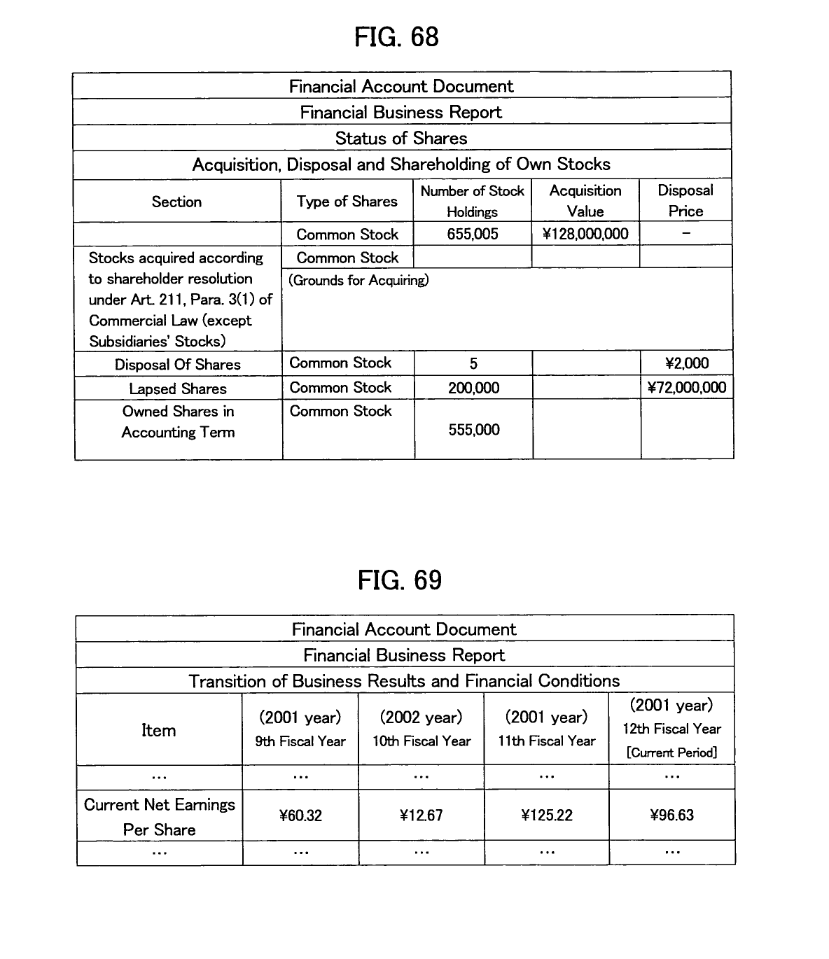

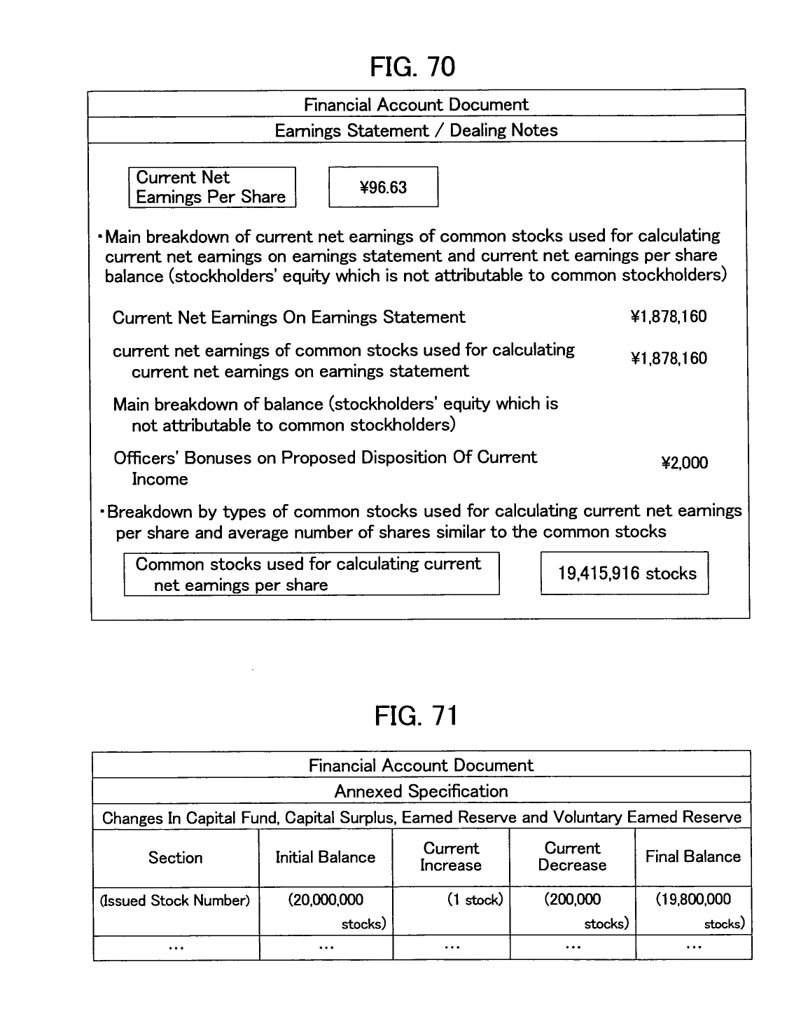

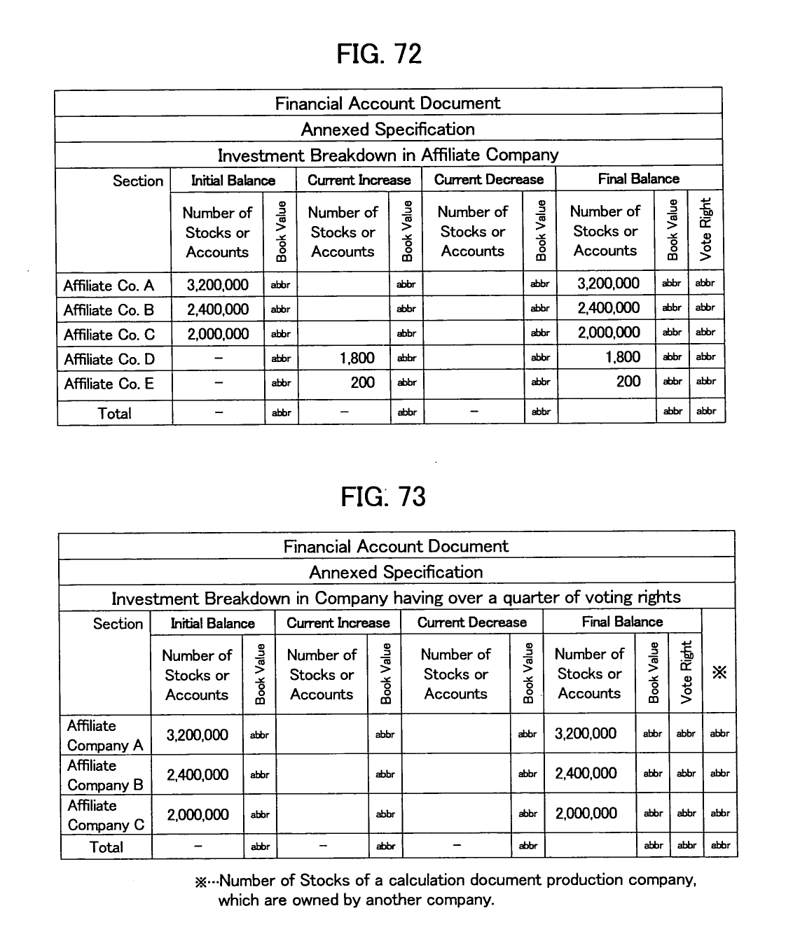

FIG. 66 shows a part describing the issued stock number obtained from the disclosure item transfer slip of the financial account document (FIG. 61). FIG. 67 shows a part describing the investment breakdown in a big stockholder, which is obtained from the disclosure item transfer slip of the financial account document (FIG. 61). FIG. 68 shows a part describing the information concerning the status of payback, disposal of shares and shareholding, which is obtained from the disclosure item transfer slip of the financial account document (FIG. 62). FIG. 69 shows a part describing the information concerning the transition of business results and financial conditions obtained from the disclosure item transfer slip of the financial account document (FIG. 56). FIG. 70 shows a part describing an explanatory note of the earnings statement obtained from the disclosure item transfer slip of the financial account document (FIG. 56). FIG. 71 shows a part describing the issued stock number obtained from the disclosure item transfer slip of the financial account document (FIG. 61). FIG. 72 shows a part describing the investment breakdown in an affiliated company, which is obtained from the disclosure item transfer slips of the financial account documents (FIG. 63 and FIG. 64). FIG. 73 shows a part describing the investment breakdown in a company possessing one fourth of voting shares, which is obtained from the disclosure item transfer slips of the financial account documents (FIG. 63 and FIG. 64). FIG. 74 shows a part describing the information concerning the director and auditing officer, which is obtained from the disclosure item transfer slips of the financial account documents (FIG. 57 and FIG. 58).

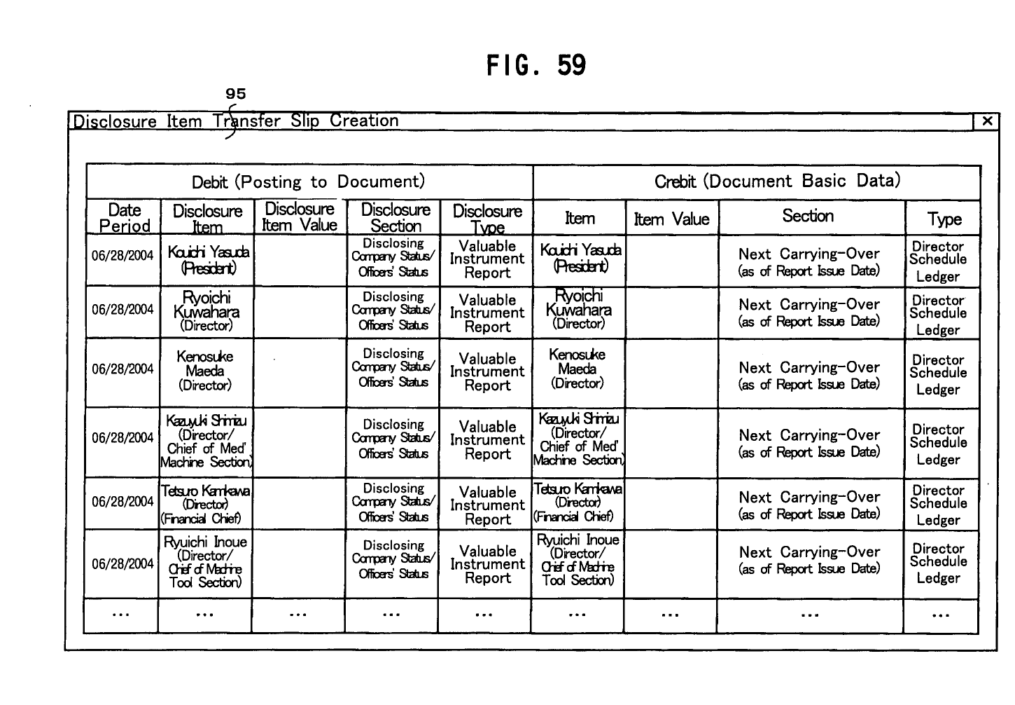

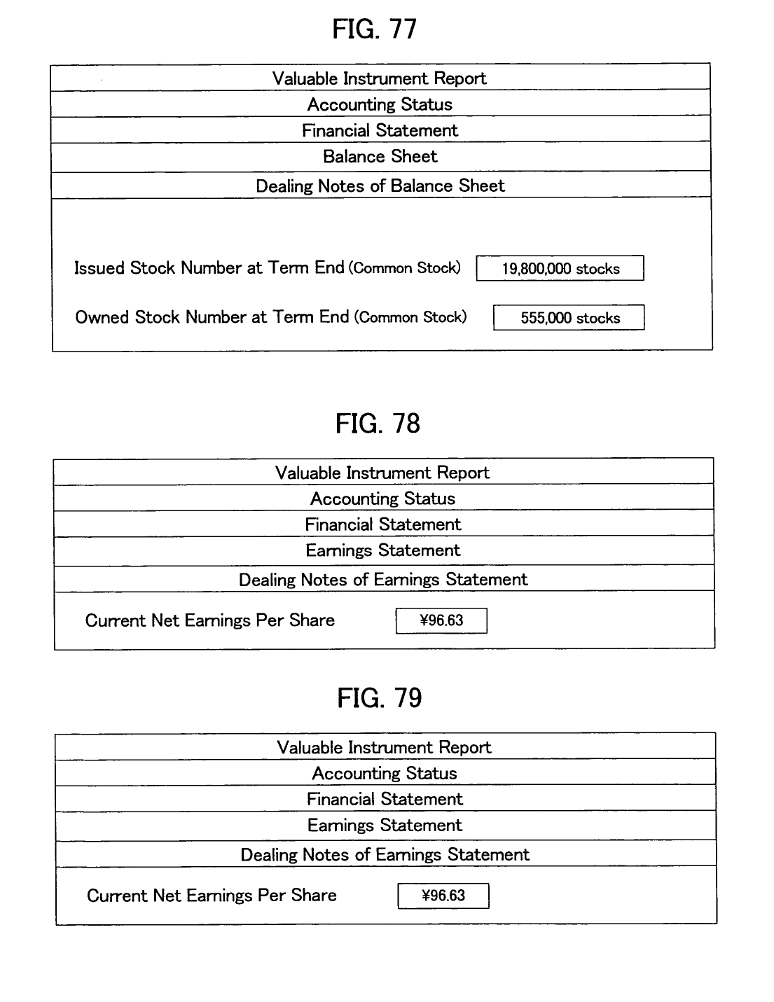

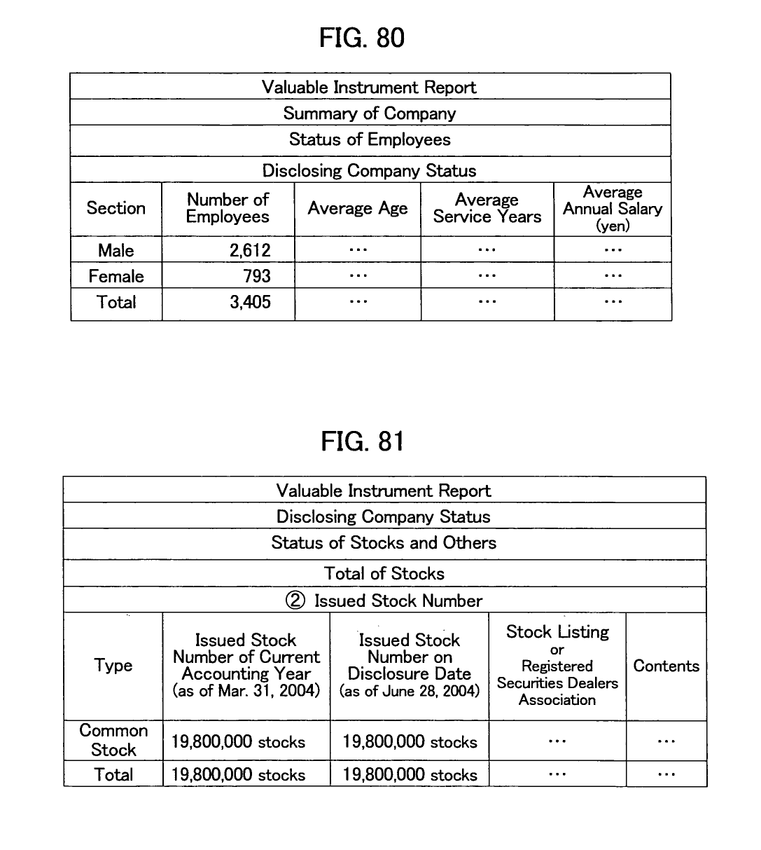

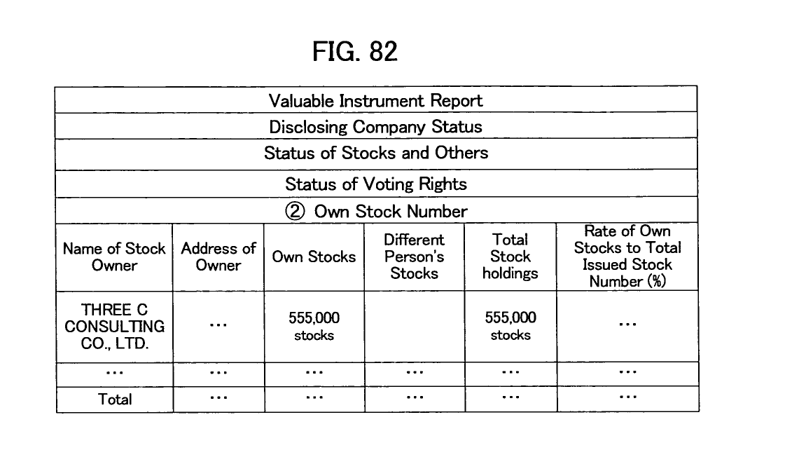

FIG. 75 shows a part describing the information concerning the status of the employees, which is obtained from the disclosure item transfer slips of the financial account document (FIG. 60). FIG. 76 shows a part describing the brief announcement of financial results of the information concerning the share of stock, which is obtained from the disclosure item transfer slips of the brief announcement of financial results (FIG. 56, FIG. 61 and FIG. 62). FIG. 77 shows a part describing the information concerning the officers, which is obtained from the disclosure item transfer slips of the valuable instrument report (FIG. 59). FIG. 78 shows a part describing the information concerning the share of stock, which is obtained from the disclosure item transfer slips of the valuable instrument report (FIG. 61 and FIG. 62). FIG. 79 shows a part describing the information concerning the share of stock, which is obtained from the disclosure item transfer slips of the valuable instrument report (FIG. 56). FIG. 80 shows a part describing the information concerning the status of a document filing company, which is obtained from the disclosure item transfer slips of the valuable instrument report (FIG. 60). FIG. 81 shows a part describing the information concerning the issued stock number, which is obtained from the disclosure item transfer slips of the valuable instrument report (FIG. 61). FIG. 82 shows a part describing the information concerning the own shares, which is obtained from the disclosure item transfer slips of the valuable instrument report (FIG. 62).

As described above, according to the document creation system 1 of the present invention, the financial account document and brief announcement of financial results can easily be created expeditiously with accuracy on the basis of the company information including not only accounting information but also non-accounting information on share of stock, company members and so forth by managing and journalizing the company information and the ledger with the basic combined account disclosure item, increase disclosure item, decrease disclosure item, and subsidiary disclosure item for complementing the contents of these items.

Further, according to the invention, it is arbitrarily possible to make the combined account disclosure item and subsidiary disclosure item and define the disclosure item and disclosure position of the document to be disclosed, so that the contents and/or format of the document can be promptly created or modified in conformity with any form newly prescribed due to a change in the law or any other change of scene. Besides, any kind of desired documents including a statutory disclosure document can freely be created by arbitrarily defining the disclosure items and form.

Moreover, according to the invention, there can be disclosed information prepared by arranging the numeric values in the slip or ledger by defining the formula formed of the combined account disclosure item and numeric values so as to apply the combined account disclosure item thus defined as the disclosure item of the document to be disclosed.

Meanwhile, there has been described above the document creation system 1 of the invention in such a form that it is used independently without being connected to Internet or network such as LAN, but also the system of the invention may of course be used with multiple processing devices 5, input device 3, display device 4 and so on, which are linked to the network.

### INDUSTRIAL APPLICABILITY

The present invention makes it possible to easily create the document to be disclosed by managing not only accounting information such as accounting dealt with by the combined account disclosure item, but also non-accounting information such as of increase/decrease in share of stock and employee, which come out of management using journalizing and ledger.

1. A document creation system for creating prescribed disclosure documents such as financial account documents and brief announcement of financial results or in-house management documents, comprising a database for storing disclosure section information for managing a combined account disclosure item defined by extending a combined account title to non-accounting information including not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items; a display device for displaying entry fields; an input device for entry into said entry field; and a processing unit for performing the following processes (A)-(E):
(A) displaying, on said display device, a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) displaying, on said display device, a disclosure item entry field for said disclosure item and a disclosure item transfer slip for asking for entering said disclosure item information,
(D) registering said disclosure item transfer slip to be stored in said database in correlation with the disclosure item information entered into each of said entry fields, and
(E) creating the prescribed disclosure documents from said business information on the basis of said disclosure item information and disclosure section information.

2. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items; a display device for displaying entry fields; an input device for entry into said entry field; and a processing unit for performing the following processes (A)-(E):
(A) displaying, on said display device, a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) displaying, on said display device, a disclosure item entry field for said disclosure item and a disclosure item transfer slip for asking for entering said disclosure item information,
(D) registering said disclosure item transfer slip to be stored in said database in correlation with the disclosure item information entered into each of said entry fields, and
(E) creating the prescribed disclosure documents from said business information on the basis of said disclosure item information and disclosure section information.

3. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, and formula item information for correlating a formula item, said formula item information being a combined account disclosure item indicating operation symbols such as addition and subtraction signs with said operation symbols; a display device for displaying entry fields; an input device for entry into said entry field; and a processing unit for performing the following processes (A)-(G):
(A) displaying, on said display device, a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) displaying, on said display device, a calculating slip including a formula item entry field for entering the formula represented by enumerating the combined account disclosure items and a calculation result item entry field for entering a calculation result item indicating the combined account disclosure item calculated by said calculation formula,
(D) registering the calculation slip for storing, in a calculating item table, the calculation result item calculated by the said calculation formula in correlation with said calculation formula.
(E) displaying, on said display device, a disclosure item entry field for said disclosure item and a disclosure item transfer slip for asking for entering said disclosure item information,
(F) registering said disclosure item transfer slip to be stored in said database in correlation with the disclosure item information entered into each of said entry fields, and
(G) creating the prescribed disclosure documents from said business information on the basis of said disclosure item information and disclosure section information.

4. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, and formula item information for correlating a formula item, said formula item information being a combined account disclosure item indicating operation symbols such as addition and subtraction signs with said operation symbols; a display device for displaying entry fields; an input device for entry into said entry field; and a processing unit for performing the following processes (A)-(G):
(A) displaying, on said display device, a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) displaying, on said display device, a calculating slip including a formula item entry field for entering the formula represented by enumerating the combined account disclosure items and a calculation result item entry field for entering a calculation result item indicating the combined account disclosure item calculated by said calculation formula,
(D) registering the calculation slip for storing, in a calculating item table, the calculation result item calculated by the said calculation formula in correlation with said calculation formula.
(E) displaying, on said display device, a disclosure item entry field for said disclosure item and a disclosure item transfer slip for asking for entering said disclosure item information,
(F) registering said disclosure item transfer slip to be stored in said database in correlation with the disclosure item information entered into each of said entry fields, and
(G) creating the prescribed disclosure documents from said business information on the basis of said disclosure item information and disclosure section information.

5. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items; a display device for displaying entry fields; an input device for entry into said entry field; and a processing unit for performing the following processes (A)-(F):
(A) displaying, on said display device, a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) preparing a disclosure ledger for calculating credit/debit balance in a given period on the basis of the date information and expression unitage information of said basic slip information and, upon itemization of said basic slip information with each combined account disclosure item,
(D) displaying, on said display device, a disclosure item entry field for said disclosure item and a disclosure item transfer slip for asking for entering said disclosure item information,
(E) registering said disclosure item transfer slip to be stored in said database in correlation with the disclosure item information entered into each of said entry fields, and
(F) creating the prescribed disclosure documents from said business information on the basis of said disclosure item information and disclosure section information.

6. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items; a display device for displaying entry fields; an input device for entry into said entry field; and a processing unit for performing the following processes (A)-(E):
(A) displaying, on said display device, a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) preparing a disclosure ledger for calculating credit/debit balance in a given period on the basis of the date information and expression unitage information of said basic slip information and, upon itemization of said basic slip information with each combined account disclosure item,
(D) displaying, on said display device, a disclosure item entry field for said disclosure item and a disclosure item transfer slip for asking for entering said disclosure item information,
(E) registering said disclosure item transfer slip to be stored in said database in correlation with the disclosure item information entered into each of said entry fields, and
(F) creating the prescribed disclosure documents from said business information on the basis of said disclosure item information and disclosure section information.

7. A document creation system for creating prescribed disclosure documents such as financial account documents and brief announcement of financial results or in-house management documents, comprising a database for storing disclosure section information for managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, formula item information for correlating a formula item, said formula item information being a combined account disclosure item indicating operation symbols such as addition and subtraction signs with said operation symbols, and other information; a display device for displaying entry fields; an input device for entry into said entry field; and a processing unit for performing the following processes (A)-(H):
(A) displaying, on said display device, a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs,
(B) registering the basic slip information entered into said entry fields to be stored as correlated business information in said database,
(C) preparing a disclosure ledger for calculating credit/debit balance in a given period on the basis of the date information and expression unitage information of said basic slip information and, upon itemization of said basic slip information with each combined account disclosure item,
(D) displaying, on said display device, a calculating slip including a formula item entry field for entering the formula represented by enumerating the combined account disclosure items and a calculation result item entry field for entering a calculation result item indicating the combined account disclosure item calculated by said calculation formula,
(E) registering the calculation slip for storing, in a calculating item table, the calculation result item calculated by the said calculation formula in correlation with said calculation formula.
(F) displaying, on said display device, a disclosure item entry field for said disclosure item and a disclosure item transfer slip for asking for entering said disclosure item information,
(G) registering said disclosure item transfer slip to be stored in said database in correlation with the disclosure item information entered into each of said entry fields, and
(H) creating the prescribed disclosure documents from said business information on the basis of said disclosure item information and disclosure section information.

8. The document creation system set forth claim 1, wherein the database has a combined account disclosure item table for storing the combined account disclosure item, and the processing unit serves to display, on the display device, the combined account disclosure item entry field for entry of said combined account disclosure item, and store in the database said combined account disclosure item entered into said entry field, and wherein the data in said combined account disclosure item table are indicated as an option on the display device when displaying the combined account disclosure entry field in the basic slip displaying process.

9. The document creation system set forth in claim 2, wherein the database has a combined account disclosure item table for storing the combined account disclosure item and a subsidiary disclosure item table for storing the subsidiary disclosure item; and the processing unit serves to display, on the display device, the combined account disclosure item entry field for entry of said combined account disclosure item and subsidiary disclosure item entry field for entry of said subsidiary disclosure item, and store in the database said combined account disclosure item and subsidiary disclosure item entered into said entry field, wherein the data in said combined account disclosure item table are indicated as an option and the date in said subsidiary disclosure item table are indicated as an option on the display device when displaying the combined account disclosure entry field in the basic slip displaying process.

10. A document creation program for creating prescribed disclosure documents such as financial account documents and brief announcement of financial results or in-house management documents, comprising:
a basic slip displaying process for displaying a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items,
a basic slip registering process for registering the basic slip information entered into said entry fields to be stored as correlated business information,
a disclosure item displaying process for displaying a disclosure item entry field for the aforesaid disclosure item and a disclosure item transfer slip for asking for entering the aforesaid disclosure item information,
a disclosure item transfer slip registering process for registering said disclosure item transfer slip in correlation with the disclosure item information entered into each of said entry fields, and
a document creating process for creating the prescribed disclosure documents from said business information on the basis of said disclosure item information and disclosure section information.

11. A document creation program for creating prescribed disclosure documents such as financial account documents and brief announcement of financial results or in-house management documents, comprising:
a basic slip displaying process for displaying a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items,
a basic slip registering process for registering the basic slip information entered into said entry fields to be stored as correlated business information,
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in correlation with the disclosure item information entered into each of said entry fields, and
a document creating process for creating the prescribed disclosure documents from said business information on the basis of said disclosure item information and disclosure section information.

12. A document creation program for creating prescribed disclosure documents such as financial account documents and brief announcement of financial results or in-house management documents, comprising:
a basic slip displaying process for displaying a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, and formula item information for correlating a formula item, said formula item information being a combined account disclosure item indicating operation symbols such as addition and subtraction signs with said operation symbols,
a basic slip registering process for registering the basic slip information entered into said entry fields to be stored as correlated business information,
a calculating slip displaying process for displaying a calculating slip including a formula item entry field for entering the formula represented by enumerating the combined account disclosure items and a calculation result item entry field for entering a calculation result item indicating the combined account disclosure item calculated by said calculation formula,
a calculation slip registering process for registering the calculation slip to store the calculation result item calculated by the said calculation formula in correlation with said calculation formula.
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in correlation with the disclosure item information entered into each of said entry fields, and
a document creating process for creating the prescribed disclosure documents from said business information on the basis of said disclosure item information and disclosure section information.

13. A document creation program for creating prescribed disclosure documents such as financial account documents and brief announcement of financial results or in-house management documents, comprising:
a basic slip displaying process for displaying a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, and formula item information for correlating a formula item, said formula item information being a combined account disclosure item indicating operation symbols such as addition and subtraction signs with said operation symbols,
a basic slip registering process for registering the basic slip information entered into said entry fields to be stored as correlated business information,
a calculating slip displaying process for displaying a calculating slip including a formula item entry field for entering the formula represented by enumerating the combined account disclosure items and a calculation result item entry field for entering a calculation result item indicating the combined account disclosure item calculated by said calculation formula,
a calculation slip registering process for registering the calculation slip for storing the calculation result item calculated by the said calculation formula in correlation with said calculation formula.
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in correlation with the disclosure item information entered into each of said entry fields, and
a document creating process for creating the prescribed disclosure documents from said business information on the basis of said disclosure item information and disclosure section information.

14. A document creation program for creating prescribed disclosure documents such as financial account documents and brief announcement of financial results or in-house management documents, comprising:
a basic slip displaying process for displaying a basic slip including a combined account title entry field for entering combined account title data and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items,
a basic slip registering process for registering the basic slip information entered into said entry fields to be stored as correlated business information in said database,
a disclosure ledger preparing process for preparing a disclosure ledger for calculating credit/debit balance in a given period on the basis of the date information and expression unitage information of said basic slip information and, upon itemization of said basic slip information with each combined account disclosure item,
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in said database in correlation with the disclosure item information entered into each of said entry fields, and
a document creating process for creating the prescribed disclosure documents from said business information on the basis of said disclosure item information and disclosure section information.

15. A document creation program for creating prescribed disclosure documents such as financial account documents and brief announcement of financial results or in-house management documents, comprising:
a basic slip displaying process for displaying a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items,
a basic slip registering process for registering the basic slip information entered into said entry fields to be stored as correlated business information,
a disclosure ledger preparing process for preparing a disclosure ledger for calculating credit/debit balance in a given period on the basis of the date information and expression unitage information of said basic slip information and, upon itemization of said basic slip information with each combined account disclosure item,
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in correlation with the disclosure item information entered into each of said entry fields, and
a document creating process for creating the prescribed disclosure documents from said business information on the basis of said disclosure item information and disclosure section information.

16. A document creation program for creating prescribed disclosure documents such as financial account documents and brief announcement of financial results or in-house management documents, comprising:
a basic slip displaying process for displaying a basic slip including a combined account title entry field for entering combined account title data, a subsidiary disclosure item entry field for entering subsidiary disclosure item data indicating auxiliary information added to said combined account title, and an expression unitage entry field for entering expressing unitages indicating numeric values of said increase/decrease respectively on both debit and credit columns while displaying a date entry field for entering a date on which the increase or decrease occurs, by managing a combined account disclosure item defined by extending a combined account title to not only the combined account title represented by increase/decrease in money, but also number of stock holdings and increase/decrease in employee with a basic combined account disclosure item indicating a substance of the increase/decrease, a decrease disclosure item indicating a substance of the decrease, and an increase disclosure item indicating a substance of the increase in the process of managing business information expressible in numeric terms, and correlating the disclosure items of said business information and disclosure items disclosed in the documents with disclosure positions in the documents of the disclosure items, and formula item information for correlating a formula item, said formula item information being a combined account disclosure item indicating operation symbols such as addition and subtraction signs with said operation symbols,
a basic slip registering process for registering the basic slip information entered into said entry fields to be stored as correlated business information,
a disclosure ledger preparing process for preparing a disclosure ledger for calculating credit/debit balance in a given period on the basis of the date information and expression unitage information of said basic slip information and, upon itemization of said basic slip information with each combined account disclosure item,
a calculating slip displaying process for displaying a calculating slip including a formula item entry field for entering the formula represented by enumerating the combined account disclosure items and a calculation result item entry field for entering a calculation result item indicating the combined account disclosure item calculated by said calculation formula,
a calculation slip registering process for registering the calculation slip for storing, in a calculating item table, the calculation result item calculated by the said calculation formula in correlation with said calculation formula.
a disclosure item displaying process for displaying a disclosure item entry field for said disclosure item and a disclosure item transfer slip for asking for entering said disclosure item information,
a disclosure item transfer slip registering process for registering said disclosure item transfer slip to be stored in correlation with the disclosure item information entered into each of said entry fields, and
a document creating process for creating the prescribed disclosure documents from said business information on the basis of said disclosure item information and disclosure section information.

17. The document creation program set forth in claim 10, further comprising a process for displaying the combined account disclosure item entry field for entry of said combined account disclosure item, and a process for registering said combined account disclosure item entered into said entry field so as to indicate the entered date as an option when displaying the combined account disclosure entry field in the basic slip displaying process.

18. The document creation program set forth in claim 11, further comprising a process for displaying the combined account disclosure item entry field for entry of said combined account disclosure item and subsidiary disclosure item entry field for entry of said subsidiary disclosure item, and a process for registering said combined account disclosure item and subsidiary disclosure item entered into said entry field, so as to indicate the entered data of the combined account disclosure item as an option when displaying the combined account disclosure entry field and the data of the subsidiary disclosure item as an option when displaying the subsidiary disclosure item entry field in the basic slip displaying process.

19. The document creation system set forth in claim 3, wherein the database has a combined account disclosure item table for storing the combined account disclosure item, and the processing unit serves to display, on the display device, the combined account disclosure item entry field for entry of said combined account disclosure item, and store in the database said combined account disclosure item entered into said entry field, and wherein the data in said combined account disclosure item table are indicated as an option on the display device when displaying the combined account disclosure entry field in the basic slip displaying process.

20. The document creation system set forth in claim 5, wherein the database has a combined account disclosure item table for storing the combined account disclosure item, and the processing unit serves to display, on the display device, the combined account disclosure item entry field for entry of said combined account disclosure item, and store in the database said combined account disclosure item entered into said entry field, and wherein the data in said combined account disclosure item table are indicated as an option on the display device when displaying the combined account disclosure entry field in the basic slip displaying process.

21. The document creation system set forth in claim 4, wherein the database has a combined account disclosure item table for storing the combined account disclosure item and a subsidiary disclosure item table for storing the subsidiary disclosure item; and the processing unit serves to display, on the display device, the combined account disclosure item entry field for entry of said combined account disclosure item and subsidiary disclosure item entry field for entry of said subsidiary disclosure item, and store in the database said combined account disclosure item and subsidiary disclosure item entered into said entry field, wherein the data in said combined account disclosure item table are indicated as an option and the date in said subsidiary disclosure item table are indicated as an option on the display device when displaying the combined account disclosure entry field in the basic slip displaying process.

22. The document creation system set forth in claim 6, wherein the database has a combined account disclosure item table for storing the combined account disclosure item and a subsidiary disclosure item table for storing the subsidiary disclosure item; and the processing unit serves to display, on the display device, the combined account disclosure item entry field for entry of said combined account disclosure item and subsidiary disclosure item entry field for entry of said subsidiary disclosure item, and store in the database said combined account disclosure item and subsidiary disclosure item entered into said entry field, wherein the data in said combined account disclosure item table are indicated as an option and the date in said subsidiary disclosure item table are indicated as an option on the display device when displaying the combined account disclosure entry field in the basic slip displaying process.

23. The document creation system set forth in claim 7, wherein the database has a combined account disclosure item table for storing the combined account disclosure item and a subsidiary disclosure item table for storing the subsidiary disclosure item; and the processing unit serves to display, on the display device, the combined account disclosure item entry field for entry of said combined account disclosure item and subsidiary disclosure item entry field for entry of said subsidiary disclosure item, and store in the database said combined account disclosure item and subsidiary disclosure item entered into said entry field, wherein the data in said combined account disclosure item table are indicated as an option and the date in said subsidiary disclosure item table are indicated as an option on the display device when displaying the combined account disclosure entry field in the basic slip displaying process.

24. The document creation program set forth in claim 12, further comprising a process for displaying the combined account disclosure item entry field for entry of said combined account disclosure item, and a process for registering said combined account disclosure item entered into said entry field so as to indicate the entered date as an option when displaying the combined account disclosure entry field in the basic slip displaying process.

25. The document creation program set forth in claim 14, further comprising a process for displaying the combined account disclosure item entry field for entry of said combined account disclosure item, and a process for registering said combined account disclosure item entered into said entry field so as to indicate the entered date as an option when displaying the combined account disclosure entry field in the basic slip displaying process.

26. The document creation program set forth in claim 13, further comprising a process for displaying the combined account disclosure item entry field for entry of said combined account disclosure item and subsidiary disclosure item entry field for entry of said subsidiary disclosure item, and a process for registering said combined account disclosure item and subsidiary disclosure item entered into said entry field, so as to indicate the entered data of the combined account disclosure item as an option when displaying the combined account disclosure entry field and the data of the subsidiary disclosure item as an option when displaying the subsidiary disclosure item entry field in the basic slip displaying process.

27. The document creation program set forth in claim 15, further comprising a process for displaying the combined account disclosure item entry field for entry of said combined account disclosure item and subsidiary disclosure item entry field for entry of said subsidiary disclosure item, and a process for registering said combined account disclosure item and subsidiary disclosure item entered into said entry field, so as to indicate the entered data of the combined account disclosure item as an option when displaying the combined account disclosure entry field and the data of the subsidiary disclosure item as an option when displaying the subsidiary disclosure item entry field in the basic slip displaying process.

28. The document creation program set forth in claim 16, further comprising a process for displaying the combined account disclosure item entry field for entry of said combined account disclosure item and subsidiary disclosure item entry field for entry of said subsidiary disclosure item, and a process for registering said combined account disclosure item and subsidiary disclosure item entered into said entry field, so as to indicate the entered data of the combined account disclosure item as an option when displaying the combined account disclosure entry field and the data of the subsidiary disclosure item as an option when displaying the subsidiary disclosure item entry field in the basic slip displaying process.
